(19) United States
(12) Patent Application Publication
(10) Pub. No.: US 2009/0056741 A1
(43) Pub. Date: Mar. 5, 2009

(54) Cleaning apparatus, cleaning method, pattern formation apparatus, and pattern formation method

(76) Inventors: Atsuko Iida, Yokohama-shi (JP); Mitsunaga Saito, Inzai-shi (JP); Koichi Ishii, Kawasaki-shi (JP); Ken Takahashi, Fukaya-shi (JP); Yoshihiro Tajima, Tano-gun (JP); Yasushi Shinjiyo, Kawasaki-shi (JP); Shigeyuki Tashiro, Osato-gun (JP); Daiji Hirosawa, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/230,607

(22) Filed: Sep. 2, 2008

Related U.S. Application Data
(63) Continuation of application No. PCT/JP2007/053282, filed on Feb. 22, 2007.

(30) Foreign Application Priority Data
Mar. 2, 2006 (JP) 2006-056478
Mar. 28, 2006 (JP) 2006-087750
Apr. 7, 2006 (JP) 2006-106566
Sep. 27, 2006 (JP) 2006-263314

(51) Int. Cl. B08B 3/10; G03G 13/16; B08B 3/12; A47L 9/00; B08B 3/04

(52) U.S. Cl. 134/1; 430/125.31; 134/198; 134/34; 134/115 R; 134/117; 134/57 R; 15/300.1

(57) ABSTRACT

A pattern formation apparatus has a drum-like intaglio rolling along a transferred medium. After the intaglio is charged by a charger, a pattern of toner particles is formed by supplying a liquid developer of each color to the intaglio via a developing machine and an electric field is formed between the intaglio and the transferred medium by rolling the intaglio along the transferred medium to transfer charged toner particles to the transferred medium. A cleaning apparatus which cleans the intaglio after the pattern in each color being transferred to the transferred medium has nozzles at an angle for blowing a cleaning liquid against recesses and removal rollers for removing toner particles liberated from the recesses together with the cleaning liquid.

### CROSS REFERENCE TO RELATED APPLICATIONS

This is a Continuation Application of PCT Application No. PCT/JP2007/053282, filed Feb. 22, 2007, which was published under PCT Article 21(2) in Japanese.

This application is based upon and claims the benefit of priority from prior Japanese Patent Applications No. 2006-056478, filed Mar. 2, 2006; No. 2006-087750, filed Mar. 28, 2006; No. 2006-106566, filed Apr. 7, 2006; and No. 2006-263314, filed Sep. 27, 2006, the entire contents of all of which are incorporated herein by reference.

### BACKGROUND OF THE INVENTION

1. Field of the Invention

The present invention relates to a pattern formation apparatus used for manufacture of, for example, flat type image display apparatuses, wiring substrates, and IC tags, a pattern formation method, a cleaning apparatus of an intaglio incorporated in the pattern formation apparatus, and a cleaning method.

2. Description of the Related Art

Photolithography technology has played a central role as a technology for forming microscopic patterns on the surface of a substrate. However, this photolithography technology requires huge and expensive production equipment. And further, manufacturing costs rise in accordance with the resolution, while the resolution and performance thereof are being increasingly enhanced.

In the field of production of, for example, image display apparatuses that contain semiconductor devices, demands for lower prices are growing along with the improved performance, but such demands cannot be fully satisfied by the conventional photolithography technology. Under such circumstances, a pattern formation technology using digital printing technology is capturing much attention.

In contrast, for example, inkjet technology is beginning to become commercially practical as a patterning technology due to its features such as easy-to-use devices and non-contact patterning, but making the resolution higher and production higher in inkjet technology can be described only as limited. That is, in this respect, electrophotography, among others, electrophotography using liquid toner has great potential.

Using such electrophotography, methods of forming a phosphor layer of the substrate for a flat panel display, a black matrix, a color filter and the like have been proposed (See, for example, Jpn. Pat. Appln. KOKAI Publication No. 2004-30980 and No. 6-265712).

In the field of flat panel displays, demands for higher resolutions are increasing steadily so that formation of patterns with higher position precision is required. However, it is difficult to tackle this problem by the electrophotography described above. This is because the resolution of a writing optical system is at most 1200 [dpi] or so, which is insufficient for the resolution and positioning. Moreover, there is a problem that a broader writing optical system compatible with larger screens in recent years has not yet been realized.

In the face of the above problems, a method of forming a pattern of phosphor or the like on the front glass for a display by using an electrostatic printing plate having a pattern with different electric resistance formed in advance on the surface thereof instead of a photo conductor, applying a liquid toner on the plate to develop the pattern, and transferring the pattern image to a glass plate has been proposed (See, for example, PCT National Publication No. 2002-527783).

To form a high-precision pattern image with a high resolution on a glass plate by adopting this method, it becomes necessary to make a pattern with different electric resistance formed in advance on an electrostatic printing plate more precise and also to reliably do the cleaning of toner remaining undesirably on the electrostatic printing plate after the pattern transfer.

Wet-type electrophotography is suitable for forming microscopic patterns with high resolutions and high position precision that cannot be reached by dry-type electrophotography (See, for example, Jpn. Pat. Appln. KOKAI Publication No. 2001-13795).

Wet-type electrophotography sometimes requires a drying process in which a carrier liquid is removed from a pattern image formed on an image support or a pattern image formed in the end in the pattern formation process and also frequently uses the carrier liquid as a cleaning liquid in the cleaning process to do the cleaning of toner particles attached to the image support after pattern formation. Thus, a large amount of carrier liquid containing toner particles is discharged as a waste liquid. Therefore, in a pattern formation apparatus using conventional wet-type electrophotography, for example, a small amount of non-transferred liquid developer remaining on an image support is collected, toner solid content is removed, a unit to separate/extract a carrier liquid for recycling is provided, and the recycled carrier liquid is added to the developer, which is a developing means. As a filter of the carrier liquid separation unit, for example, a continuous cell body acting as a liquid diffusion suppressing member to suppress diffusion of a collected developer and a pair of flat electrodes to which mutually different potentials are applied to exert an electric field to the collected developer being passed through the continuous cell body are provided. This allows to electrodeposit solely toner solid content charged positively on one electrode to which a negative voltage is applied and to separate the carrier liquid into a carrier liquid collection tank for extraction.

However, while the toner solid content can be removed by a pattern formation apparatus using conventional wet-type electrophotography, there is a problem that so-called metallic soap added to the developer as an ionic compound is not electrodeposited on an electrode and thus cannot be removed.

Thus, a method of using an adsorbent is known as a method of removing ionic compounds (See, for example, Jpn. Pat. Appln. KOKAI Publication No. 2004-117772). According to this method, metallic soap is removed and a carrier liquid is recycled by using an ionic compound removal device housing an ion adsorbent chemically adsorbing ions to remove ionic compounds contained in a collected liquid through adsorption of ionic compounds by the adsorbent. Also, according to this method, toner solid content is removed by a filter, which is separately attached.

However, according to the above method, there is no holding mechanism of an adsorbent and therefore, it is necessary to make a contact time of the ion adsorbent and a collected carrier liquid longer by causing 100 g of the adsorbent to pass through the collected liquid at a very slow carrier flow rate of 10 ml/min. Thus, this method has a disadvantage that treatment efficiency is very low because treatment capabilities cannot be increased per unit time. There is also a problem that the adsorbent is likely to precipitate in the liquid and thus, only an adsorbent in the outermost surface layer can exert an adsorption capability and adsorbents in other layers cannot exert an adsorption capability, leading to lower adsorption efficiency per unit amount of the adsorbent used. Further, there is a problem of the troublesomeness that ion adsorbents precipitated at the bottom need to be stirred in the ionic compound removal device.

According to this method, toner solid content and ionic compounds cannot be removed simultaneously. Also, this method has a disadvantage that whether the adsorbent has been saturated can be determined only by monitoring the content of ionic compounds in the recycled carrier liquid passing through the ionic compound removal device for a long time to detect a state in which no change occurs and thus, it is very difficult to determine when to replace the adsorbent.

### BRIEF SUMMARY OF THE INVENTION

An object of the present invention is to provide a cleaning apparatus capable of satisfactorily doing the cleaning of charged particles held by an image support, and provide a cleaning method.

Another object of the present invention is to provide a pattern formation apparatus capable of removing ionic compounds and toner solid content simultaneously from a waste liquid of liquid developer and whose treatment capabilities per unit time and adsorption efficiency per unit time of an adsorbent used are excellent, and to provide a pattern formation method.

To achieve the above-described object, in the present invention, a cleaning apparatus which cleans an intaglio after making a transcription to a transferred medium by aggregating developer particles in a pattern-like recess, has: a supply device which supplies a cleaning liquid to the recess; and a removal device which removes the developer particles remaining in the recess together with the cleaning liquid supplied by the supply device.

Moreover, in the present invention, a cleaning apparatus which cleans a recess after a transcription incorporated in a pattern formation apparatus that supplies a liquid developer in which charged developer particles are dispersed in an insulating liquid to an intaglio having the pattern-like recess, aggregates the developer particles in the liquid developer into the recess by action of an electric field near the recess, and makes a transcription to a transferred medium by the action of an electric field on the developer particles aggregated in the recess, comprises: a supply device which supplies a cleaning liquid to the recess; and a removal device which removes the developer particles remaining in the recess together with the cleaning liquid supplied by the supply device.

Furthermore, in the present invention, a cleaning method for cleaning an intaglio after making a transcription to a transferred medium by aggregating developer particles in a pattern-like recess, comprises: a supply step of supplying a cleaning liquid to the recess; and a removal step of removing the developer particles remaining in the recess together with the cleaning liquid supplied by the supply step.

According to the above invention, when developer particles remaining on the recess of an intaglio were removed after transferring the developer particles to a transferred medium, by supplying the cleaning liquid to the recess and the developer particles attached to the recess were liberated in the cleaning liquid, then the developer particles attached to the recess are removed together with the cleaning liquid. Thus, the intaglio can reliably remove the developer particles adhering to the recess and can transfer the highly resolution and fine patterns to the transferred medium.

Moreover, in the present invention, a cleaning apparatus which cleans an image support holding a pattern image by charged particles to transfer the pattern image to a transferred medium, comprises: an electrode arranged near and opposite to the image support to cause the charged particles held by the image support to be adsorbed by forming an electric field between the electrode and image support; and a liquid flow device which fills a space between the electrode and the image support with a cleaning liquid and causing the cleaning liquid to circulate the charged particles adsorbed by the electrode after causing the electric field to disappear.

Moreover, a pattern formation apparatus of the present invention, comprises: a holding mechanism which holds a flat-plate transferred medium; a drum-like image support; a rolling mechanism which rolls the image support along the transferred medium held by the holding mechanism; an image formation apparatus which forms a pattern image by charged particles on a circumferential surface of the image support; a transfer device which transfers the pattern image on the circumferential surface to the transferred medium by forming an electric field between the rolling image support and the transferred medium; and a cleaning apparatus which cleans the circumferential surface of the image support, wherein the cleaning apparatus has: an electrode arranged near and opposite to the image support to cause the charged particles held on the circumferential surface to be adsorbed by forming the electric filed between the electrode and image support; and a liquid flow device which fills a space between the electrode and the circumferential surface of the image support with a cleaning liquid and causing the cleaning liquid to circulate the charged particles adsorbed by the electrode after causing the electric field to disappear.

Furthermore, in the present invention, a cleaning method for cleaning an image support holding a pattern image by charged particles to transfer the pattern image to a transferred medium, comprises steps of: arranging an electrode near and opposite to the image support; filling a space between the electrode and the image support with a cleaning liquid; causing the electrode to adsorb the charged particles held by the image support by forming an electric field between the electrode and the image support; and causing the cleaning liquid filling the space between the electrode and the image support to circulate to flow the charged particles adsorbed by the electrode after causing the electric field to disappear.

According to the above invention, when charged particles held by an image support were removed, the charged particles held by the image support ware caused to adsorb by the electrode by causing to fill a space between an electrode near and opposite to the image support and forming an electric field between the electrode and the image support. The cleaning liquid circulated to flow the charged particles adsorbed by the electrode after the electric field was caused to disappear. Accordingly, a larger amount of the charged particles left on the image support, for example, due to failure of development can satisfactorily be removed.

Moreover, a cleaning apparatus of the present invention, comprises: a liquid flow device which fills a surface of an image support with a cleaning liquid and flowing the cleaning liquid; and an ultrasonic device which causes the cleaning liquid to penetrate into remaining developer particles by application of ultrasonic waves on the developer particles remaining on the image support while the surface of the image support is filled with the cleaning liquid.

According to the above invention, the developer particles are made to be soaked when the cleaning liquid is flowing, by making developer particles, which remain on the surface, soaked under the influence of ultra sonic waves and causing the cleaning liquid to penetrate into the developer particles, in a state where the surface of the image support is filled with the cleaning liquid. Thus, the developer particles remaining on the image support can be effectively removed. Accordingly, a larger amount of the charged particles left on the image support, for example, due to failure of development can satisfactorily be removed. In particular, the invention is effective when the intaglio having a pattern-like recess which houses the developer particles on the surface of the image support, is used.

Moreover, in the present invention, a cleaning apparatus which cleans an image support holding a pattern image by charged particles to transfer the pattern image to a transferred medium, comprises: a liquid flow device which fills a surface of the image support with a cleaning liquid and flows the cleaning liquid; an ultrasonic device which causes the cleaning liquid to penetrate into the remaining developer particles by application of ultrasonic waves on the developer particles remaining on the image support while the surface of the image support is filled with the cleaning liquid; and a conductive member arranged near and opposite to the surface of the image support to cause the charged particles held by the image support to be adsorbed by forming an electric field between the image support and the conductive member.

According to the above invention, the developer particles are caused to adsorb by a conductive member by making the developer particles remaining in a state where the surface of the image support is filled with the cleaning liquid soaked under the influence of ultrasonic waves and by the action of the electric field on such developer particles. After causing the electric field to disappear, the image support can be satisfactorily cleaned by circulating the cleaning liquid and easily removing the developer particles remaining on the image support.

Moreover, in the present invention, a cleaning method for cleaning an image support holding a pattern image by developer particles to transfer the pattern image to a transferred medium, comprises: a step of filling a surface of the image support with a cleaning liquid; an ultrasonic wave generation step of causing the cleaning liquid to penetrate into the remaining developer particles by application of ultrasonic waves on the developer particles remaining on the image support; and a liquid flow step of flowing the cleaning liquid filling the surface of the image support.

Moreover, in the present invention, a cleaning method for cleaning an image support holding a pattern image by charged particles to transfer the pattern image to a transferred medium, comprising: a step of filling a surface of the image support with a cleaning liquid; an ultrasonic wave generation step of causing the cleaning liquid to penetrate into the remaining charged particles by application of ultrasonic waves on the charged particles remaining on the image support; a step of causing a conductive member to adsorb the charged particles held by the image support by forming an electric field between the conductive member arranged near and opposite to the surface of the image support and the image support; and a liquid flow step of flowing the charged particles adsorbed by the conductive member by flowing the cleaning liquid filling the surface of the image support after causing the electric field to disappear.

Furthermore, A pattern formation apparatus of the present invention, has: an image support; a pattern formation unit provided opposite to the image support and having a development part for forming a toner image by developing an electrostatic latent image formed on the image support using a liquid developer including toner containing an ionic compound and a carrier liquid, and a transfer part for transferring the toner image to a transfer medium; a waste liquid collection line connected to the pattern formation unit to collect a waste liquid containing toner solid content, ionic compounds, and the carrier liquid; a waste liquid treatment unit that is connected to the collection line, has a conductive barrier structure having perforations of 30 to 100 μm in diameter, and includes a strainer which removes the toner solid content and the ionic compounds in the waste liquid, and an input part provided upstream of the strainer to introduce adsorbent particles; and a recycled liquid supply line which returns the treated waste liquid discharged from the waste liquid treatment unit to the pattern formation unit, wherein the strainer serves waste liquid treatment by causing to form an adsorbent particle layer of 0.5 mm to 10 mm in thickness by allowing to pass the waste liquid or the carrier liquid to which adsorbent particles having a maximum frequency of particle diameter distribution in a range of 5 μm to 100 μm have been added.

### BRIEF DESCRIPTION OF THE SEVERAL VIEWS OF THE DRAWING

FIG. 1 is a perspective view showing an outline configuration of a pattern formation apparatus according to an embodiment of the present invention.

FIG. 2 is a plan view A and a sectional view B of an original plate used by the pattern formation apparatus in FIG. 1.

FIG. 3 is a partially enlarged plan view of the original plate in FIG. 2.

FIG. 4 is a partially enlarged plan view illustrating a structure of one recess of the original plate in FIG. 2.

FIG. 5 is a schematic diagram showing a state in which the original plate in FIG. 2 is wound around a drum element tube.

FIG. 6 is a schematic diagram showing the configuration for charging the surface of a high-resistance layer of the original plate in FIG. 2.

FIG. 7 is a schematic diagram showing the configuration for forming a pattern by toner particles by supplying a liquid developer to the original plate in FIG. 2.

FIG. 8 is a schematic diagram showing the configuration for transferring a pattern formed on the original plate in FIG. 2 to a glass plate.

FIG. 9 is a schematic diagram showing the configuration of principal parts of a rolling mechanism for rolling the original plate in FIG. 2 along the glass plate.

FIG. 10 is an operation illustration diagram illustrating an operation to transfer toner particles gathered in the recess of an intaglio to the glass plate.

FIG. 11 is a schematic representation showing a cleaner according to a first embodiment of the present invention for cleaning the intaglio.

FIG. 12 is a diagram illustrating a spraying angle of a cleaning liquid by the cleaner in FIG. 11.

FIG. 13 is a schematic diagram showing a state in which the cleaning liquid is sprayed on the recess of the intaglio.

FIG. 14 is a schematic diagram showing a state in which toner particles are liberated by spraying of the cleaning liquid.

FIG. 15 is a schematic diagram showing a state in which a removal roller is slidingly brought into contact with the recess after spraying of the cleaning liquid.

FIG. 16 is a schematic diagram showing a state in which toner particles are sucked together with the cleaning liquid by bringing the removal roller into contact with an opening of the recess.

FIG. 17 is a schematic representation showing a cleaner according to a second embodiment of the present invention.

FIG. 18 is a schematic representation showing a cleaner according to a third embodiment of the present invention.

FIG. 19 is a schematic representation showing a cleaner according to a fourth embodiment of the present invention.

FIG. 20 is a schematic representation showing a cleaner according to a fifth embodiment of the present invention.

FIG. 21 is a schematic representation showing a cleaner according to a sixth embodiment of the present invention.

FIG. 22 is a schematic representation showing the structure of principal parts of a cleaner according to a seventh embodiment of the present invention.

FIG. 23 is a schematic representation showing the structure of principal parts of a cleaner according to an eighth embodiment of the present invention.

FIG. 24 is a schematic representation showing the structure of principal parts of a cleaner according to a ninth embodiment of the present invention.

FIG. 25 is a schematic representation showing a cleaner according to a tenth embodiment of the present invention.

FIG. 26 is a diagram illustrating a method of determining an amount of developer particles remaining in the recess.

FIG. 27 is a schematic diagram showing a cleaning apparatus according to the first embodiment of the present invention.

FIG. 28 is an operation illustration diagram showing a state in which a space between the original plate and an electrode in the cleaning apparatus in FIG. 27 is filled with the cleaning liquid.

FIG. 29 is an operation illustration diagram showing a state in which an electric field is formed between the original plate and the electrode to cause the electrode to adsorb developer particles from the state shown in FIG. 28.

FIG. 30 is an operation illustration diagram showing a state in which the cleaning liquid is caused to circulate to flow developer particles from the state shown in FIG. 29.

FIG. 31 is a schematic diagram showing a cleaning apparatus according to the second embodiment of the present invention.

FIG. 32 is a schematic diagram showing a cleaning apparatus according to the third embodiment of the present invention.

FIG. 33 is a schematic diagram showing a cleaning apparatus according to the fourth embodiment of the present invention.

FIG. 34 is a schematic diagram showing a cleaning apparatus according to the fifth embodiment of the present invention.

FIG. 35 is a schematic diagram showing a cleaning apparatus according to the sixth embodiment of the present invention.

FIG. 36 is a diagram illustrating a voltage applied to constituent members of the apparatus in FIG. 35.

FIG. 37 is a schematic representation showing a cleaner according to an eleventh embodiment of the present invention.

FIG. 38 is a block diagram of a control system controlling the operation of a cleaning apparatus according to the seventh embodiment of the present invention.

FIG. 39 is a diagram illustrating a method of determining the amount of developer particles remaining in the recess.

FIG. 40 is a schematic diagram showing a cleaning apparatus according to the seventh embodiment of the present invention.

FIG. 41 is a flow chart illustrating the operation of the cleaning apparatus in FIG. 40.

FIG. 42 is an operation illustration diagram showing a state in which a space between the original plate and an electrode in the cleaning apparatus in FIG. 40 is filled with the cleaning liquid.

FIG. 43 is an operation illustration diagram showing a state in which developer particles are softened by providing an ultrasonic wave to between the original plate and the electrode from the state shown in FIG. 42.

FIG. 44 is an operation illustration diagram showing a state in which the cleaning liquid is caused to circulate to flow developer particles from the state shown in FIG. 43.

FIG. 45 is a graph showing a relationship between a frequency and a cleaning index about a cleaning effect when A and B particles are cleaned.

FIG. 46 is a diagram illustrating a calculation method of the cleaning index.

FIG. 47 is a table showing a relationship between the frequency of an ultrasonic wave provided for cleaning of an original plate and damage to the original plate.

FIG. 48 is a schematic diagram showing the embodiment excluding a cleaner from the pattern formation apparatus in FIG. 1.

FIG. 49 is a schematic diagram showing a cleaning apparatus according to the eighth embodiment of the present invention.

FIG. 50 is a block diagram showing a control system controlling the operation of the cleaning apparatus in FIG. 49.

FIG. 51 is a flow chart illustrating the operation of the cleaning apparatus in FIG. 49.

FIG. 52 is an operation illustration diagram showing a state in which a space between the original plate and an electrode in the cleaning apparatus in FIG. 49 is filled with the cleaning liquid.

FIG. 53 is an operation illustration diagram showing a state in which developer particles are softened by providing an ultrasonic wave to between the original plate and the electrode from the state shown in FIG. 52.

FIG. 54 is an operation illustration diagram showing a state in which developer particles are attracted to the electrode by forming an electric field between the original plate and the electrode from the state shown in FIG. 53.

FIG. 55 is an operation illustration diagram showing a state in which developer particles are adsorbed by the electrode from the state in FIG. 54.

FIG. 56 is an operation illustration diagram showing a state in which the cleaning liquid is caused to circulate to flow developer particles from the state shown in FIG. 55 by causing the electric field to disappear.

FIG. 57 is a schematic diagram showing a first modification of the cleaning apparatus in FIG. 49.

FIG. 58 is a diagram showing a state in which the surface of the original plate is wet with the cleaning liquid in the cleaning apparatus in FIG. 57.

FIG. 59 is a diagram showing a state in which an electric field and an ultrasonic wave are generated between the electrode and the original plate from the state in FIG. 58.

FIG. 60 is an operation illustration diagram showing a state in which the cleaning liquid is caused to circulate to flow developer particles from the state shown in FIG. 59 by causing the electric field to disappear.

FIG. 61 is a schematic diagram showing a second modification of the cleaning apparatus in FIG. 49.

FIG. 62 is a schematic diagram showing a third modification of the cleaning apparatus in FIG. 49.

FIG. 63 is a diagram illustrating a voltage provided to each component of the cleaning apparatus in FIG. 62.

FIG. 64 is a schematic diagram showing a cleaning apparatus according to the ninth embodiment of the present invention.

FIG. 65 is a diagram showing a state in which a space between the original plate and an electrode in the cleaning apparatus in FIG. 64 is filled with the cleaning liquid.

FIG. 66 is a diagram showing a state in which a portion into which the liquid has not penetrated is present before generating an ultrasonic wave in the state in FIG. 65.

FIG. 67 is a diagram illustrating how penetration of the cleaning liquid is proceeding when an ultrasonic wave is provided in the state in FIG. 66.

FIG. 68 is a diagram illustrating the operation of spraying the cleaning liquid by a spraying unit incorporated in the cleaning apparatus in FIG. 64.

FIG. 69 is a schematic representation showing an outline of an exemplary pattern formation apparatus according to another embodiment of the present invention.

FIG. 70 is a schematic representation illustrating the configuration of an exemplary waste liquid treatment mechanism applied to a pattern formation apparatus according to the present invention.

FIG. 71 is a schematic representation showing the configuration of an exemplary filter used for the waste liquid treatment mechanism.

FIG. 72 is an enlarged view of a portion of the barrier structure in FIG. 71.

FIG. 73 is a diagram illustrating an exemplary operation in the adsorbent particle layer in FIG. 72.

FIG. 74 is a graph diagram showing a relationship between the amount of introduced adsorbent and that of removed metallic soap.

FIG. 75 is a graph diagram showing a relationship between the number of times of circulation in a waste liquid treatment unit and the amount of removed metallic soap.

FIG. 76 is a graph diagram showing a relationship between saturation of adsorbent particles and conductivity of a waste liquid.

FIG. 77 is a schematic representation showing the configuration of another exemplary barrier structure used for a strainer in the waste liquid treatment mechanism.

FIG. 78 is a partially enlarged view of the barrier structure in FIG. 77.

FIG. 79 is a schematic representation showing the configuration of another exemplary barrier structure used for the strainer in the waste liquid treatment mechanism.

FIG. 80 is an enlarged view of the barrier structure in FIG. 79.

FIG. 81 is a diagram showing the configuration of a stainless plate used as the barrier structure in FIG. 79.

FIG. 82 is a schematic representation showing the state of a cross section of a barrier structure gap in FIG. 81.

FIG. 83 is a schematic representation showing the outline of an exemplary pattern formation apparatus according to another embodiment of the present invention.

FIG. 84 is a diagram illustrating the configuration of an intaglio drum used for the pattern formation apparatus in FIG. 83.

FIG. 85 is a diagram illustrating the configuration of a wiring substrate manufacturing apparatus used for manufacturing circuit boards.

FIG. 86 is a diagram schematically showing the constitution of a liquid developer usable in the present invention.

FIG. 87 is a diagram schematically showing the configuration of the liquid developer usable in the present invention.

FIG. 88 is a diagram schematically showing the configuration of the cross section of a circuit board using a pattern formed according to the present invention.

FIG. 89 is a graph showing a criterion for replacing the adsorbent.

### DETAILED DESCRIPTION OF THE INVENTION

Embodiments of the present invention will be described below with reference to drawings.

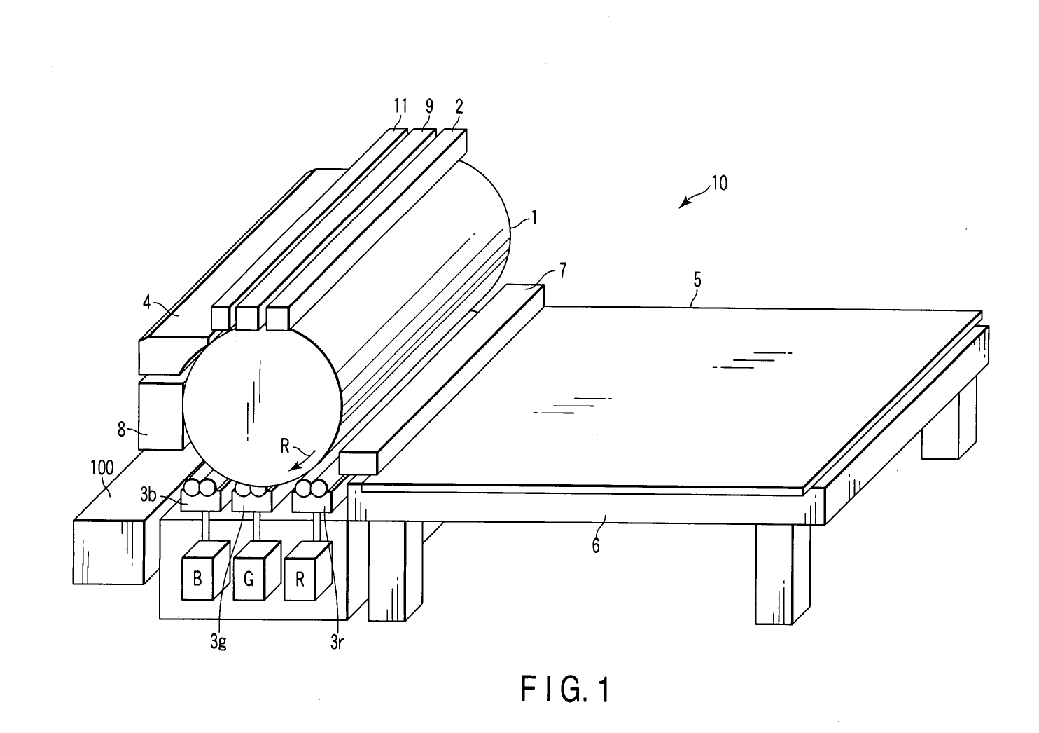

As shown in FIG. 1, a pattern formation apparatus 10 according to the present invention has an original plate 1 (intaglio, image support) wound around a drum element tube (described later) rotating in the clockwise direction (in an arrow R direction) in FIG. 1, a charger 2 for charging a high-resistance layer, described later, of the original plate 1 by providing charges, a plurality of developing machines 3r, 3g, and 3b (hereinafter, may be generically called a developing machine 3) for development by supplying liquid developers of each color (r: red; g: green; b: blue) to the original plate 1, a drier 4 for drying solvent components of liquid developers attached to the original plate 1 during development by air blowing for vaporization, a stage 6 (holding mechanism) for holding at a fixed position a glass plate 5 to be a transferred medium on which patterns are formed by transferring developer particles attached to the original plate 1, a coating applicator 7 for applying a high-resistance or insulating solvent to the surface of the glass plate 5 before the transcription, a cleaner 8 for cleaning the original plate 1 after the transcription, a cleaning apparatus 100 that, when a larger amount of developer particles (charged particles) than normal is attached to the original plate 1, does the cleaning of the relatively large amount of developer particles, and a static eliminator 9 for eliminating charges from the original plate 1. A detector 11 (detection device) for detecting the amount of developer particles remaining on the original plate 1 is arranged upstream from the static eliminator 9 in the rotation direction R of the drum element tube facing each other. The charger 2, the developing machine 3, and the drier 4 function as an image formation apparatus of the present invention.

Liquid developers housed in the developing machines 3r, 3g, and 3b of each color are a hydrocarbon-based or silicon-based insulating solvent in which charged particles are dispersed and development proceeds when these particles undergo electrophoresis due to an electric field. Particles can be constructed by surrounding phosphor particles of each color of about 4 [μm] in average particle diameter by resin particles whose average particle diameter is smaller than that of phosphor particles and dissociating in an electric field ions from resin particles, which have ionic charged sites and are thereby charged, by including pigment particles of each color inside resin particles, or by supporting pigment particles of each color on the surface of resin particles.

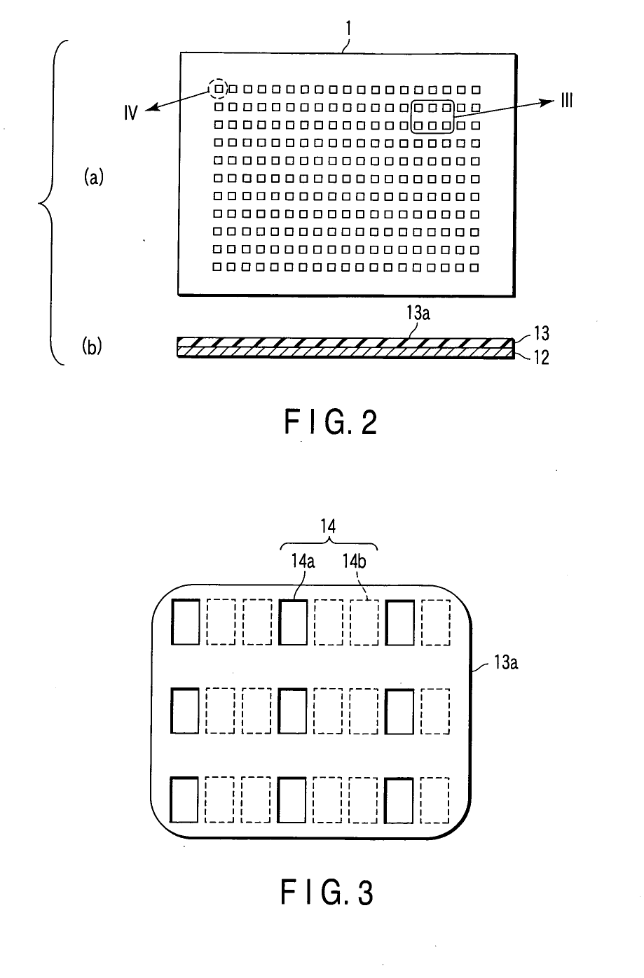

As shown in FIG. 2A as a plan view, the original plate 1 is formed as a rectangular thin plate. The original plate 1 is constructed, as shown in FIG. 2B as a sectional view, by forming a high-resistance layer 13 on the surface of a metallic film 12 (conductive member) in a rectangular shape having a thickness of 0.05 [mm] to 0.4 [mm], preferably 0.1 [mm] to 0.2 [mm].

The metallic film 12 has flexibility and can be constructed from materials such as aluminum, stainless steel, titanium, and amber and also from polyimide or PET on which a metal is evaporated. However, in order to form transfer patterns with high position precision, it is preferable to construct the metallic film 12 from materials that resist elongation caused by thermal expansion or stress.

The high-resistance layer 13 is formed from materials (including insulators) whose volume resistivity is 10¹⁰ [Ωcm] or more, for example, polyimide, acrylics, polyester, urethane, epoxy, Teflon (registered trademark), nylon, and publicly known resist materials, and the thickness thereof is 10 [μm] to 40 [μm] and preferably, 20 [μm]+5 [μm].

On a surface 13a of the high-resistance layer 13 of the original plate 1, a pattern 14 in which many rectangular recesses 14a as shown in FIG. 3 as an enlarged view are aligned and arranged is formed. In the present embodiment, for example, as an intaglio for manufacturing phosphor screens formed on the front substrate of flat type image display apparatuses, only the recesses 14a corresponding to pixels for one color are formed, by depressing the surface 13a of the high-resistance layer 13 and space is only reserved in areas 14b for the other two colors denoted by broken lines in FIG. 3 without forming recesses. That is, areas are reserved for shifting the original plate 1 relative to the transferred medium for each color when a color pattern is formed using the original plate 1.

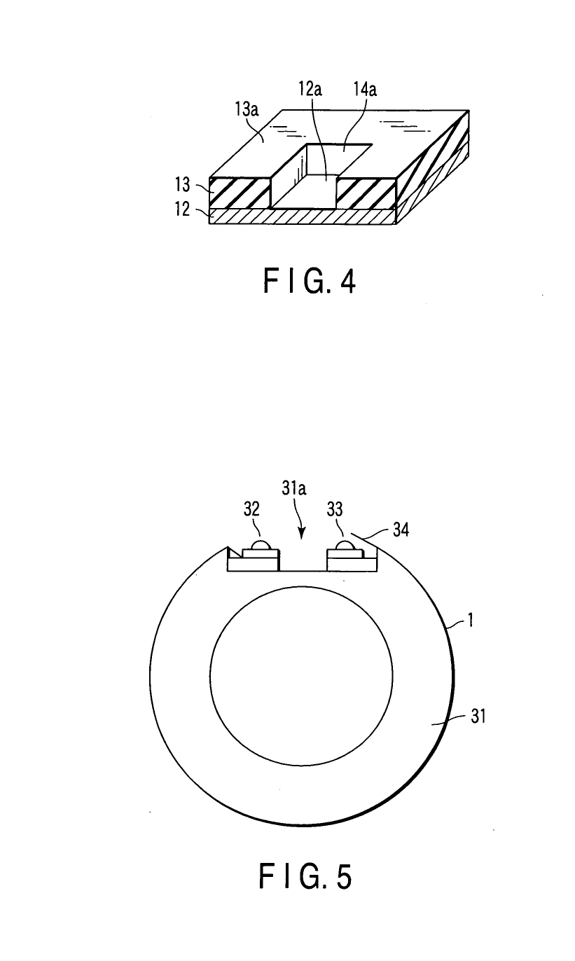

FIG. 4 shows a sectional view of the original plate 1 by enlarging one recess 14a. In the present embodiment, a surface 12a of the metallic film 12 is exposed at the bottom of the recess 14a and the depth of the recess 14a approximately corresponds to the thickness of the high-resistance layer 13. Preferable characteristics with improved transfer characteristics can be obtained by coating the whole surface of the original plate 1, including the surface 12a of the metallic film 12 exposed at the bottom of the recess 14a and the surface 13a of the high-resistance layer 13, with a surface releasing layer having a thickness of about 0.5 [μm] to 3 [μm]. Or, transfer characteristics can also be improved by forming the high-resistance layer 13 on the metallic film 12 coated with a surface releasing layer in which the releasing layer is exposed only at the bottom of the recess 14a (not shown).

FIG. 5 shows an outline sectional view depicting how the film-like original plate 1 having the above structure is wound around a drum element tube 31. A clamp 32 to fix one end of the original plate 1 and a clamp 33 to fix the other end are provided in a cutout portion 31a of the drum element tube 31 in the upper part of FIG. 5. To wind the original plate 1 around the drum element tube 31, one end of the original plate 1 is fixed to the clamp 32, and then another end 34 is fixed to the clamp 33 while stretching the original plate 1. Accordingly, the original plate 1 can be wound around at a specified position on a circumferential surface of the drum element tube 31 without slackening.

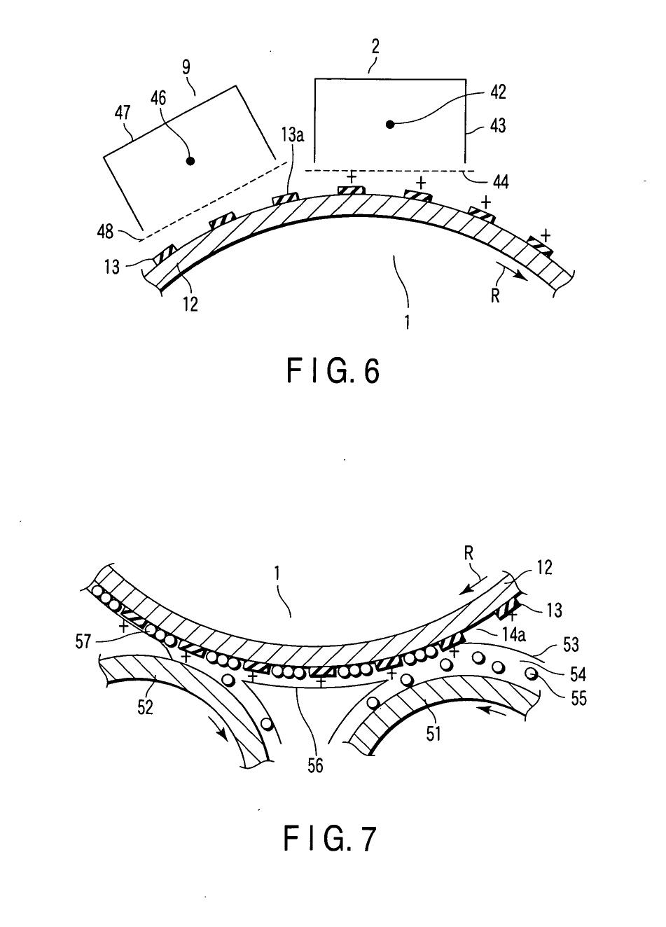

FIG. 6 is a partial configuration diagram illustrating a process in which the surface 13a of the high-resistance layer 13 of the original plate 1 wound around the drum element tube 31 as described above is charged by the charger 2. The charger 2 is a well-known corona charger basically constructed from a corona wire 42 and a shield case 43, which can improve the uniformity of charging by providing a mesh grid 44. The surface 13a of the high-resistance layer 13 is uniformly charged at substantially +500 [V], for example, by grounding the metallic film 12 and the shield case 43 of the original plate 1, applying a voltage of +5.5 [kV] by a power unit (not shown), and further applying a voltage of +500 [V] to the grid 44 to move the original plate 1 in an arrow R direction in FIG. 6.

The static eliminator 9 shown in FIG. 6 has almost the same structure as that of the charger 2, but the surface 13a of the high-resistance layer 13 of the original plate 1 can be discharged to be substantially 0 [V] before the surface 13a is charged by the charger 2 by connecting to an AC power supply to apply an AC voltage of, for example, the effective voltage 6 [V] and the frequency 50 [Hz] to a corona wire 46 and setting up a shield case 47 and a grid 48 so that repetitive charging characteristics of the high-resistance layer 13 can be stabilized.

FIG. 7 shows a diagram illustrating a development operation on the original plate 1 charged as described above. For the development, the developing machine 3 of the color to be developed is placed opposite to the original plate 1 and a developing roller 51 (supply member) and a squeeze roller 52 are brought close to the original plate 1 to supply the liquid developer to the original plate 1. The circumferential surface of the developing roller 51 is arranged at a position opposite to the surface 13a of the high-resistance layer 13 of the original plate 1 to be transported via a gap of about 100 to 150 [μm] and rotates in the same direction (counterclockwise direction in FIG. 7) as the rotation direction of the original plate 1 at a speed about 1.4 or 1.5 times that of the original plate 1.

A liquid developer 53 supplied to the circumferential surface of the developing roller 51 by a supply system (not shown) is constructed by dispersing charged toner particles 55 as developer particles in a solvent 54 as an insulating liquid, and is supplied to the circumferential surface of the original plate 1 with rotation of the developing roller 51. Here, if a voltage of, for example, +250 [V] is applied to the developing roller 51 by a power unit (not shown), the positively charged toner particles 55 migrate through the solvent 54 toward the metallic film 12 at an earth potential to be gathered inside the recess 14a of the original plate 1. At this point, the surface 13a of the high-resistance layer 13 is charged at about +500 [V] and thus, the positively charged toner particles 55 are repelled by the surface 13a and do not adhere to the surface 13a.

After the toner particles 55 are gathered inside the recess 14a of the original plate 1 in this manner, the liquid developer 53, whose concentration of the toner particles 55 has become lower, continues to enter a gap between the squeeze roller 52 and the original plate 1 facing each other. Here, the gap (the distance between the surface 13a of the insulating layer 13 and the surface of the squeeze roller 52) is set to be 30 [μm] to 50 [μm], the potential of the squeeze roller is set at +250 [V] and the squeeze roller 52 is set to move in the direction opposite to that of the original plate 1 at a speed three times to five times that of the original plate 1 and therefore, while development is further being promoted, an effect of squeezing out a portion of a solvent 56 attached to the original plate 1 is simultaneously achieved. In this manner, a toner pattern 57 is formed in the recess 14a of the original plate 1.

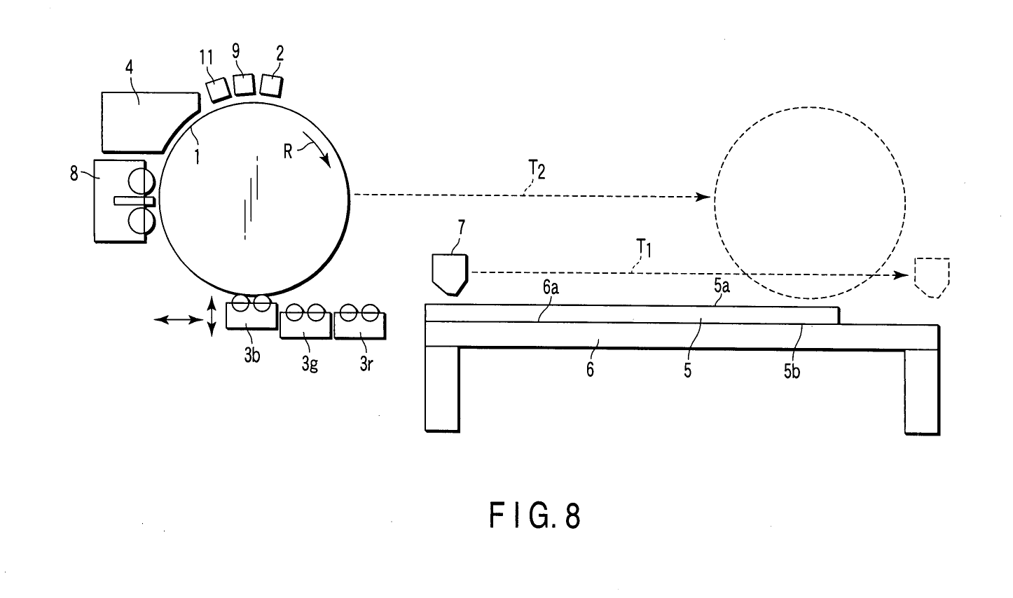

Incidentally, when a pattern of three-color phosphors is formed on the glass plate 5, as shown in FIG. 8, the developing machine 3b housing a liquid developer containing blue phosphor particles first moves to immediately below the original plate 1 and here, the developing machine 3b is lifted by a rising and falling mechanism (not shown) to bring the developing machine 3b closer to the original plate 1. In this state, the original plate 1 rotates in the arrow R direction to develop a pattern using the recess 14a. When the development of the blue pattern is completed, the developing machine 3b is lowered to separate from the original plate 1.

In the course of the blue development process, the coating applicator 7 held over the stage 6 after being transported in advance by a conveying machine (not shown) moves along the surface separated from the stage 6 of the glass plate 5 in a broken line arrow T1 direction to apply a solvent to the surface of the glass plate 5. The role of the solvent and material composition thereof will be described later. The method of applying the solvent will also be described later in detail.

Thereafter, the original plate 1 supporting the blue pattern on the circumferential surface thereof rotates to move in a broken line arrow T2 direction in FIG. 8 (this operation is called rolling) and a blue pattern image is transferred to the surface of the glass plate 5. Details of the transfer will also be described later. After completing the transfer of the blue pattern, the original plate 1 is translated to the left in FIG. 8 to return to the initial position for development. At this point, the stage 6 holding the glass plate 5 goes down to avoid contact with the original plate 1 returning to the initial position.

Then, the cleaner 8 is activated to do the cleaning of blue developer particles remaining on the original plate 1. The cleaner 8 that performs a normal cleaning operation after the transfer process of developer particles of each color is completed. The cleaner 8 will also be described later in detail.

Next, the developing machines 3r, 3g, and 3b of the three colors move to the left in FIG. 8 and stop when the green developing machine 3g is positioned immediately below the original plate 1. Like the blue pattern development, the developing machine 3g is lifted for development before being lowered. Subsequently, a green pattern is transferred from the original plate 1 to the surface of the glass plate 5 by the same operation as that described above. At this point, the transfer position of the green pattern on the surface of the glass plate 5 is naturally shifted for one color from that of the blue pattern described above. Also, after the green pattern is transferred, the original plate 1 is cleaned by the cleaner 8.

Then, the above operation is repeated for red development to form a pattern image in three colors on the surface of the glass plate 5 by transferring patterns in three colors to the surface of the glass plate 5 in such a way that these patterns are aligned. Thus, by holding the glass plate 5 to fix the plate at a fixed position and moving the original plate 1 relative to the glass plate 5, the need for reciprocation movement of the glass plate 5 is eliminated so that reservation of a large movement space and enlargement of devices can be controlled.

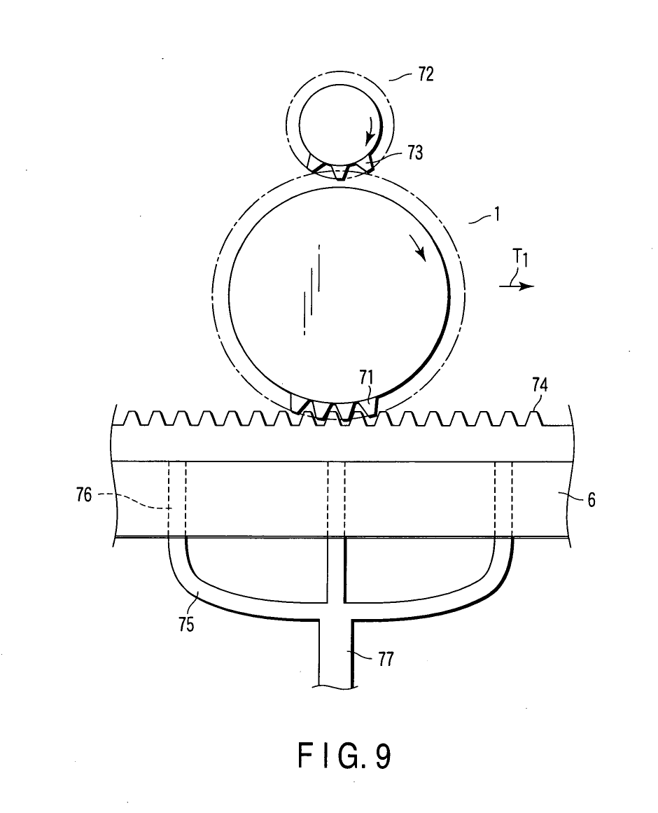

FIG. 9 shows the structure of principal parts of a rolling mechanism for causing the original plate 1 to roll along the glass plate 5. A gear 71, called a pinion, is mounted on both ends in the axial direction of the drum element tube 31 around whose circumferential surface the original plate 1 is wound. The original plate 1 rotates by engagement of the gear 71 and a driving gear 73 of a motor 72 and also is translated to the right in FIG. 9 by engagement of a rack 74 on a linear track set up at both ends of the stage 6 and the pinion (the gear 71). At this point, the structure of each part of the rolling mechanism is designed so that a relative shift should not arise between the surface of the glass plate 5 held on the stage 6 and the circumferential surface of the original plate 1. An operation to move in parallel along the glass plate 5 while rotating is called rolling.

Owing to use of such a rack-and-pinion mechanism, because there is no idle pulley for drive transmission, high-precision rotation/translation driving without backlash can be realized so that a high-precision pattern with high position precision such as ±5 [μm] can be transferred onto the glass plate 5.

On the other hand, the glass plate 5 (not shown in FIG. 9) is arranged on the stage 6 in such a way that, as shown in FIG. 8, substantially the whole surface of a back surface 5b (the surface on the side separated from the original plate 1) thereof is caused to be in contact with a flat contact surface 6a of the stage 6. In addition, a negative pressure acts on the glass plate 5 via an adsorption hole (not shown) opened to the contact surface 6a of an inlet 76 by connecting a vacuum pump (not shown) to the inlet 76 extending to the contact surface 6a through the stage 6 from a connection pipe 76 via a main pipe 77 so that the glass plate 5 is adsorbed onto the contact surface 6a of the stage 6. Thus, substantially the whole surface of the back surface 5b of the glass plate 5 is pressed against the contact surface 6a having high flatness by this adsorption mechanism for close contact so that the glass plate 5 is held on the stage 6 in a state of high flatness. Thus, by pressing the glass plate 5 against the flat contact surface 6a, distortion and the like of the glass plate 5 can also be corrected so that the relative position with the original plate 1 can be maintained with high precision.

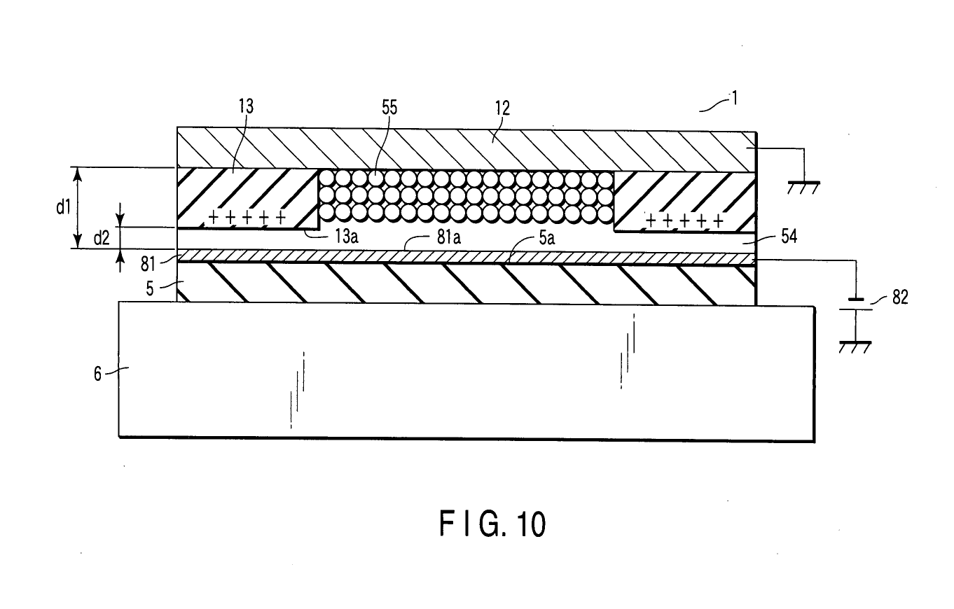

FIG. 10 is a sectional view of principal parts for illustrating how the toner particles 55 are transferred from the original plate 1 to the glass plate 5. A conductive layer 81 constituted, for example, by conductive polymers has been applied to a surface 5a of the glass plate 5, and a surface 81a of the conductive layer 81 and the surface 13a of the high-resistance layer 13 of the original plate 1 are set up in a non-contact state via a gap d2. d2 is set as a value in the range of, for example, 10 [μm] to 40 [μm]. If the thickness of the high-resistance layer 13 is, for example, 20 [μm], the distance between the metallic film 12 and the surface 81a of the conductive layer 81 will be 30 [μm] to 60 [μm]. Or, the conductive layer 81 applied to the surface 5a of the glass plate 5 and the surface 13a of the high-resistance layer 13 of the original plate 1 may be brought into contact.

If a voltage of, for example, −500 [V] is applied to the conductive layer 81 via a power unit 82 (transcriber) in this state, a potential difference of 500 [V] is formed with respect to the metallic film 12 at the earth potential and an electric field thereof causes electrophoresis of the toner particles 55 through the solvent 54, which are transferred to the surface 81a of the conductive layer 81. Since the toner particles 55 can be transferred even in a non-contact state, as described above, there is no need to place an elastic body such as a blanket or flexo plate, as used in offset printing and flexographic printing, and a transfer with high position precision can always be realized. After the toner particles 55 are transferred, the conductive layer 81 is removed by putting the glass plate 5 into a baking furnace (not shown) for burning.

If toner particles are transferred to the glass plate 5 using an electric field, as described above, it is required that a solvent be present in a transfer gap to wet a space between the conductive layer 81 on the glass plate 5 side and the original plate 1, and so, it is effective to pre-wet the surface 5a of the glass plate 5 prior to a transfer with a solvent. Any insulating or high-resistance solvent may be used as a pre-wet solvent, but a solvent that is the same as that used in the liquid developer or further with an added charging control agent is preferable. As described using FIG. 8, an appropriate amount of pre-wet solvent is applied to the surface 5a of the glass plate 5 at an appropriate timing by the coating applicator 7.

Incidentally, in order to form a high-resolution and high-precision pattern image on the glass plate 5 by the pattern formation apparatus 10, it is important to reliably clean the original plate 1 after a pattern image is transferred, in addition to forming a pattern using the recess 14a with high precision on the high-resistance layer 13 and transferring a toner image in the recess 14a to the glass plate 5 using an electric field. Particularly, if the same recess 14a of the original plate 1 is repeatedly used to develop and transfer patterns in three colors, like the present embodiment, a problem of color mixing arises when a pattern image of the next color is formed if the toner particles 55 of a prior color remain in the recess 14a. Moreover, when the original plate 1 as adopted in the present embodiment is cleaned, developer particles are likely to remain near corners at the bottom of the recess 14a and the toner particles 55 cannot be sufficiently removed from the extremely fine pattern-like recess 14a simply by bringing a squeeze roller into contact with the recess 14a slidingly, as is done conventionally.

Thus, in the present embodiment, when the original plate 1 is cleaned, a cleaning liquid is first supplied to the recess 14a to liberate the toner particles 55 in the cleaning liquid remaining particularly at corners of the recess 14a, and then, the liberated toner particles 55 are removed together with the cleaning liquid. Cleaning methods of the original plate 1 will be described below by showing some examples. Drawings shown in the description below are all schematic representations and are intended to describe functions of actual devices, instead of structures thereof.

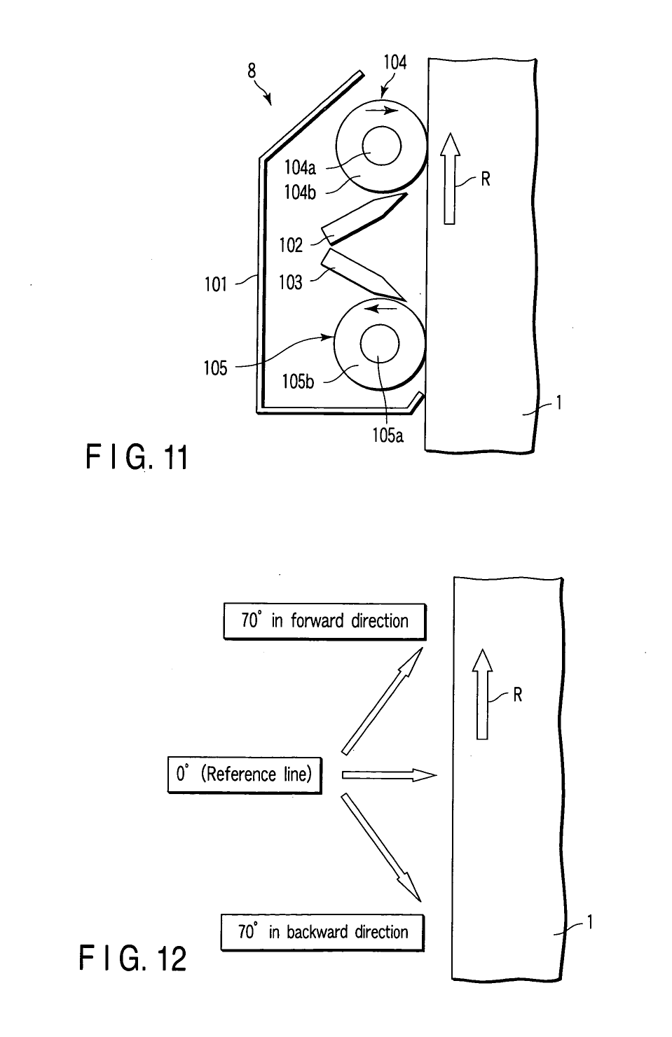

FIG. 11 schematically shows the structure of principal parts of the cleaner 8 according to the first embodiment of the present invention.

The cleaner 8 has a case 101 opened to the surface of the original plate 1. The case 101 functions as a vessel for collecting cleaning liquids including the toner particles 55 removed from the original plate 1. The case 101 has two systems of nozzles, 102 and 103, functioning as supply devices of the present invention, and two removal rollers, 104 and 105, functioning as removal devices of the present invention provided therein.

The nozzle 102 of one system arranged on the upper side in FIG. 11 is arranged by being inclined upward toward the rotation direction (an arrow R direction in FIG. 11) of the original plate 1 and positioned so that a tip thereof faces the surface of the original plate 1 via an opening of the case 101. The nozzle 103 of the other system is arranged by being inclined downward in FIG. 11 with respect to the rotation direction R of the original plate 1 and positioned so that the tip thereof faces the surface of the original plate 1 via the opening of the case 101. Incidentally, a plurality of the recesses 14a (not shown) is provided on the surface of the original plate 1. Each system of the nozzles 102 and 103 has a plurality of nozzles (not shown) in the axial direction of the original plate 1 across the rotation direction R of the original plate 1.

The one removal roller 104 is arranged above the nozzle 102 of one system in FIG. 11, that is, downstream from the nozzle 102 in the rotation direction R of the original plate 1 in the vicinity and positioned so that the removal roller 104 is in contact with the surface of the original plate 1 via the opening of the case 101. The other removal roller 105 is arranged below the nozzle 103 of the other system in FIG. 11, that is, positioned to sandwich the two systems of the nozzles 102 and 103 together with the one removal roller 104 and positioned so that the removal roller 105 is in contact with the surface of the original plate 1 via the opening of the case 101. Then, the removal roller 104 in the upper part in FIG. 11 rotates in the direction opposite (an arrow r1 direction in FIG. 11) to the rotation direction R of the original plate 1 and the removal roller 105 in the lower part in FIG. 11 rotates in the same direction (an arrow r2 direction in FIG. 11) as the rotation direction R of the original plate 1.

More specifically, each system of the nozzles 102 and 103 is constructed by setting up a plurality of two-fluid nozzles jetting a liquid and a gas simultaneously together in the axial direction of the original plate 1 so that each nozzle directs a jet of a cleaning liquid to the surface of the original plate 1 at constant pressure. In the present embodiment, an insulating liquid constituting the liquid developer was used as a cleaning liquid. By using a solvent constituting the liquid developer as a cleaning liquid in this manner, processes can be made to proceed without hindrance even when the cleaning liquid remains in the recess 14a of the original plate 1. In other words, it is necessary to select a liquid that does not affect processes as a cleaning liquid when the liquid remains on the original plate 1.

The cleaning liquid jetted from each nozzle is spread and blown from directions inclined toward the rotation direction and axial direction of the original plate 1. In the present embodiment, the inclination angle of each of the nozzles 102 and 103 with respect to the original plate 1, that is, a blowing angle of the cleaning liquid is made adjustable by an adjustment mechanism (not shown) so that the cleaning liquid can be blown from all angles with respect to the rotation direction and axial direction of the original plate 1. Accordingly, the cleaning liquid can be blown from all angles to the rectangular recess 14a and particularly the toner particles 55 adhering to corners of the recess 14a can reliably be removed.

The removal rollers 104 and 105 described above have the same structure and are constructed by providing sponge layers 104b and 105b (porous members) around hollow shafts 104a and 105a (rotation axes) respectively. To describe the one removal roller 104 representatively, many intake holes (not shown) are provided in regions of the shaft 104a opposite to the sponge layer 104b. The sponge layer 104b is constructed from a urethane material of thickness of 7 [mm] having continuous cells of an average cell diameter of 70 [μm] and provided to coat all intake holes of the shaft 104a. “Continuous cells” here refer to a structure in which many cells are connected like a three-dimensional mesh.

Then, when air is sucked in from many intake holes of the shaft 104a by a suction pump or a negative pressure device (not shown) connected to the shaft 104a a negative pressure arises on the surface of the sponge layer 104b so that the cleaning liquid including the toner particles 55 is sucked to the sponge layer 104b. Here, while the removal roller 104 produces an effect of wiping off the toner particles 55 remaining on the original plate 1 by rotating the removal roller 104 in the opposite direction to the rotation direction of the original plate 1, if the amount of the toner particles 55 adhering to the original plate 1 before cleaning is small and a large portion of the toner particles 55 is discharged together with a waste liquid by a liquid jetted from the nozzles, removal capabilities of liquids and the toner particles 55 can sufficiently be demonstrated even if the removal roller 104 rotates in a forward direction along with the original plate 1.

Operations of cleaning the original plate 1 by the cleaner 8 of the above structure will be described below with reference to FIGS. 12 to 16 together with FIG. 11.

First, a cleaning liquid is blown against the surface of the rotating original plate 1 via the nozzles 102 and 103. As shown in FIG. 12, the blowing angle of the cleaning liquid can be adjusted from an angle perpendicular to the surface of the original plate 1 (defined as a reference line of the angle 0°) to angles of ±70° in the rotation direction R of the original plate 1. In the present embodiment, the blowing angle of the nozzle 102 present downstream in the rotation direction R is set at 45° in the rotation direction and that of the nozzle 103 present upstream in the rotation direction R is set at 45° against the rotation direction.

The nozzles 102 and 103 are two-fluid nozzles which are connected to a cleaning liquid tank (not shown) via a liquid supply pump (not shown) with a pressure in the range of 0.1 [MPa] to 1.0 [MPa], and also connected to an air pump (not shown), with a pressure in the range of 0.1 [MPa] to 1.0 [MPa], so that a cleaning liquid can be supplied to the recess surface at a liquid pressure in the range of 0.1 [MPa] to 1.0 [MPa] and air pressure in the range of 0.1 [MPa] to 1.0 [MPa]. If the nozzle is a two-fluid nozzle, the liquid pressure of the cleaning liquid jetted from each of the nozzles 102 and 103 is preferably set at about 0.1 [MPa] to 1.0 [MPa], and also the air pressure of the cleaning liquid is preferably set at about 0.1 [MPa] to 1.0 [MPa]. In the present embodiment, the liquid pressure of the cleaning liquid is set at 0.5 [MPa] and the air pressure is also set at 0.5 [MPa].

If the blowing angle of the cleaning liquid to the original plate 1 exceeds 70°, a problem occurs that the surface of the intaglio drum is more likely to be contaminated because the angle of incidence of the blowing liquid on the finely shaped recess patterns becomes shallow, which makes it impossible to liberate particles remaining particularly at corners at normal liquid pressure, and makes it more likely for a liquid to flow outside of the portion in contact with the cleaning portion. If the liquid pressure of the cleaning liquid drops below 0.1 [MPa], it becomes impossible to liberate remaining particles because the liquid cannot be jetted to the recess at sufficient liquid pressure, and if the liquid pressure of the cleaning liquid exceeds 1.0 [MPa], a liquid flow spread insufficiently controlled due to a liquid pressure far stronger than air pressure is jetted toward the intaglio surface, causing scattering of the liquid to the surrounding thereof, which will contaminate other units. Further, if the air pressure of the cleaning liquid drops below 0.1 [MPa], the liquid flow is jetted toward the intaglio surface while the width and spread thereof are not sufficiently controlled and therefore, particles remaining inside recess patterns cannot be liberated from corners at sufficient pressure. If the air pressure of the cleaning liquid exceeds 1.0 [MPa], particles cannot be liberated from corners at sufficient pressure either because the liquid to be jetted is atomized.

In the present embodiment, air is used as a gas, but an inert nitrogen gas may be used to enhance an explosion-protection effect.

Further, in addition to the two-fluid nozzle to increase the liquid pressure by using the gas pressure as described above, a one-fluid nozzle that directly causes a high-pressure pump to jet a liquid by high liquid pressure may also be used. For the two-fluid nozzle, the liquid pressure of the cleaning liquid is preferably set in the range of 0.4 [MPa] to 2.5 [MPa]. In the present embodiment, the liquid pressure of the cleaning liquid is set at 1.2 [MPa]. It is quite natural that the nozzle angle of the one-fluid nozzle is preferably set also in the range of ±70° in the rotation angle R of the original plate 1 for the same reason as that for the two-fluid nozzle. If the liquid pressure of the cleaning liquid drops below 0.4 [MPa], it becomes impossible to liberate remaining particles adequately because the liquid cannot be jetted to the recess at sufficient liquid pressure, and if the liquid pressure of the cleaning liquid exceeds 2.5 [MPa], due to too strong liquid pressure, the liquid is scattered to the surroundings, and contaminates other units.

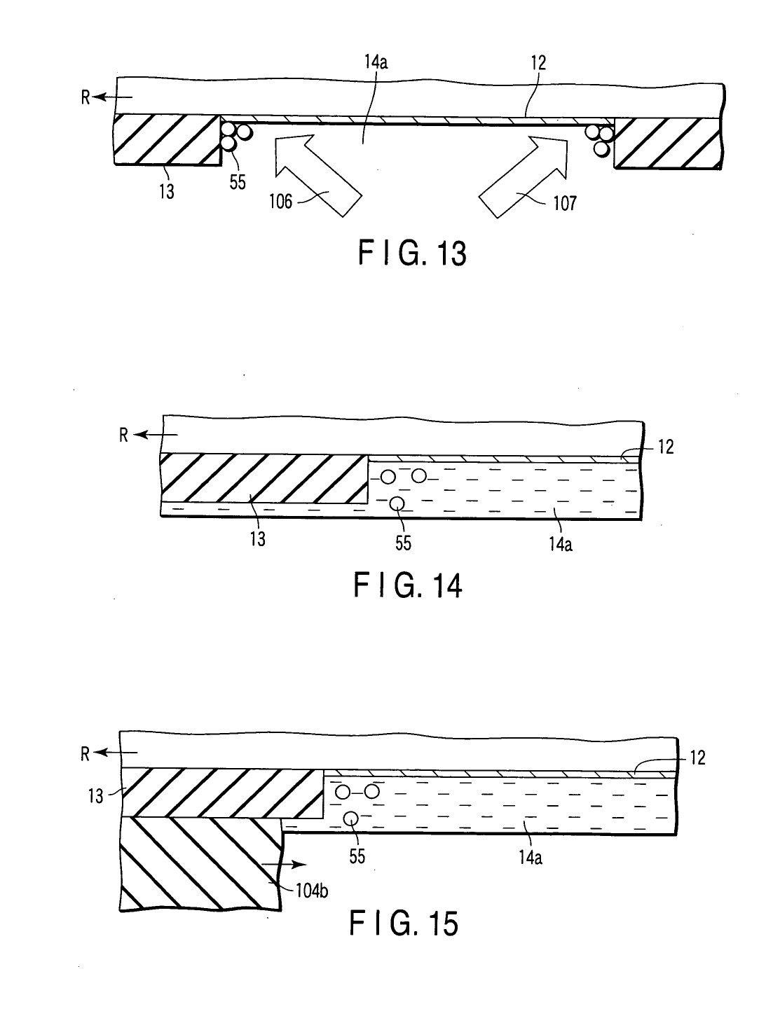

As shown schematically in FIG. 13, a cleaning liquid 106 jetted from the one nozzle 102 arranged downstream in the rotation direction R of the original plate 1 is blown mainly against the corner on the downstream side in the rotation direction R of each of the recesses 14a of the original plate 1 to liberate, as shown schematically in FIG. 14, the toner particles 55 adhering to this corner in the cleaning liquid. A cleaning liquid 107 jetted from the other nozzle 103 arranged upstream in the rotation direction R is, on the other hand, blown mainly against the corner on the upstream side in the rotation direction R of each of the recesses 14a of the original plate 1 to liberate the toner particles 55 adhering to this corner in the cleaning liquid.

Then, as shown in FIG. 15, the one removal roller 104 arranged downstream in the rotation direction R of the original plate 1 is brought into contact while being rotated in the direction opposite to that of the original plate 1 by the relative movement of the original plate 1 and the cleaner 8, and the sponge layer 104b is slidingly brought into contact with the surface of the original plate 1. At this point, the other removal roller 105 functions mainly to collect the cleaning liquid jetted from the other nozzle 103.

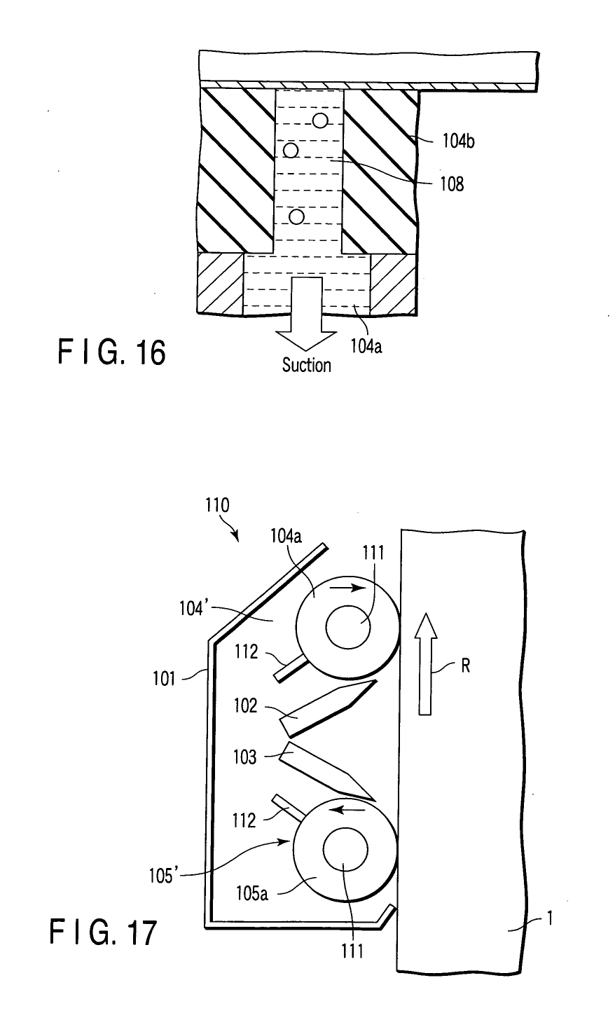

When the sponge layer 104b of the removal roller 104 comes into contact with the opening of the recess 14a of the original plate 1, as schematically shown in FIG. 16, a negative pressure acts on the surface of the sponge layer 104b via continuous cells 108 of the sponge layer 104b and the shaft 104a and the toner particles 55 remaining in the recess 14a are sucked together with the cleaning liquid. At this point, the toner particles 55 that had adhered to the corners of the recess 14a are in a free state in the cleaning liquid after being blown by the cleaning liquid and can easily be removed from the recess 14a simultaneously with suction/removal of the cleaning liquid.

In the present embodiment, while the average cell diameter of the continuous cells 108 in the sponge layer 104b of the removal roller 104 (105) is set to 70 [μm], which yielded the highest efficiency, it is preferable to set the average cell diameter of the continuous cells 108 in the range of about 20 [μm] to 400 [μm]. If the average cell diameter of the continuous cells 108 drops below 20 [μm], particles are more likely to be clogged in the cells and the life of the removal roller is shortened, causing a problem of more frequent replacement of members. If the average cell diameter exceeds 400 [μm], the number of particles captured in cells for removal decreases so that a high removal performance cannot be achieved.

According to the cleaner 8 in the first embodiment, as described above, the toner particles 55 remaining due to adhering to corners of the recess 14a can reliably be liberated in a cleaning liquid by blowing the cleaning liquid against the original plate 1 at an angle and the liberated toner particles 55 can reliably and easily be removed together with the cleaning liquid by the removal roller 104 that causes a negative pressure on the surface of the sponge layer 104b. Thus, the toner particles 55 of the previous color can be prevented from remaining on the original plate 1 before starting a development process of the next color, leading to the prevention of color mixing. More specifically, if the cleaner 8 in the present embodiment is used, the ratio of the toner particles 55 remaining on the original plate 1 after the toner particles were transferred to the glass plate 5 was 0.1 [%] or less. Accordingly, the original plate 1 that can transfer a high-definition fine pattern at high resolution can be provided.

FIG. 17 shows a schematic representation showing a cleaner 110 according to the second embodiment of the present invention. The cleaner 110 has the same configuration as the cleaner 8 in the first embodiment except that two removal rollers 104′ and 105′ have a shaft 111 that is solid and a metallic scraper 112 is brought into contact and arranged on the circumferential surface of the sponge layers 104a and 105a of the rollers. Thus, the same reference numerals are attached to components that function like those of the cleaner 8 and a description thereof is omitted.

That is, when the cleaner 110 is operated, a cleaning liquid jetted from the nozzles 102 and 103 liberates the toner particles 55 remaining in the recess 14a of the original plate 1 and the liberated toner particles 55 are removed together with the cleaning liquid by the removal rollers 104′ and 105′. At this point, the toner particles 55 adhering to the circumferential surface of the sponge layers 104a and 105a of the removal rollers 104′ and 105′ respectively are scraped off by the scraper 112 with the rotation of the removal roller.

Thus, the same effect as that of the cleaner 8 in the first embodiment described above can be achieved by the cleaner 110 in the present embodiment and in addition, the configuration of the apparatus can be simplified to reduce manufacturing costs of the apparatus.

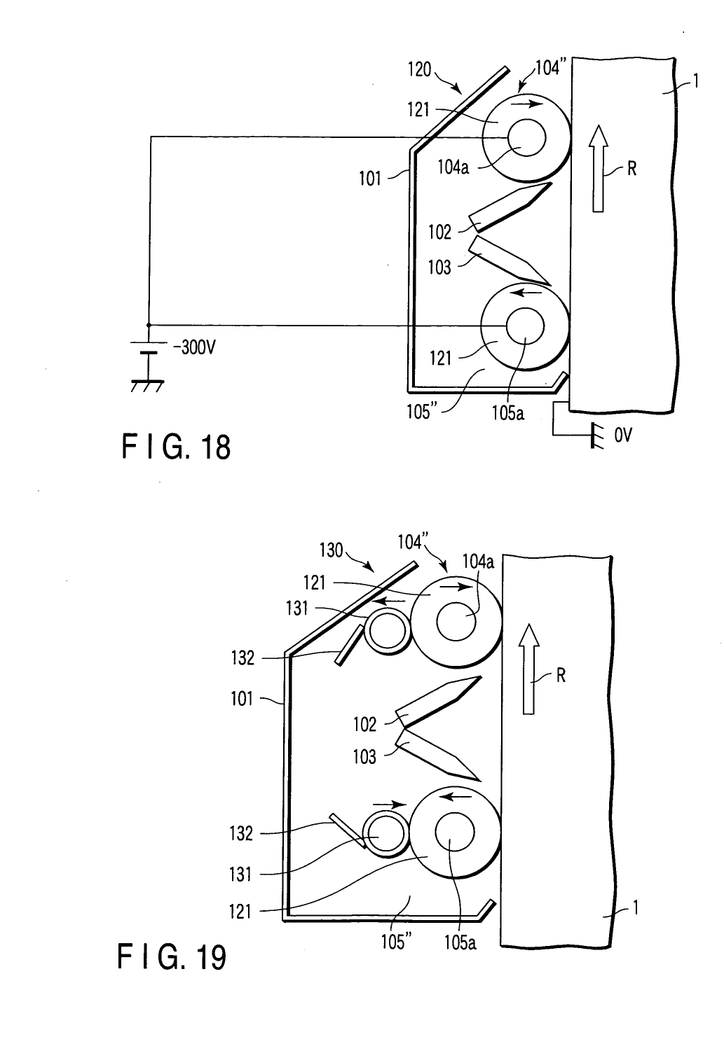

FIG. 18 shows a schematic representation showing a cleaner 120 according to the third embodiment of the present invention. The cleaner 120 has the same configuration as the cleaner 8 in the first embodiment except that a sponge layer 121 of two removal rollers 104″ and 105″ is conductive and a power unit 122 is connected to the sponge layer 121 to form an electric field between the sponge layer 121 and the metallic film 12 (not shown) of the original plate 1. Thus, also here, the same reference numerals are attached to components that function like those of the cleaner 8 and a description thereof is omitted.

The sponge layer 121 of a volume resistivity of 10³ [Ω·cm] to 10¹² [Ω·cm], preferably 10⁸ [Ω·cm] to 10¹¹ [Ω·cm], is formed from a conductive material whose JIS-C hardness is about 50, and is designed to have such hardness so that the sponge layer 121 does not contact the metallic film 12 exposed at the bottom of the recess 14a but does contact the original plate 1. If the volume resistivity drops below 10³ [Ω·cm], the surface of the sponge layer becomes more conductive and a sufficient electric field cannot be generated between the surface of the sponge layer and the intaglio surface so that a removal effect of electrically attracting charged particles to the sponge side cannot be achieved. If the volume resistivity exceeds 10¹² [Ω·cm], it becomes difficult to generate an effective electric field between the surface of the sponge layer and the intaglio surface by an appropriate applied voltage so that an effect of electrically removing charged particles cannot be achieved either.

When the cleaner 120 is operated, a cleaning liquid jetted from the nozzles 102 and 103 liberates the toner particles 55 remaining in the recess 14a of the original plate 1 and the liberated toner particles 55 are removed together with the cleaning liquid by the removal rollers 104″ and 105″. At this point, a pressure device (not shown) is operated to apply a negative pressure on the surface of the sponge layer 121 and also a voltage of, for example, −300 [V] is applied to the removal rollers 104″ and 105″ via the power unit 122 to form an electric field between the metallic film 12 of the original plate 1 at the earth potential and the sponge layer 121. Then, the toner particles 55 and the cleaning liquid are together sucked by the action of the negative pressure and the charged toner particles 55 are adsorbed onto the sponge layer 121 by the action of the electric field.

That is, the same effect as that of the cleaner 8 in the first embodiment described above can be achieved by the cleaner 120 in the present embodiment, and in addition, an adsorption effect of the toner particles 55 by the removal rollers 104″ and 105″ can be enhanced, further increasing the removal efficiency of the toner particles 55.

FIG. 19 shows a schematic representation showing a cleaner 130 according to the fourth embodiment of the present invention. The cleaner 130 has the same configuration as the cleaner 120 in the third embodiment except that cleaning rollers 131 are brought into rotational contact with the circumferential surface of the removal rollers 104″ and 105″ and further, blades 132 are brought into contact and arranged on the circumferential surface of each of the cleaning rollers 131. Thus, also here, the same reference numerals are attached to components that function like those of the cleaner 120 and a description thereof is omitted.

The cleaning roller 131 is constructed, for example, by forming an alumite layer of a thickness of 6 [μm] by anodic treatment on the circumferential surface of an aluminum hollow pipe, and rotates in the same direction as the corresponding removal rollers 104″ and 105″. The blade 132 is formed from urethane rubber of JIS-A hardness 80, 300% modulus 300 [kgf/cm²], and thickness of 1 [mm].

Then, when the cleaner 130 is operated, a cleaning liquid jetted from the nozzles 102 and 103 liberates the toner particles 55 remaining in the recess 14a of the original plate 1 and the liberated toner particles 55 are removed together with the cleaning liquid by the removal rollers 104″ and 105″. At this point, a pressure device (not shown) is operated to apply a negative pressure on the surface of the sponge layer 121 and also a voltage of, for example, −300 [V] is applied to the sponge layer 121 of the removal rollers 104″ and 105″ to form an electric field between the metallic film 12 of the original plate 1 at the earth potential and the sponge layer 121. Then, the toner particles 55 and the cleaning liquid are together sucked by the action of the negative pressure and the charged toner particles 55 are adsorbed onto the sponge layer 121 by the action of the electric field.

Then, of the toner particles 55 sucked by the removal rollers 104″ and 105″, the toner particles 55 remaining on the circumferential surface of the removal rollers 104″ and 105″ without being collected together with the cleaning liquid via the shafts 104a and 105a are moved to the cleaning roller 131 before being scraped off by the blade 132. At this point, against the voltage (−300 [V]) provided to the removal rollers 104″ and 105″ as described above, a voltage of, for example, −500 [V] is applied to the cleaning roller 131 to form an electric field between the removal rollers 104″ and 105″ and the cleaning roller 131, whereby the toner particles 55 remaining on the circumferential surface of the removal rollers 104″ and 105″ are attracted to the cleaning roller 131.

That is, the same effect as that of the cleaner 120 in the third embodiment described above can be achieved by the cleaner 130 in the present embodiment and in addition, the circumferential surface of the removal rollers 104″ and 105″ can always be kept clean, and also, the circumferential surface of the cleaning roller 131 can always be kept clean so that an adsorption effect of the toner particles 55 by the removal rollers 104″ and 105″ can still be enhanced, further increasing the removal efficiency of the toner particles 55.

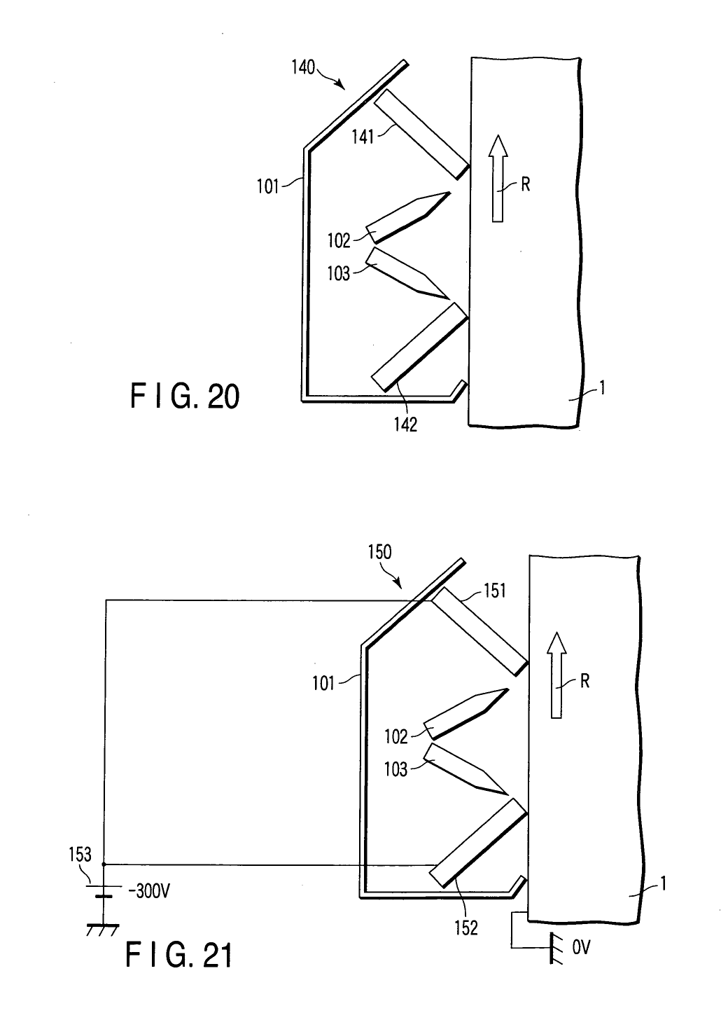

FIG. 20 shows a schematic representation showing a cleaner 140 according to the fifth embodiment of the present invention. The cleaner 140 has the same configuration as the cleaner 8 in the first embodiment except that the cleaner 140 has two resin blades 141 and 142 instead of the two removal rollers 104 and 105. Thus, also here, the same reference numerals are attached to components that function like those of the cleaner 8 and a description thereof is omitted.

The blades 141 and 142 are formed from urethane rubber of JIS-A hardness 75, 300% modulus 250 [kgf/cm²], and thickness of 1 [mm]. In the present embodiment, the liquid pressure of a cleaning liquid jetted via each of the two-fluid nozzles 102 and 103 was set at 1.0 [MPa] and the air pressure was also set at 1.0 [MPa]. That is, the jetting pressure of the cleaning liquid was set higher than that of the cleaner 8 in the first embodiment described above. Moreover, the blowing angle of the cleaning liquid was set to angles of ±70° in the direction perpendicular to the original plate 1.

Then, when the cleaner 140 is operated, a cleaning liquid jetted from the nozzles 102 and 103 first liberates the toner particles 55 remaining in the recess 14a of the original plate 1. The liberated toner particles 55 are scraped off by the blades 141 and 142 together with the cleaning liquid. In the present embodiment, as the pressure of the cleaning liquid is set higher and the blowing angle of the cleaning liquid is adjusted to an appropriate angle, the toner particles 55 adhering to the recess 14a can reliably be liberated so that the toner particles 55 can sufficiently be removed simply by scraping off by the blades 141 and 142.

That is, the same effect as that of the cleaner 8 in the first embodiment described above can be achieved by the cleaner 140 in the present embodiment, and in addition, replacement of the removal rollers 104 and 105 by the blades 141 and 142 eliminates the need for an expensive component such as a pressure device, so that apparatus components can be manufactured more cheaply.

FIG. 21 shows a schematic representation showing a cleaner 150 according to the sixth embodiment of the present invention. The cleaner 150 has the same configuration as the cleaner 140 in the fifth embodiment except that the cleaner 150 uses conductive blades 151 and 152 formed from a conductive material instead of the resin blades 141 and 142, and a power unit 153 is connected to the conductive blades 151 and 152 to form an electric field between these conductive blades 151 and 152 and the metallic film 12 (not shown here) of the original plate 1. Thus, also here, the same reference numerals are attached to components that function like those of the cleaner 140 and a description thereof is omitted.

When the cleaner 150 is operated, a cleaning liquid jetted from the nozzles 102 and 103 first liberates the toner particles 55 remaining in the recess 14a of the original plate 1. Then, the liberated toner particles 55 are scraped off by the blades 151 and 152 together with the cleaning liquid. At this point, a voltage of, for example, −300 [V] is applied to each of the conductive blades 151 and 152 via the power unit 153 to form an electric field between the conductive blades 151 and 152 and the metallic film 12 (not shown here) of the original plate 1 at the earth potential. Accordingly, it becomes possible to scrape off the toner particles 55 liberated from the original plate 1 by the conductive blades 151 and 152 and also to cause the conductive blades 151 and 152 to adsorb the toner particles 55 remaining in the recess 14a.

Thus, when the cleaner 150 in the present embodiment is used, the same effect as that of the cleaner 140 in the fifth embodiment described above can be achieved, and in addition, an adsorption effect of the toner particles 55 by the conductive blades 151 and 152 can be further enhanced, further increasing the removal efficiency of the toner particles 55.

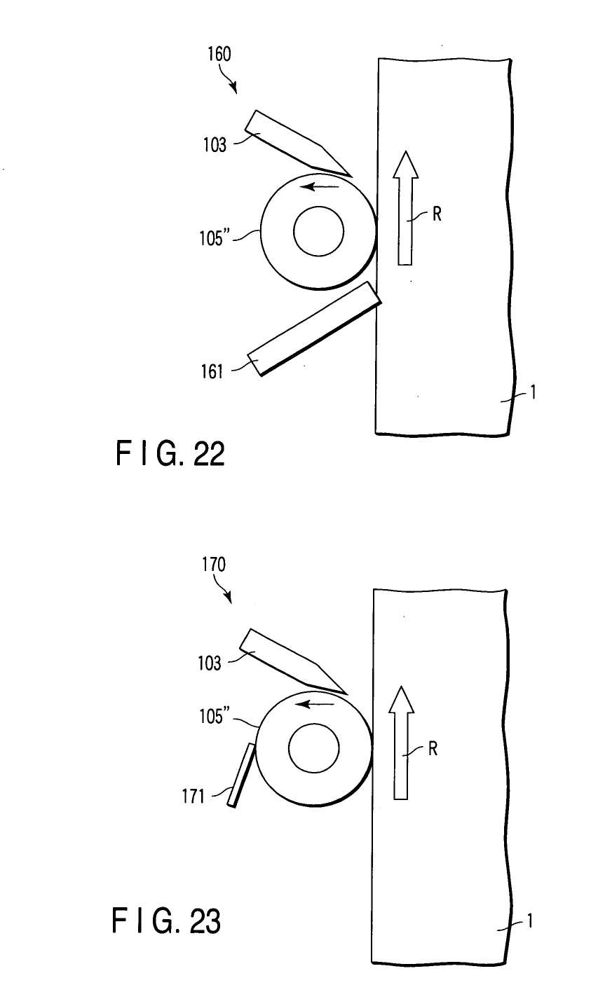

FIG. 22 shows the configuration of principal parts of a cleaner 160 according to the seventh embodiment of the present invention as a schematic representation. Here, the apparatus is illustrated after further simplification and the configuration on the downstream side in the rotation direction R of the original plate 1 is omitted. The cleaner 160 is different from the cleaner 120 in the third embodiment in that the cleaner 160 has a blade 161 formed from a resin material having conductivity. Thus, here the same reference numerals are attached to components that function like those of the cleaner 120 and a description thereof is omitted.

When the cleaner 160 is operated, a cleaning liquid jetted from the nozzle 103 (102) first liberates the toner particles 55 remaining in the recess 14a of the original plate 1. Then, the liberated toner particles 55 are scraped off by the blade 161 together with the cleaning liquid and removed by the removal roller 105″ (104″). Like the cleaner 150 in the sixth embodiment, a voltage of, for example, −300 [V] is applied to the blade 161. Moreover, the same voltage is applied to the removal roller 105″ (104″).

Thus, an electric field is formed between the original plate 1 and the removal roller 105″ (104″) and also an electric field is formed between the original plate 1 and the blade 161 and the toner particles 55 liberated from the original plate 1 by a jet of the cleaning liquid are attracted to the removal roller and the blade by the electric fields. Thus, also in the present invention, effects similar to those of the apparatus in each embodiment described above can be achieved and the removal efficiency of the toner particles 55 can be increased.

FIG. 23 shows the configuration of principal parts of a cleaner 170 according to the eighth embodiment of the present invention as a schematic representation. Here, the apparatus is illustrated after further simplification and the configuration on the downstream side in the rotation direction R of the original plate 1 is omitted. The cleaner 170 is different from the cleaner 120 in the third embodiment in that a conductive scraper 171 is brought into contact and arranged on the circumferential surface of each of the removal rollers 105″ (104″). Thus, here the same reference numerals are attached to components that function like those of the cleaner 120 and a description thereof is omitted.

The conductive scraper 171 is constructed, for example, by coating the surface of an aluminum plate of thickness of about 1 [mm] with fluororesin of thickness of about 2 [mm]. In the present embodiment, a metallic film (not shown) of the original plate 1 is set at the earth potential, a voltage of, for example, −300 [V] is applied to the removal roller 105″ (104″), and a voltage of, for example, −500 [V] is applied to the conductive scraper 171.

When the cleaner 160 is operated, a cleaning liquid jetted from the nozzle 103 (102) first liberates the toner particles 55 remaining in the recess 14a of the original plate 1. Then, the liberated toner particles 55 are removed by the removal roller 105″ (104″) together with the cleaning liquid. At this point, due to a potential difference between the original plate 1 and the removal roller 105″ (104″), the toner particles 55 liberated from the original plate 1 are electrically attracted toward the removal roller 105″ (104″).

Further, the toner particles 55 remaining on the circumferential surface without being sucked after being moved to the removal roller 105″ (104″) are scraped off by the conductive scraper 171. At this point, the toner particles 55 on the circumferential surface of the removal roller 105″ (104″) are attracted toward the conductive scraper 171 by an electric field formed between the removal roller 105″ (104″) and the conductive scraper 171.

According to the present embodiment, as described above, the conductive scraper 171 is arranged by bringing the conductive scraper 171 into contact with the circumferential surface of the removal roller 105″ (104″) in addition to the configuration of the cleaner 120 in the third embodiment described above and therefore, the circumferential surface of the removal roller 105″ (104″) can always be kept clean by the action of the electric field, increasing the removal efficiency of the toner particles 55.

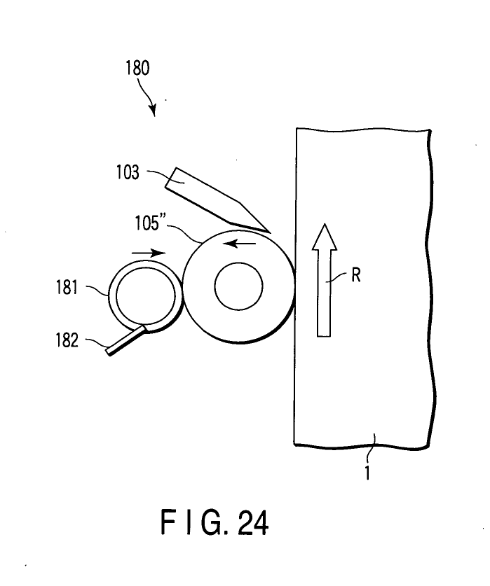

FIG. 24 schematically shows the configuration of principal parts of a cleaner 180 according to the ninth embodiment of the present invention. The cleaner 180 is different from the cleaner 170 in the eighth embodiment in that the cleaner 180 has a cleaning roller 181, which is the same as that used for the apparatus 130 in the fourth embodiment described above, in place of the conductive scraper 171, and further has a scraper 182 arranged by bringing the scraper 182 into contact with the circumferential surface of the cleaning roller 181.

Also in the present embodiment, the original plate 1 is grounded, a voltage of, for example, −300 [V] is applied to the removal roller 105″ (104″), and a voltage of, for example, −500 [V] is applied to the cleaning roller 181. Then, the toner particles 55 removed from the original plate 1 by the removal roller 105″ (104″) are electrically attracted to the cleaning roller 181 before being scraped off by the scraper 182. Also, the cleaner 180 in the present embodiment can naturally achieve effects similar to those of the cleaner in each embodiment described above.

The cleaner 130 according to the ninth embodiment of the present invention will be described using FIG. 19. The cleaner 130 according to the ninth embodiment has almost the same configuration as that of the cleaner 130 according to the fourth embodiment described above, but while the fourth embodiment uses a two-fluid nozzle of a cleaning liquid and air, the ninth embodiment uses a one-fluid nozzle of a cleaning liquid. The nozzles 102 and 103 are connected to a high-pressure pump (not shown) with a pressure in the range of 0.4 [MPa] to 2.5 [MPa] and configured to be able to supply a cleaning liquid at a liquid pressure in the range of 0.4 [MPa] to 2.5 [MPa] from a cleaning liquid tank to the intaglio surface. In the present embodiment, the liquid pressure of the cleaning liquid is set at 1.2 [MPa] and a plurality of one-fluid nozzles are arranged so that a liquid can be jetted at nozzle angles of 80° and −80°. The jetted cleaning liquid liberates the toner particles 55 remaining in the recess 14a of the original plate 1 and the liberated toner particles 55 are removed by the removal roller 105″ (104″) together with the cleaning liquid. At this point, a pressure device (not shown) is operated to apply a negative pressure on the surface of the sponge layer 121 and also a voltage of, for example, −300 [V] is applied to the sponge layer 121 of the removal rollers 104″ and 105″ to form an electric field between the metallic film 12 of the original plate 1 at the earth potential and the sponge layer 121. Then, the toner particles 55 and the cleaning liquid are together sucked by the action of the negative pressure and the charged toner particles 55 are adsorbed onto the sponge layer 121 by the action of the electric field.

Then, of the toner particles 55 sucked by the removal rollers 104″ and 105″, the toner particles 55 remaining on the circumferential surface of the removal rollers 104″ and 105″ without being collected, together with the cleaning liquid via the shafts 104a and 105a are moved to the cleaning roller 131 before being scraped off by the blade 132. At this point, against the voltage (−300 [V]) provided to the removal rollers 104″ and 105″ as described above, a voltage of, for example, −500 [V] is applied to the cleaning roller 131 to form an electric field between the removal rollers 104″ and 105″ and the cleaning roller 131, whereby the toner particles 55 remaining on the circumferential surface of the removal rollers 104″ and 105″ are attracted to the cleaning roller 131.

In the first to ninth embodiments described above, a case in which toner images of all colors are developed and transferred using the recess 14a in which a pattern for one color is formed is described, but the present invention is not limited to this and toner images in three colors may be formed in the original plate 1 after forming the recesses 14a for three colors in the original plate 1 to transfer the toner images to the glass plate 5 together. In this case, there is no possibility of color mixing because toner of a different color is not developed in the same recess 14a and thus, there is no need for performing a cleaning process for each color or performing a cleaning operation after each transfer process.

Also in the above embodiments, an apparatus having an adjustment mechanism capable of adjusting the angle of two-fluid nozzles that jet a cleaning liquid toward the original plate 1 is described, but a nozzle oscillating function may be provided by electrically controlling the two-fluid nozzles 102 and 102 for oscillating the nozzles.

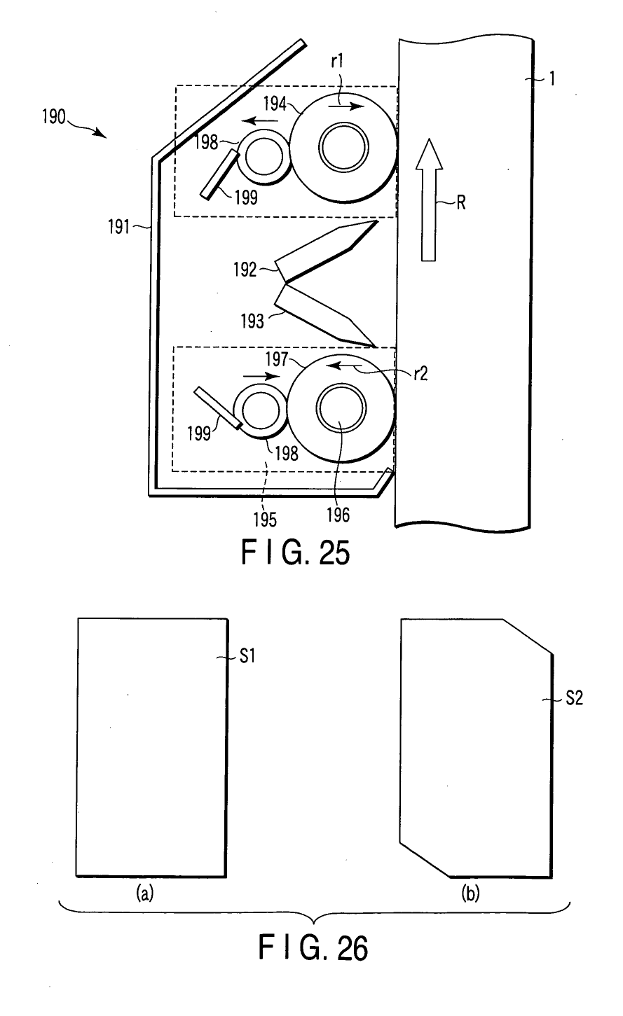

FIG. 25 schematically shows the configuration of principal parts of a cleaner 190 according to the tenth embodiment of the present invention.

The cleaner 190 has a case 191 having an opening toward the surface of the original plate 1. The case 191 functions also as a vessel to collect a cleaning liquid including developer particles removed from the original plate 1. The case 191 has two systems of nozzles, 192 and 193, and two removal rollers, 194 and 195.

The nozzle 192 of one system arranged on the upper side in FIG. 25 is arranged by being inclined upward toward the rotation direction (an arrow R direction in FIG. 25) of the original plate 1 and positioned so that a tip thereof faces the surface of the original plate 1 via an opening of the case 191. The nozzle 193 of the other system is arranged by being inclined downward in FIG. 25 with respect to the rotation direction R of the original plate 1 and positioned so that the tip thereof faces the surface of the original plate 1 via the opening of the case 191. Each system of the nozzles 192 and 193 has a plurality of nozzles (not shown) in the axial direction of the original plate 1 across the rotation direction R of the original plate 1.

The one removal roller 194 is arranged above the nozzle 192 of one system in FIG. 11, that is, downstream from the nozzle 192 in the rotation direction R of the original plate 1 in the vicinity and positioned so that the removal roller 194 is in contact with the surface of the original plate 1 via the opening of the case 191. The other removal roller 195 is arranged below the nozzle 193 of the other system in FIG. 25, that is, positioned to sandwich the two systems of the nozzles 192 and 193 together with the one removal roller 194 and positioned so that the removal roller 195 is in contact with the surface of the original plate 1 via the opening of the case 191. Then, the removal roller 194 in the upper part in FIG. 25 rotates in the direction opposite (an arrow r1 direction in FIG. 25) to the rotation direction R of the original plate 1 and the removal roller 195 in the lower part in FIG. 25 rotates in the same direction (an arrow r2 direction in FIG. 25) as the rotation direction R of the original plate 1.

More specifically, each system of the nozzles 192 and 193 is constructed by setting up a plurality of two-fluid nozzles jetting a liquid and a gas simultaneously together in the axial direction of the original plate 1 so that each nozzle directs a jet of cleaning liquid to the surface of the original plate 1 at constant pressure. In the present embodiment, an insulating liquid constituting the liquid developer was used as a cleaning liquid. By using a solvent constituting the liquid developer as a cleaning liquid in this manner, processes can be made to proceed without hindrance even when the cleaning liquid remains in the recess 14a of the original plate 1. In other words, it is necessary to select a liquid that does not affect processes as a cleaning liquid when the liquid remains on the original plate 1.

The cleaning liquid jetted from each nozzle is spread and blown from directions inclined toward the rotation direction and axial direction of the original plate 1. Accordingly, the cleaning liquid can be blown from angles inclined to the rectangular recess 14a and particularly the toner particles 55 adhering to corners of the recess 14a can reliably be removed.

The removal rollers 194 and 195 described above have the same structure and are each constructed by providing a sponge layer 197 around a hollow shaft 196. To describe the one removal roller 194 representatively, many intake holes (not shown) are provided in regions of the shaft 196 opposite to the sponge layer 197. Then, when air is sucked in from many intake holes of the shaft 196 by a suction pump (not shown) connected to the shaft 196, a negative pressure arises on the surface of the sponge layer 197 so that the cleaning liquid including the toner particles 55 is sucked to the sponge layer 197.

The toner particles 55 adhering to the surface of the sponge layer 197 are removed by a cleaning roller 198 rotating in an arrow direction in FIG. 25. Then, the toner particles 55 adhering to the surface of the cleaning roller 198 are scraped off by a blade 199. That is, the two removal rollers 194 and 195 described above are always kept clean by the cleaning roller 198 and the blade 199 to enhance the cleaning performance of the original plate 1.

Next, the cleaning apparatus 100 according to the first embodiment of the present invention will be described in detail.

The cleaning apparatus 100 is used when it is necessary to remove more developer particles than usual from the original plate 1, for example, when a relatively large amount of developer particles adhere to the recess 14a of the original plate 1 after a failure of development of pattern images in each color or a relatively large amount of developer particles adhere to the recess 14a after a failure of transfer of pattern images in each color. In other words, the cleaning apparatus 100 is used when developer particles adhering to the original plate 1 cannot be sufficiently removed by the cleaners 8, 110, 120, 130, 140, 150, 160, 170, 180, and 190 described above. If, for example, a development process fails, on the assumption that the amount of developer particles adhering to the original plate 1 exceeds a reference value, the original plate 1 is cleaned by the cleaning apparatus 100 being operated before migration to the transfer process. That is, the cleaning apparatus 100 is used to do the cleaning of the original plate 1 by separate treatment separately from a normal cleaning operation performed by the cleaner 8 (hereinafter, representing the cleaners for a description below).

Whether to do the cleaning of the original plate 1 by the cleaning apparatus 100 is determined by one of the following two methods: a mode to do the cleaning of the original plate 1 by the cleaning apparatus 100 is selected when the amount of developer particles adhering undesirably to the original plate 1 exceeds a certain reference value and a mode to do the cleaning of the original plate 1 by the cleaner 8 as usual is selected when the amount of developer particles falls below the certain reference value.

For example, if developer particles for developing the pattern-like recess 14a of the original plate 1 are phosphor particles and the cleaning mode is selected, whether the amount of phosphor particles exceeds the reference value can be determined by irradiating phosphor particles adhering to the inside of the specific recess 14a, which is to be sampled, with ultraviolet rays to detect an excitation light thereof and comparing the amount of excitation light with a pre-detected reference amount of light under normal conditions.

Or, whether the amount of developer particles adhering to the recess 14a exceeds the reference value can be determined by detecting an image of the recess 14a, which is to be sampled, and comparing the image with a pre-detected reference image. In this case, as shown, for example, in FIG. 26, the degree of adhesion of developer particles can be determined by calculating an area of the opening from an image of the recess 14a in a state where no developer particle adheres as a reference value S1 in advance, calculating an occupation area S2 of developer particles adhering to the recess 14a from the detected image when the mode is selected, and comparing the occupation area S2 with the reference value S1. More specifically, if S1 and S2 described above satisfy the following formula, the cleaning mode of the cleaner 8 is selected without using the cleaning apparatus 100 and, if S1 and S2 do not satisfy the following formula, the cleaning mode of the cleaning apparatus 100 is selected.

0.6<S2/S1<1.4

More specifically, if the cleaning mode to operate the cleaning apparatus 100 is selected, a control part (not shown) of the pattern formation apparatus 10 operates a movement mechanism (not shown) to move the original plate 1 to a cleaning position above the cleaning apparatus 100. At this point, process units such as the cleaner 8, the drier 4, the static eliminator 9, and the charger 2 that stand in the way of movement of the original plate 1 are withdrawn from the movement path of the original plate 1 to a withdrawal position. Or, these process units are integrally moved together as the original plate 1 is moved. Here, an illustration of the movement mechanism for moving the original plate 1 to the cleaning position and a withdrawal mechanism for withdrawing each process unit and a description thereof are omitted.

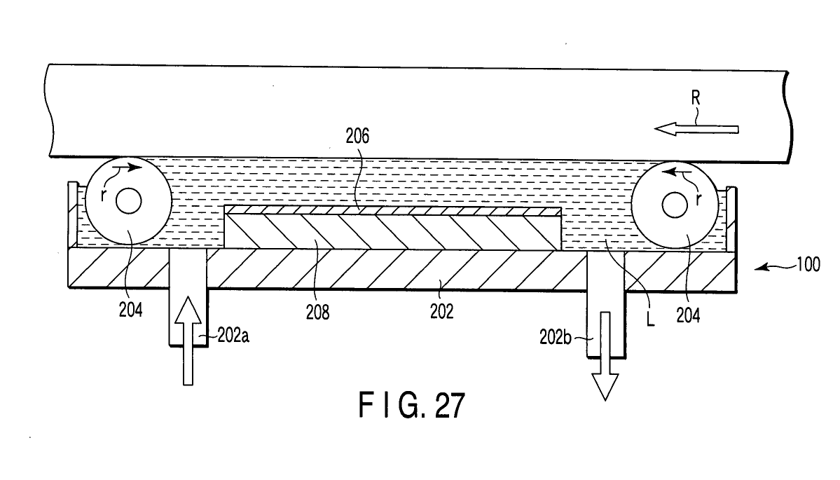

As shown in FIG. 27, the cleaning apparatus 100 has a cistern 202 opened toward the original plate 1 arranged at the illustrated cleaning position. In the present embodiment, the cleaning apparatus 100 is positioned vertically below the original plate 1 arranged at the cleaning position facing each other and therefore, the cistern 202 is opened vertically upward (toward the original plate 1). The cistern 202 has a length at least exceeding the total length of the original plate 1 in the axial direction (direction perpendicular to the paper surface of FIG. 11) and edges of the opening are curved to match the curvature of the original plate 1. Then, the original plate 1 is arranged at the cleaning position opposite to the cleaning apparatus 100 while edges of the opening are separated from the circumferential surface of the original plate 1 located at the cleaning position by a certain gap.

The cistern 202 has an inflow port 202a for causing a cleaning liquid L described later to flow into the cistern 202 and an outflow port 202b for causing the cleaning liquid L to flow out of the cistern 202 formed at the bottom of the cistern 202. The inflow port 202a and the outflow port 202b are formed as a long slender slit extending in the axial direction of the original plate 1 so that the cleaning liquid L circulating inside the cistern 202 flows in a constant direction (direction opposite to the rotation direction of the original plate 1) along the circumferential surface of the original plate 1. The inflow port 202a and the outflow port 202b may also be constructed by arranging a plurality of pipes or flexible tubes whose diameter is about 5 mm to 10 mm in the axial direction at constant intervals to be connected so that a liquid supplied at a constant flow rate from a group of pipes arranged on the inflow side is successively discharged from a group of pipes arranged on the outflow side to form a constant liquid flow inside the cistern 202 (not shown).

That is, a tank housing the cleaning liquid L is connected to the inflow port 202a via a pipe and valve (not shown) so that the cleaning liquid L in the tank can be supplied to the cistern 202 at a controllable flow rate by operating a pump (not shown). Also, a waste liquid tank is connected to the outflow port 202b via a pipe (not shown) so that the cleaning liquid L discharged from the cistern 202 is stored in the waste liquid tank. The used cleaning liquid L collected in the waste liquid tank may be reused after developer particles are removed.

A plurality of liquid leakage prevention rollers 204 are arranged near edge parts inside the cistern 202. The two liquid leakage prevention rollers 204 are representatively shown in FIG. 27, but similar liquid leakage prevention rollers may be provided in each of the cisterns 202 at both ends in the axial direction of the original plate 1. Each of the liquid leakage prevention rollers 204 is positioned and arranged at a position opposite to the circumferential surface of the original plate 1 rotating at the cleaning position via a constant tiny gap. In the present embodiment, each of the liquid leakage prevention rollers 204 is a metallic roller whose roller diameter is 20 [mm] and is positioned opposite to the circumferential surface of the original plate 1 via a gap of about 50 [μm]±10 [μm].

Then, by rotating the liquid leakage prevention roller 204 in a graphic arrow r direction, a cleaning liquid that could leak out of a gap between edges of the cistern 202 and the circumferential surface of the original plate 1 is made to flow toward the inside of the cistern 202 to prevent liquid leakage from the cistern 202 by a squeeze effect. In other words, the rotation direction r of each of the liquid leakage prevention rollers 204 is set as a direction in which a cleaning liquid present in a tiny gap between the original plate 1 and the liquid leakage prevention roller 204 is sent toward the inside of the cistern 202.

An electrode 206 for forming an electric field between the original plate 1 and the electrode 206 is fixingly mounted at the bottom in the center of the cistern 202. The electrode 206 is curved to form a recess toward the original plate 1 with substantially the same curvature as that of the circumferential surface of the original plate 1 and fixed to the bottom of the cistern 202 via a gap adjusting member 208. In the present embodiment, the electrode 206 is formed by applying a gold coating of thickness of 5 [μm] to the surface of a nickel plate having a thickness of 0.5 [mm] and a gap between the circumferential surface of the original plate 1 and the electrode 206 is set to about 100 [μm]±20 [μm] by adjusting the thickness of the gap adjusting member 208. Incidentally, Isopar or the like is used as the cleaning liquid L circulating inside the cistern 202 in which the electrode 206 is arranged as described above.

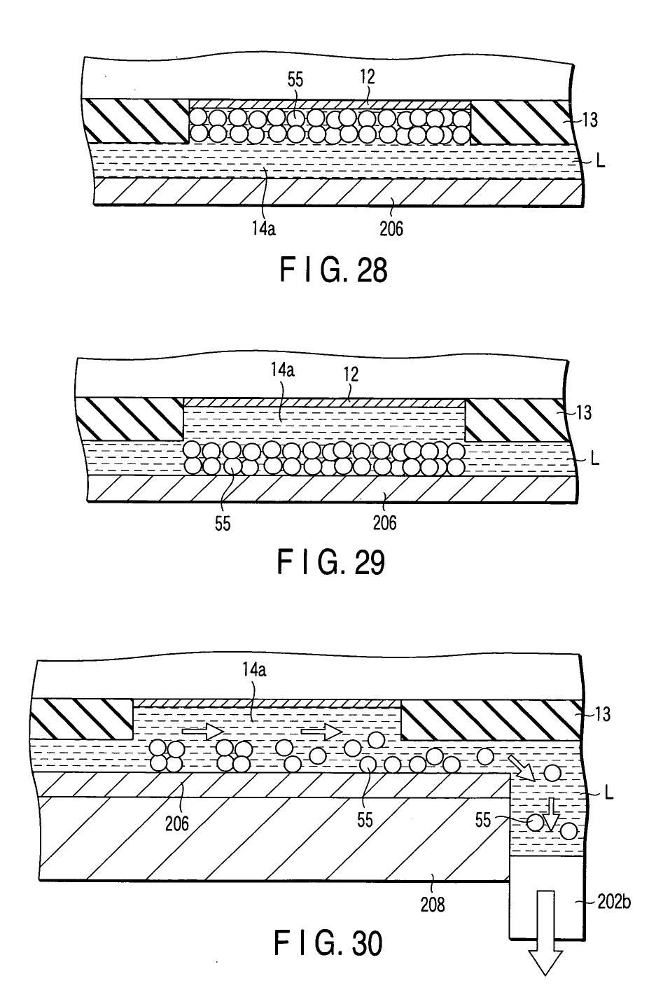

Cleaning operations performed by the cleaning apparatus 100 of the above structure will be described below with reference to FIGS. 28 to 30. Here, the configuration of principal parts of the cleaning apparatus 100 is shown as partially enlarged views and cleaning operations of developer particles will be described by focusing on one of the recesses 14a of the original plate 1.

After the original plate 1 approaches the cleaning apparatus 100 and moves to the above cleaning position opposite to the cleaning apparatus 100, the plurality of liquid leakage prevention rollers 204 of the cleaning apparatus 100 are rotated in the above direction and in this state, a pump (not shown) is operated to supply the cleaning liquid L to the cistern 202 via the inflow port 202a. At this point, the cistern 202 is filled with the cleaning liquid L by not allowing the cleaning liquid L to flow out via the outflow port 202b of the cistern 202 so that the space between the original plate 1 and the electrode 206 is filled with the cleaning liquid L. This state is shown in FIG. 28.

Then, in the state shown in FIG. 28, a voltage of −500 [V] is applied to the electrode 206 arranged inside the cistern 202 via a power unit to form an electric field between the metallic film 12 (conductive member) at the earth potential arranged at the bottom of the recess 14a and the electrode 206. Accordingly, as shown in FIG. 28, developer particles (the toner particles 55) held inside the recess 14a are adsorbed, as shown in FIG. 29, onto the electrode 206. At this point, developer particles migrate through the cleaning liquid L filling the space between the recess 14a and the electrode 206 to reach the electrode 206.

Then, as shown in FIG. 30, the cleaning liquid L present between the original plate 1 and the electrode 206 is caused to circulate while the electric field is made to disappear by turning off the voltage applied to the electrode 206 to flow developer particles adsorbed by the electrode 206. At this point, a pump (not shown) is operated to supply the cleaning liquid L into the cistern 202 at a predetermined flow rate via the inflow port 202a so that cleaning liquid L including developer particles removed from the recess 14a is caused to flow out via the outflow port 202b.

By using the cleaning apparatus 100 in the present embodiment, as described above, even if a relatively large amount of developer particles remain in the pattern-like recess 14a of the original plate 1, for example, after a failure of a development process or a failure of a transfer process, developer particles held on the original plate 1 can reliably be removed, and compared with the cleaner 8 that performs the normal cleaning operation, a larger amount of developer particles can satisfactorily be removed. For example, when the cleaning apparatus 100 in the present embodiment was operated in a state where the pattern-like recess 14a of the original plate 1 was filled with developer particles, the amount of developer particles remaining in the recess 14a when the cleaning operation terminated was 0.01 [%] or less.

In the embodiment described above, the relative movement between the original plate 1 and the cleaning apparatus 100 during the cleaning operation of the cleaning apparatus 100 is not described, and, as shown in FIG. 27, the original plate 1 may be rotated in the arrow R direction or may not be rotated. If the original plate 1 should be rotated, it is necessary to form the electric field described above at least once in all areas of the circumferential surface of the original plate 1 opposite to the cistern 202 of the cleaning apparatus 100 and then to cause the electric field to disappear. Or, in this case, the cleaning liquid L may be made to flow by forming a pulse-shaped electric field.

If the original plate 1 should not be rotated, after cleaning of an area of the circumferential surface of the original plate opposite to the cistern 202 of the cleaning apparatus 100 is completed, the cleaning is done several times by intermittently rotating the original plate 1 so that the cistern 202 faces areas adjacent to such area. In this case, it is preferable to set the distance of rotation of the original plate 1 so that two adjacent areas to be cleaned overlap only slightly.

Moreover, in the embodiment described above, a case in which both the cleaner 8 and the cleaning apparatus 100 are used as cleaning means of the original plate 1 is described, but the present invention is not limited to this and the cleaning apparatus 100 having a higher developer particle removal capability may be used.

Further, in the embodiment described above, the original plate 1 is moved to the cleaning position to be arranged above the cleaning apparatus 100 when the cleaning operation of the cleaning apparatus 100 is performed, but the arrangement position of the cleaning apparatus 100 is not limited to this, and if liquid leakage between edges of the cistern 202 and the circumferential surface of the original plate can reliably be prevented, it is possible to arrange the cleaning apparatus 100 on the circumferential surface of the original plate 1 arranged at the development position.

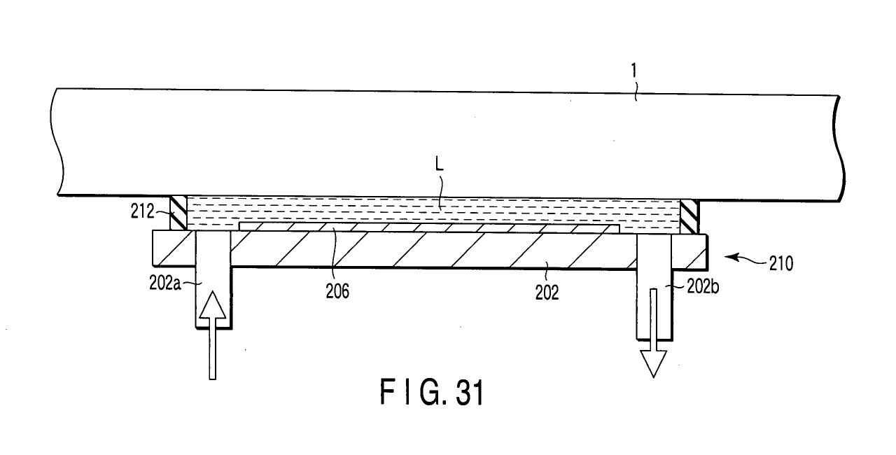

FIG. 31 shows a schematic diagram of a cleaning apparatus 210 according to the second embodiment of the present invention with an enhanced liquid leakage prevention function. The cleaning apparatus 210 need not necessarily have the cistern 202 arranged in a posture with the opening thereof directed upward as illustrated in FIG. 31 and may take any posture toward the original plate 1.

The cleaning apparatus 210 has substantially the same structure as the cleaning apparatus 100 in the first embodiment described above except that the cleaning apparatus 210 has rubber packing 212 for preventing liquid leakage in place of the liquid leakage prevention roller 204 described above. Therefore, the same reference numerals are attached to components that function like those of the cleaning apparatus 100 and a description thereof is omitted. Here, an illustration of the gap adjusting member 208 for adjusting the gap between the electrode 206 and the circumferential surface of the original plate to an appropriate value is omitted.

When the cleaning apparatus 210 is used, a spatial relationship in which an end of the rubber packing 212 is in contact with the circumferential surface of the original plate 1 is maintained in a state where the original plate 1 is moved to the cleaning position shown in FIG. 31. This spatial relationship is maintained when the arrangement state of the cleaning apparatus 210 with respect to the original plate 1 is changed.

Like the first embodiment described above, the cistern 202 is filled with the cleaning liquid L and an electric field is formed between the original plate 1 and the electrode 206 in this state so that developer particles adhering to the recess 14a of the original plate 1 are adsorbed onto the electrode 206. Then, after the electric field is made to disappear, the cleaning liquid L is caused to circulate in the cistern 202 to cause the cleaning liquid L including developer particles to flow out of the cleaning apparatus 210.

Also in the present embodiment, as described above, like the cleaning apparatus 100 in the first embodiment described above, a relatively large amount of developer particles remaining on the original plate 1 can satisfactorily be removed to be able to form a high-resolution and high-precision pattern. The cleaning apparatus 210 in the present embodiment functions particularly effectively when developer particles remaining in the recess 14a are dried and firmly fixed because the original plate 1 and the cleaning apparatus 210 are not moved relatively to each other.

Developer particles can be made easily removable by, for example, causing the cleaning liquid L filling the space between the original plate 1 and the cleaning apparatus 210 to circulate for a certain amount of time to wet developer particles inside the recess 14a satisfactorily before forming an electric field between the original plate 1 and the cleaning apparatus 210. As a result, developer particles can satisfactorily be removed even if they are dried.

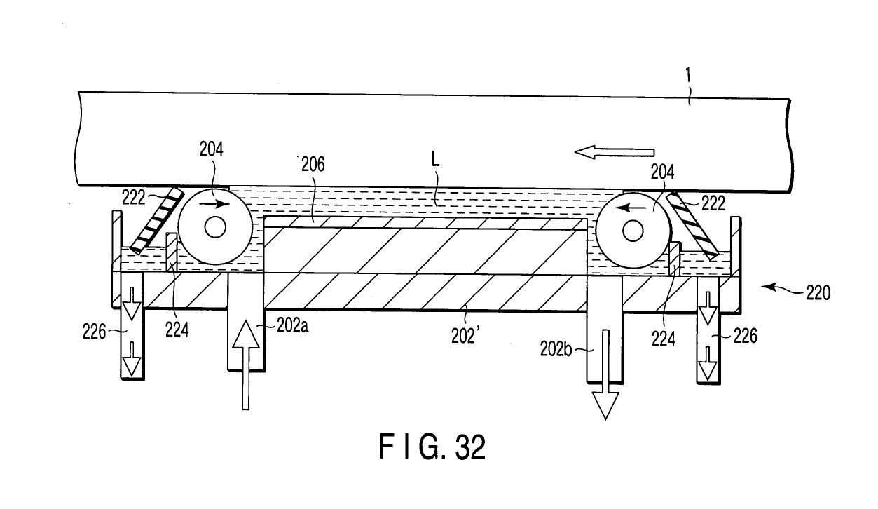

FIG. 32 shows a schematic diagram of a cleaning apparatus 220 according to the third embodiment of the present invention. The cleaning apparatus 220 has substantially the same structure as the cleaning apparatus 100 in the first embodiment described above except that the cleaning apparatus 210 has a blade 222 in contact with the circumferential surface of the original plate 1 outside each of the liquid leakage prevention rollers 204 and the cistern 202 has a double structure. Therefore, the same reference numerals are attached to components that function like those of the cleaning apparatus 100 and a description thereof is omitted. The blade 222 is formed from a resin whose JISA hardness is 30 to 90.

The cleaning liquid L caused to flow into a cistern 202′ via the inflow port 202a is generally caused to flow into an inside area partitioned by a frame-shaped partition wall 224 to fill a space between the circumferential surface of the original plate 1 and the electrode 206 by the squeeze effect by the plurality of liquid leakage prevention rollers 204 arranged further inside from the inside area. Then, like the first embodiment described above, an electric field is formed between the original plate 1 and the electrode 206 and the made to disappear to cause developer particles adsorbed by the electrode 206 to flow out of the cleaning apparatus 220 via the outflow port 202b by the flow of the cleaning liquid L.

At this point, there is a possibility that the cleaning liquid L filling the above inside area leaks out via a gap between the liquid leakage prevention roller 204 and the circumferential surface of the original plate 1, but the cleaning liquid L leaked out in this manner is scraped off by the blade 222. The cleaning liquid L scraped off from the circumferential surface of the original plate 1 by the blade 222 is collected to a circular area outside the cistern 202′ before being discharged via a waste liquid pipe 226.

Also in the present embodiment, as described above, the same effect as that of the cleaning apparatus 100 in the first embodiment described above is achieved and also, compared with the cleaning apparatus 100, the possibility of liquid leakage can be reduced.

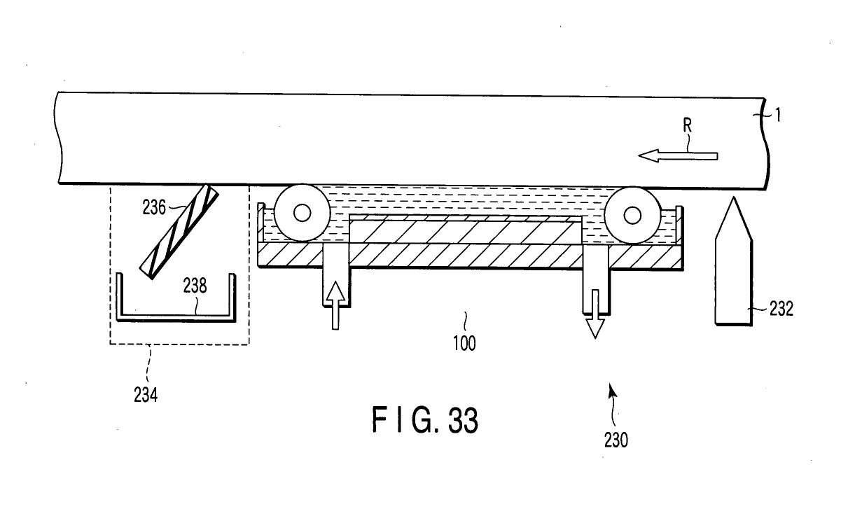

FIG. 33 shows a schematic diagram of a cleaning apparatus 230 according to the fourth embodiment of the present invention. The cleaning apparatus 230 has a structure in which a nozzle 232 as a pre-wet device is arranged on the upstream side of the cleaning apparatus 100 in the rotation direction R of the original plate 1 and a removal device 234 is arranged on the downstream side of the cleaning apparatus 100 in the rotation direction R.

The nozzle 232 supplies a cleaning liquid to the circumferential surface of the original plate 1 like wetting an area of the circumferential surface of the original plate 1 before being faced with the cleaning apparatus 100 in advance. A two-fluid nozzle of the cleaner 8 described above may be adopted as the nozzle 232. By wetting the area before being faced with the cleaning apparatus 100 with a cleaning liquid in advance in this manner, developer particles can be made easily removable so that cleaning can be done satisfactorily.

The removal device 234 functions to remove a cleaning liquid remaining on the circumferential surface of the original plate 1 after passing through the cleaning apparatus 100. The removal device 234 scrapes off any cleaning liquid remaining on the circumferential surface by bringing a blade 236 into contact with the circumferential surface of the original plate 1 to collect the scraped cleaning liquid in a vessel 238. The blade 236 is preferably formed from a resin whose JISA hardness is about 30 to 90 and in the present embodiment, is formed from a resin whose JISA hardness is 60.

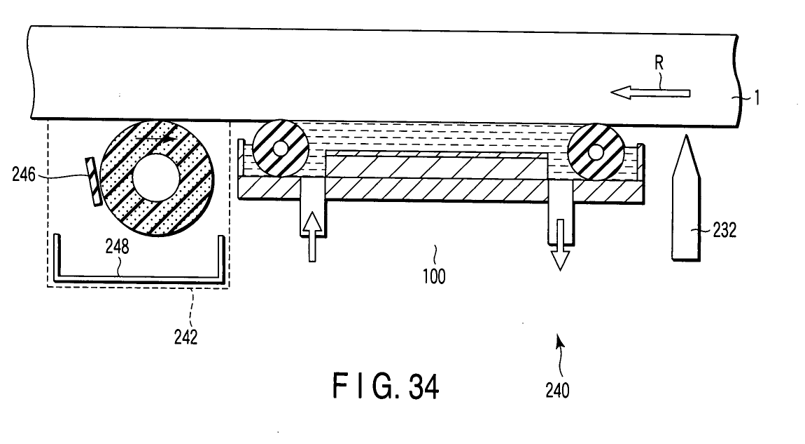

FIG. 34 shows a schematic diagram of a cleaning apparatus 240 according to the fifth embodiment of the present invention. The cleaning apparatus 240 is different from the cleaning apparatus 230 in the fourth embodiment in that the cleaning apparatus 240 has a removal device 242 in place of the removal device 234 on the downstream side of the cleaning apparatus 100 in the rotation direction R of the original plate 1.

Like the above removal device 234, the removal device 242 functions to remove any cleaning liquid remaining on the circumferential surface of the original plate 1 after passing through the cleaning apparatus 100. The removal device 242 has a sponge roller 244 for collecting the cleaning liquid adhering to the circumferential surface by being brought into contact with the circumferential surface of the original plate 1 and rotating in the direction opposite to the rotation direction R of the original plate 1, a scraper 246 for scraping off contaminants such as a cleaning liquid from the circumferential surface of the sponge roller 244, and a vessel 248 for collecting deposits scraped off by the scraper 246.

The sponge roller 244 has a sponge layer having cells whose average cell diameter is 20 [μm] to 400 [μm] and collects the cleaning liquid remaining on the circumferential surface of the original plate 1 through adhesion. In the present embodiment, the urethane sponge roller 244 whose average cell diameter is 200 [μm] was used. The scraper 246 is formed from a metallic plate.

The cleaning apparatus 240 also achieves the same effect as that of the cleaning apparatus 230 in the fourth embodiment described above and can reliably collect developer particles remaining in the recess 14a of the original plate 1. That is, the sponge roller 244 can follow the shape of the recess 14a by elastically being deformed by the shape of the recess 14a of the original plate 1 and also has an action of sucking a cleaning liquid by many cells.

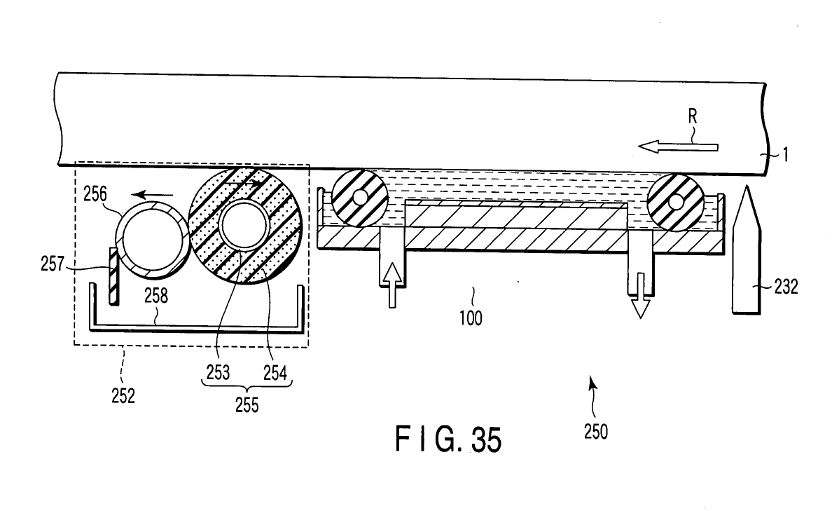

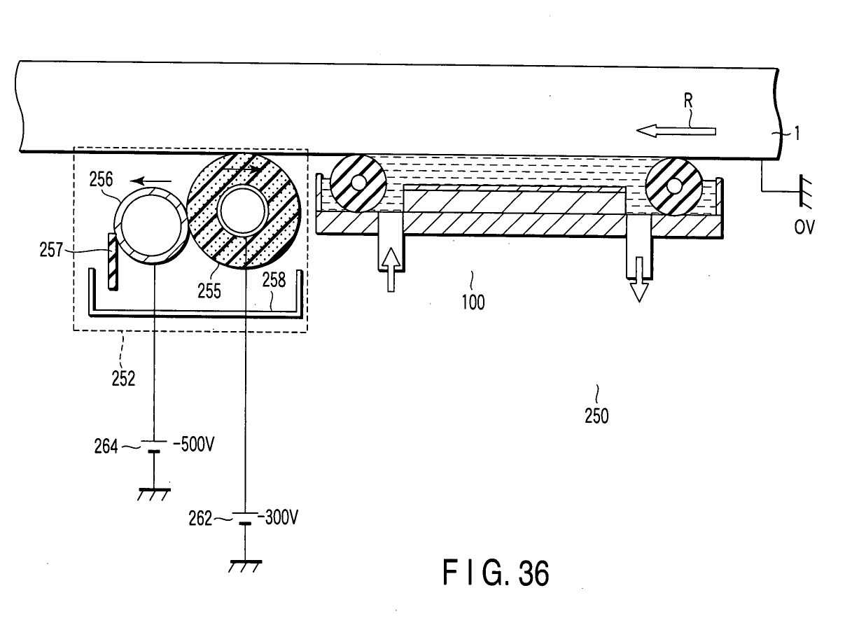

FIG. 35 shows a schematic diagram of a cleaning apparatus 250 according to the sixth embodiment of the present invention. FIG. 36 shows a diagram for illustrating the voltage to be applied to each constituent member of the cleaning apparatus 250. The cleaning apparatus 250 is different from the cleaning apparatus 230 in the fourth embodiment in that the cleaning apparatus 250 has a removal device 252 in place of the removal device 234 on the downstream side of the cleaning apparatus 100 in the rotation direction R of the original plate 1.

As shown in FIG. 35, the removal device 252 functions, like the above removal device 234, to remove any cleaning liquid remaining on the circumferential surface of the original plate 1 after passing through the cleaning apparatus 100. The removal device 252 has a sponge roller 255 in which a urethane sponge layer 254 of thickness of about 7 [mm] having continuous cells whose average cell diameter is 70 μm is formed outside a hollow pipe 253. The sponge roller 255 is arranged by being positioned so that the circumferential surface of the sponge layer 254 comes into contact with the circumferential surface of the original plate 1 and rotates in the direction opposite to the rotation direction R of the original plate 1.

The sponge layer 254 is formed from a material that has a JIS-C hardness of about 30, volume resistivity of 10³ [Ωcm] to 10¹¹ [Ω·cm], 10⁹ [Ω·cm] in the present embodiment, and average cell diameter of 20 [μm] to 200 [μm], 70 [μm] in the present embodiment, and a negative pressure is caused on the circumferential surface thereof by operating a suction pump (not shown) connected to the hollow pipe 253. That is, the cleaning liquid collected by the sponge roller 255 from the original plate 1 is mostly collected via the hollow pipe 253.

Then, a very small amount of cleaning liquid (including developer particles) remaining on the circumferential surface of the sponge roller 255 is removed by a cleaning roller 256 in rotational contact with the sponge roller 255. The cleaning roller 256 is constructed by forming an alumite layer of thickness of about 6 [μm] by anodic treatment on the circumferential surface of an aluminum hollow pipe.

Further, deposits adhering to the circumferential surface of the cleaning roller 256 are scraped off by a blade 257 before being collected in a vessel 258. The blade 257 is formed from urethane rubber of JIS-A hardness of about 80, 300% modulus 300 [kgf/cm²], and thickness of 1 [mm].

As shown in FIG. 36, an appropriate voltage is applied to each constituent member of the above removal device 252. That is, a metallic film (not shown) of the original plate 1 is grounded, a voltage of −300 [V] is applied to the sponge roller 255 via a power unit 262, and a voltage of −500 [V] is applied to the cleaning roller 256 via a power unit 264. By applying a voltage to each constituent member in such a way that the potential gradually decreases in the movement direction of developer particles, developer particles remaining on the original plate 1 can electrically effectively be moved, further increasing the removal efficiency of developer particles.

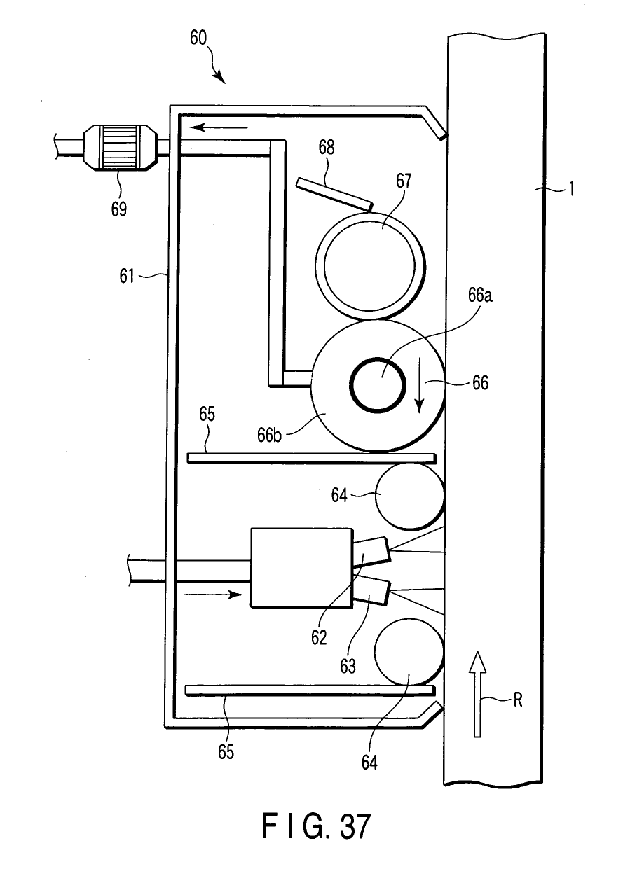

FIG. 37 shows a schematic diagram of a cleaner 60 according to the eleventh embodiment of the present invention. The cleaner 60 has a case 61 having an opening toward the surface of the original plate 1. The case 61 functions also as a vessel to collect a cleaning liquid including developer particles removed from the original plate 1.

The case 61 has two systems of nozzles 62 and 63, two liquid shielding rollers 64/64 positioned to sandwich these nozzles vertically in FIG. 37 in the rotation direction R of the original plate 1, two liquid shielding plates 65/65 arranged further outside from these two rollers, and a suction sponge roller 66, a cleaning roller 67, and a blade 68 downstream from these components 62 to 65 in the rotation direction of the original plate 1.

The nozzle 62 of one system arranged on the upper side in FIG. 37 is arranged by being inclined upward toward the rotation direction (an arrow R direction in FIG. 37) of the original plate 1 and positioned so that a tip thereof faces the surface of the original plate 1 via an opening of the case 61. The nozzle 63 of the other system is arranged by being inclined downward in FIG. 37 with respect to the rotation direction R of the original plate 1 and positioned so that the tip thereof faces the surface of the original plate 1 via the opening of the case 61.

Further, each system of the nozzles 62 and 63 has a plurality of nozzles (not shown) in the axial direction of the original plate 1 across the rotation direction R of the original plate 1. The plurality of nozzles are arranged also by being inclined toward the axial direction of the original plate 1. A liquid supply pipe is connected to a base end of the plurality of nozzles and a cleaning liquid is supplied via the liquid supply pipe to blow the cleaning liquid against the original plate 1 from the tip of each nozzle.

The two liquid shielding rollers 64 arranged at positions to sandwich the two systems of the nozzles 62 and 63 vertically have a structure in which urethane rubber is wound around a shaft, have each a length at least exceeding the length in the axial direction of the original plate 1, and are positioned so that the circumferential surface thereof is in contact with the surface of the original plate 1 via the opening of the case 61. Then, each of the liquid shielding rollers 64 rotates together with the rotation of the original plate 1, and function to prevent scattering of the cleaning liquid blown from the nozzles 62 and 63.

Also, the two liquid shielding plates 65 arranged further outside the two liquid shielding rollers 64 have a length at least exceeding the length in the axial direction of the original plate 1 and function to shield a scattered cleaning liquid that could not be shielded by the liquid shielding rollers 64. These liquid shielding plates 65 are formed from an acrylic resin and are each arranged at a position separated from the surface of the original plate 1 via a tiny gap.

By providing the liquid shielding rollers 64 and the liquid shielding plates 65, contamination of the original plate 1 by a cleaning liquid blown via the nozzles 62 and 63 being scattered to other areas of the original plate 1 can be prevented.

The suction sponge roller 66 has a length at least exceeding the length in the axial direction of the original plate 1 and is arranged by being positioned so that the circumferential surface thereof is in contact with the surface of the original plate 1 via the opening of the case 61. The suction sponge roller 66 rotates in the direction opposite to the rotation direction R of the original plate 1 to slidingly bring the circumferential surface thereof into contact with the surface of the original plate 1.

An outer circumferential surface of the cleaning roller 67 is in rotational contact with that of the suction sponge roller 66. A tip of the blade 68 is arranged on the outer circumferential surface of the cleaning roller 67 by being in contact with the outer circumferential surface.

More specifically, each system of the nozzles 62 and 63 is constructed by setting up a plurality of one-fluid nozzles jetting a liquid at high pressure in the axial direction of the original plate 1 so that each nozzle directs a jet of cleaning liquid to the surface of the original plate 1 at constant pressure. In the present embodiment, an insulating liquid constituting the liquid developer was used as a cleaning liquid. By using a solvent constituting the liquid developer as a cleaning liquid in this manner, processes can be made to proceed without hindrance even when the cleaning liquid remains in the recess 14a of the original plate 1. In other words, it is necessary to select a liquid that does not affect processes as a cleaning liquid when the liquid remains on the original plate 1.

The cleaning liquid jetted from each nozzle is spread and blown from directions inclined toward the rotation direction and axial direction of the original plate 1. Accordingly, the cleaning liquid can be blown from angles inclined to the many rectangular recesses 14a of the original plate 1 so that particularly the toner particles 55 adhering to corners of the recess 14a can reliably be removed.

The suction sponge roller 66 is constructed by providing a sponge layer 66b around a hollow shaft 66a. In the present embodiment, the sponge layer 66b is formed from a conductive urethane material with continuous cells having a JIS-C hardness of about 50, volume resistivity of 10⁹ [Ω·cm], and average cell diameter of 50 [μm].

Moreover, many intake holes (not shown) are provided in regions of the shaft 66a opposite to the sponge layer 66b. Then, when air is sucked in from many intake holes of the shaft 66a by a suction pump 69 connected to the shaft 66a, a negative pressure arises on the surface of the sponge layer 66b so that the cleaning liquid including the toner particles 55 are sucked to the sponge layer 66b.

The cleaning liquid sucked by the suction pump 69 is collected in a waste liquid tank (not shown) by passing the cleaning liquid through a liquid collection pipe (not shown). The used cleaning liquid collected in the waste liquid tank may be reused after developer particles are removed.

Further, the toner particles 55 remaining on the surface of the sponge layer 66b without being sucked in are removed by the cleaning roller 67 rotating in the direction opposite (arrow direction in FIG. 37) to that of the suction sponge roller 66. In the present embodiment, the cleaning roller 67 is constructed by forming an alumite layer of thickness of about 6 [μm] by anodic treatment of the surface of an aluminum hollow pipe.

Then, the toner particles 55 adhering to the surface of the cleaning roller 67 are scraped off by the blade 68. In the present embodiment, the blade 68 is formed from urethane rubber of JIS-A hardness of about 75, 300% modulus 300 [kgf/cm²], and thickness of 2 [mm].

That is, the surface of the above suction sponge roller 66 is always maintained in a clean state by the cleaning roller 67 and the blade 68 to enhance cleaning performance of the original plate 1.

Incidentally, appropriate voltages are applied to the above suction sponge roller 66 and the cleaning roller 67. That is, a metallic film of the original plate 1 is grounded, a voltage of −300 [V] is applied to the suction sponge roller 66, and a voltage of −500 [V] is applied to the cleaning roller 67. By applying a voltage to each constituent member in such a way that the potential gradually decreases in the movement direction of developer particles, developer particles remaining on the original plate 1 can electrically effectively be moved, further increasing the removal efficiency of developer particles.

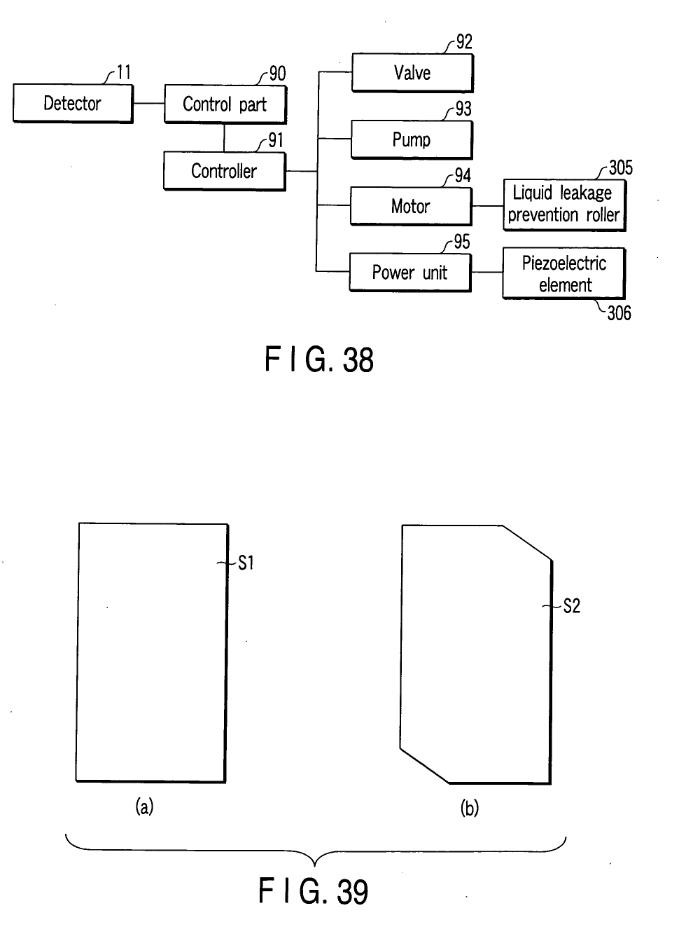

Next, a cleaning apparatus 300 according to the seventh embodiment of the present invention will be described in detail. A block diagram of a control system controlling operations of the cleaning apparatus 300 is shown in FIG. 38.

The cleaning apparatus 300 is used when it is necessary to remove more developer particles than usual from the original plate 1, for example, when a relatively large amount of developer particles adhere to the recess 14a of the original plate 1 after a failure of development of pattern images in each color or a relatively large amount of developer particles adhere to the recess 14a after a failure of transfer of pattern images in each color. In other words, the cleaning apparatus 300 is used when developer particles adhering to the original plate 1 cannot be sufficiently removed by the cleaner 8 (representing the cleaners for a description below) described above. The amount of developer particles remaining on the original plate 1 can be detected by the detector 11 shown in FIG. 1.

If, for example, a development process fails, a control part 90 (See FIG. 38) of the pattern formation apparatus 10 detects the amount of developer particles adhering to the original plate 1 via the detector 11. If the control part 90 determines that the amount of remaining developer particles exceeds a reference value, the control part 90 sends a command to a controller 91 (control device) of the cleaning apparatus 100 to select a mode to clean the original plate 1 before transition to a transfer mode. That is, the cleaning apparatus 100 is used when the original plate 1 is cleaned by different treatment separately from a normal cleaning operation by the cleaner 8. The detector 11, the control part 90, and the controller 91 function as a detection device of the present invention.

Whether to do the cleaning of the original plate 1 by the cleaning apparatus 300 is determined by the control part 90 according to one of the following two methods: a mode to do the cleaning of the original plate 1 by the cleaning apparatus 300 is selected when the amount of developer particles adhering undesirably to the original plate 1 exceeds a certain reference value, and a mode to do the cleaning of the original plate 1 by the cleaner 8 as usual is selected when the amount of developer particles falls below the certain reference value.

For example, if developer particles for developing the pattern-like recess 14a of the original plate 1 are phosphor particles, the control part 90 irradiates phosphor particles adhering to the inside of the specific recess 14a, which is to be sampled, with ultraviolet rays to detect an excitation light thereof via the detector 11. Then, the control part 90 compares the amount of excitation light with a reference amount of light pre-detected via the detector 11 under normal conditions to determine whether the amount of phosphor particles remaining on the original plate 1 exceeds the reference value.

Or, whether the amount of developer particles adhering to the recess 14a exceeds the reference value is determined by detecting an image of the recess 14a, which is to be sampled,” via a camera (not shown) or the like of the detector 11 and comparing the image with a pre-detected reference image. In this case, as shown, for example, in FIG. 39, the degree of adhesion of developer particles can be determined by calculating an area of the opening from an image of the recess 14a in a state where no developer particle adheres as a reference value S1 (FIG. 39a) in advance, calculating an occupation area S2 (FIG. 39b) of developer particles adhering to the recess 14a from the detected image when the mode is selected, and comparing the occupation area S2 with the reference value S1. More specifically, if S1 and S2 described above satisfy the following formula, the cleaning mode of the cleaner 8 is selected without using the cleaning apparatus 300 and, if S1 and S2 do not satisfy the following formula, the cleaning mode of the cleaning apparatus 300 is selected.

0.6<S2/S1<1.4

That is, if the cleaning mode is selected by the control part 90 of the pattern formation apparatus 10, the control part 90 operates a movement mechanism (not shown) to move the original plate 1 to a cleaning position above the cleaning apparatus 300. At this point, process units such as the cleaner 8, the drier 4, the static eliminator 9, and the charger 2 that stand in the way of movement of the original plate 1 are withdrawn from the movement path of the original plate 1 to a withdrawal position. Or, these process units are integrally moved together as the original plate 1 is moved. Here, illustrations of the movement mechanism for moving the original plate 1 to the cleaning position and a withdrawal mechanism for withdrawing each process unit and a description thereof are omitted.

Further, when the pattern formation apparatus 10 fails to operate or stops in an emergency, adhering developer particles may remain on the original plate 1 for a long time exceeding a certain reference value and in such a case, the cleaning in normal cleaning mode may not be doable if developers have a certain stickiness. To deal with such a situation, the control part 90 may have a mechanism to count (not shown) the time from the development process or transfer process before transition to a cleaning operation, which is equipped with a function to select a mode to clean the original plate 1 using the cleaning apparatus 300 when a certain reference time is exceeded or returned after an emergency stop.

Here, the configuration of the cleaning apparatus 300 in the present embodiment will be described.

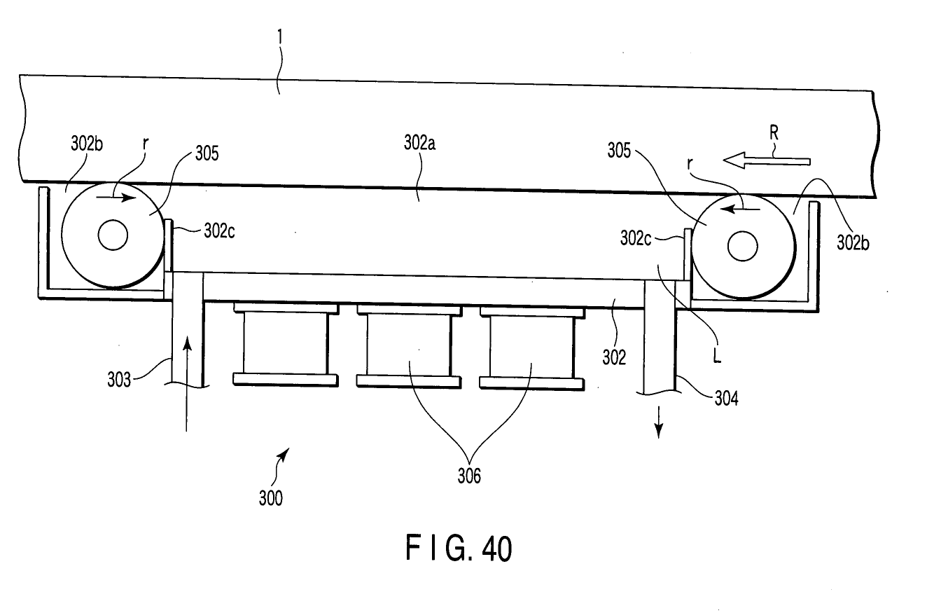

As shown in FIG. 40, the cleaning apparatus 300 has a cistern 302 opened toward the original plate 1 arranged at the illustrated cleaning position. In the present embodiment, the cleaning apparatus 300 is positioned vertically below the original plate 1 arranged at the cleaning position facing each other and therefore, the cistern 302 is opened vertically upward (toward the original plate 1). The cistern 302 has a length at least exceeding the total length of the original plate 1 in the axial direction (direction perpendicular to the paper surface of FIG. 40) and edges of the opening are curved matching the curvature of the original plate 1. Then, the original plate 1 is arranged at the cleaning position opposite to the cleaning apparatus 100 while edges of the opening are separated from the circumferential surface of the original plate 1 located at the cleaning position by a certain gap.

The cistern 302 is divided into a total of three cisterns, one inside cistern and two outside cisterns, in a simple manner. The cistern 302 has an inflow port 303 for causing a cleaning liquid L, described later, to flow into the cistern 302 and an outflow port 202b for causing the cleaning liquid L to flow out of the cistern 302 formed at the bottom of an inner cistern 302a of the cistern 302. The inflow port 303 and the outflow port 304 are formed as a long slender slit extending in the axial direction of the original plate 1 so that the cleaning liquid L circulating inside the cistern 302 flows in a constant direction (direction opposite to the rotation direction of the original plate 1) along the circumferential surface of the original plate 1.

That is, a tank housing the cleaning liquid L is connected to the inflow port 303 via a pipe and valve (not shown) and a pump 93 (See FIG. 38) so that the cleaning liquid L in the tank can be supplied to the inner cistern 302a at a controllable flow rate by operating the pump 93 (FIG. 38). Also, a waste liquid tank is connected to the outflow port 304 via a pipe (not shown) so that the cleaning liquid L discharged from the inner cistern 302a is stored in the waste liquid tank. The used cleaning liquid L collected in the waste liquid tank may be reused after developer particles are removed.

A plurality of liquid leakage prevention rollers 305 are arranged near edge parts of the inner cistern 302a. The two liquid leakage prevention rollers 305 shown in FIG. 40 are each housed and arranged in two outer cisterns 302b in such a way that the outer cisterns 302b are substantially in contact with walls 302c partitioning the cistern 302 into the inner cistern 302a and the outer cisterns 302b. Two liquid leakage prevention rollers 305 are shown in FIG. 40, but liquid shielding plates using acrylic plates or the like for prevention of liquid leakage may be provided at both ends.

Each of the liquid leakage prevention rollers 305 is positioned and arranged at a position opposite to the circumferential surface of the original plate 1 rotating at the cleaning position via a constant tiny gap. In the present embodiment, each of the liquid leakage prevention rollers 305 is a metallic roller whose roller diameter is 20 [mm] and is positioned opposite to the circumferential surface of the original plate 1 via a gap of about 50 [μm]±10 [μm].

Then, by rotating each of the liquid leakage prevention rollers 305 in a graphic arrow r direction by rotating a motor 94 (See FIG. 38), the cleaning liquid L that could leak out to the outer cistern 302b from a gap between the walls 302c at edges of the inner cistern 302a and the circumferential surface of the original plate 1 is made to flow toward the inside of the inner cistern 302a to prevent liquid leakage from the inner cistern 302a to the outer cistern 302b by a squeeze effect. In other words, the rotation direction r of each of the liquid leakage prevention rollers 305 is set as a direction in which a cleaning liquid present in a tiny gap between the original plate 1 and the liquid leakage prevention roller 305 is sent toward the inside of the inner cistern 302a. As already described above, Isopar or the like is used as the cleaning liquid L circulating in the cleaning apparatus 300. Moreover, the above components 302, 303, 304, 305, 92, 93, and 94 function as a liquid flow device of the present invention.

A plurality of piezoelectric elements 306 for generating ultrasonic waves to act on developer particles held on the original plate 1 are mounted side by side at the bottom substantially in the center outside the cistern 302. These piezoelectric elements 306 are each constructed by housing and arranging a piezoelectric body inside a case formed from a conductive material in a substantially cylindrical shape having a diameter of 45 [mm] and height of 60 [mm] and mounted together to cover a substantially whole surface of the inner cistern 302a. As shown in FIG. 38, the plurality of piezoelectric elements 306 are connected to a power unit 95 and function as ultrasonic devices for generating ultrasonic waves having desired frequencies and applied voltages under control of the controller 91. The bottom of the inner cistern 302a opposite to the original plate 1 is preferably constructed from a conductive material such as a metallic plate to prevent attenuation of ultrasonic waves.

Ultrasonic waves generated by the plurality of piezoelectric elements 306 creates an ultrasonic wave oscillation field passing through the cleaning liquid L filling a tiny gap between the surface of the original plate 1 and the piezoelectric elements 306 to cause the cleaning liquid L to penetrate into the toner particles 55 filling up the recess 14a of the original plate 1 effectively in a short time. Accordingly, even if a relatively large amount of the toner particles 55 remaining in the recess 14a is firmly fixed after the passage of time, the cleaning liquid L can be caused to penetrate into corners of the recess 14a rapidly and sufficiently to make the toner particles 55 soaked quickly so that the toner particles 55 can easily and reliably be removed from the recess 14a by flowing the cleaning liquid L.

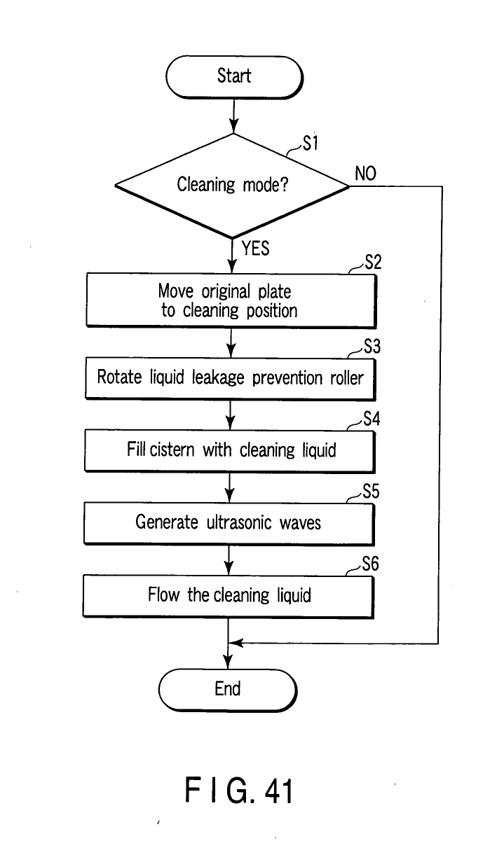

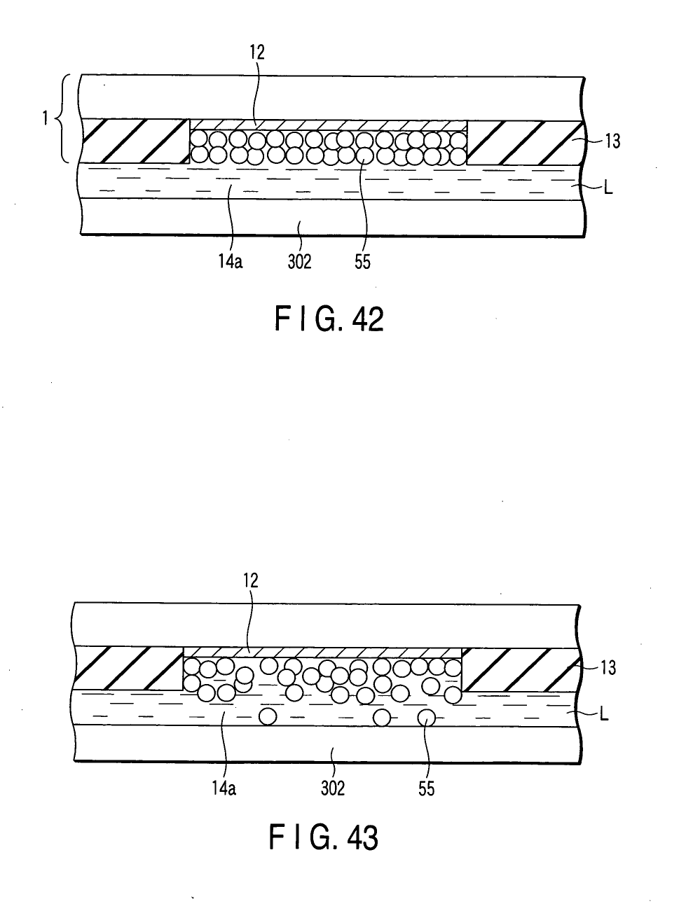

Cleaning operations performed by the cleaning apparatus 300 of the above structure will be described below with reference to operation illustration diagrams shown in FIGS. 42 to 44 together with the flow chart shown in FIG. 41. Here, the configuration of principal parts of the cleaning apparatus 300 is shown as partially enlarged views and cleaning operations of developer particles will be described by focusing on one of the recesses 14a of the original plate 1.

When the cleaning mode by the cleaning apparatus 300 is selected by the control part 90 of the pattern formation apparatus 10 (step 1; YES), the original plate 1 approaches the cleaning apparatus 300 to move to the above-described cleaning position opposite to the cleaning apparatus 300 (step 2). At this point, the control part 90 detects the amount of the toner particles 55 remaining in the original plate 1 via the detector 11 and compares the amount with a preset threshold before selecting the operation mode.

Then, the controller 91 of the cleaning apparatus 300 rotates the plurality of liquid leakage prevention rollers 304 in the direction described above (step 3) and opens the valve 92 to operate the pump 93 to supply the cleaning liquid L into the cistern 302 via the inflow port 303. At this point, the cistern 302 is filled with the cleaning liquid L by not allowing the cleaning liquid L to flow out via the outflow port 304 of the cistern 302 so that the cistern 302 is filled with the cleaning liquid L (step 4). This state is shown in FIG. 42.

Then, after the surface of the original plate 1 is filled with the cleaning liquid L at step 4, the controller 91 controls the power unit 95 to supply a power of about 1 [KW] to the plurality of piezoelectric elements 306 to create an ultrasonic wave oscillation field of about 45 [KHz] in the cleaning liquid L (step 5). At this point, the frequency, applied voltage, and application time of the generated ultrasonic waves can optionally be changed by the power unit 95 being controlled by the controller 91 and desired values in accordance with the amount of remaining toner particles detected via the detector 11, elapsed time and the like can be set.

When ultrasonic waves are generated at step 5, as shown in FIG. 43, the cleaning liquid L penetrates into the recess 14a of the original plate 1 satisfactorily and the toner particles 55 peel off the recess 14a and fall. That is, the cleaning liquid L penetrates into the toner particles 55 firmly fixed to the recess 14a effectively in a short time under the influence of ultrasonic waves and, as shown in FIG. 43, with the toner particles 55 being subjected to forced vibration in the liquid, the toner particles 55 are made to float in the cleaning liquid L.

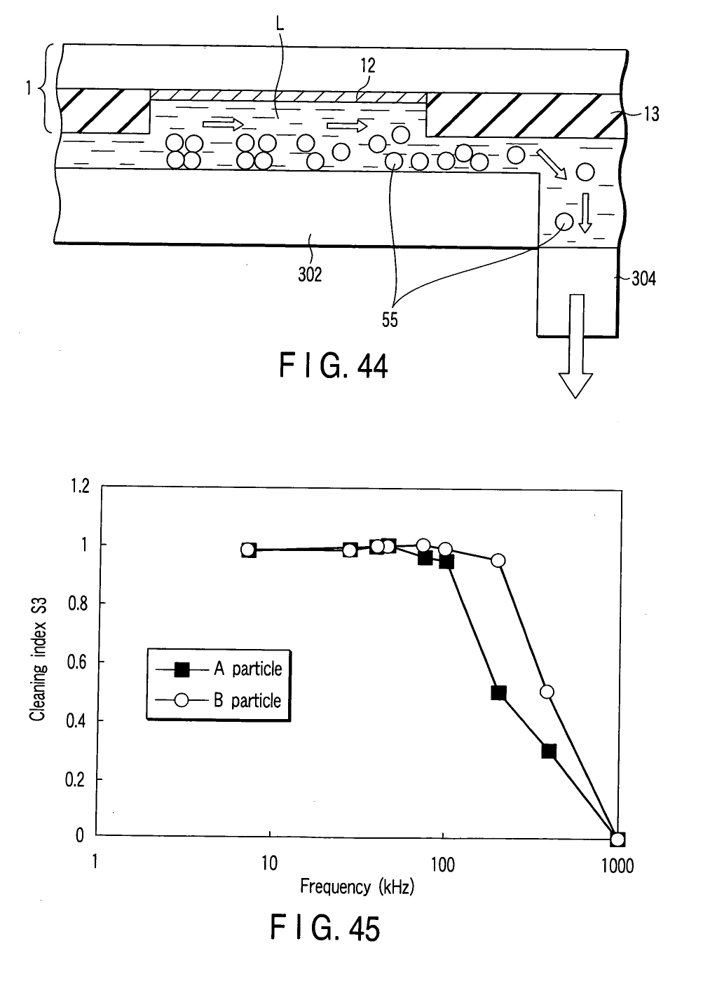

In this state, the controller 91 causes the cleaning liquid L to circulate in the cistern 302 at a predetermined flow rate by operating the pump 93 to cause the toner particles 55 floating in the cleaning liquid L after being peeled off the recess 14a to flow out via the outflow port 304 together with the cleaning liquid L in the cistern 302 (step 6). This state is shown in FIG. 44. With the above operations, the toner particles 55 held by the original plate 1 are removed.

When the cleaning liquid L is caused to flow at step 6, the ultrasonic wave oscillation field created by the piezoelectric elements 306 may have been made to disappear, but it is preferable to cause cleaning liquid L to flow while the ultrasonic wave oscillation field is formed to remove the remaining toner 55 from the recess 14a more efficiently.

By using the cleaning apparatus 300 in the present embodiment, as described above, even if a relatively large amount of developer particles remain in the pattern-like recess 14a of the original plate 1 and is firmly fixed, for example, after a failure of development process or a failure of transfer process, developer particles held on the original plate 1 can reliably and quickly be removed. Thus, high-resolution and high-precision patterns can be formed with stability by incorporating the cleaning apparatus 300 in the present embodiment into the pattern formation apparatus 10.

Moreover, according to the cleaning apparatus 300 in the present embodiment, compared with the cleaner 8 that performs a normal cleaning operation, a larger amount of developer particles can be removed satisfactorily. For example, when the cleaning apparatus 300 in the present embodiment was operated in a state where the pattern-like recess 14a of the original plate 1 was filled with developer particles, the amount of developer particles remaining in the recess 14a when the cleaning operation terminated was 0.01 [%] or less. The cleaning apparatus 300 is effective particularly when developer particles remaining in the recess 14a are firmly fixed after the passage of time and developer particles can be peeled off by making developer particles soaked under the influence of ultrasonic waves.

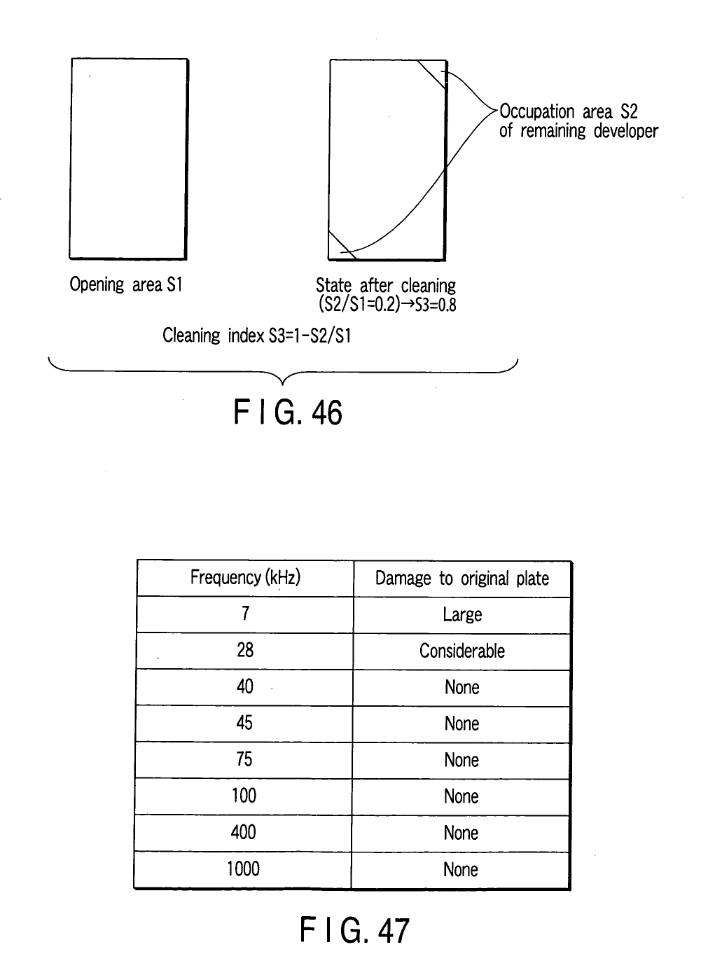

Here, a cleaning effect of the toner particles 55 when ultrasonic waves are used like the cleaning apparatus 300 in the present embodiment will be considered in more detail with reference to FIGS. 45 to 47. FIG. 45 shows a relationship between the frequency of ultrasonic waves and a cleaning index as a graph. FIG. 46 shows a diagram for illustrating a calculation method of the cleaning index. FIG. 47 is a table showing results of examination of a relationship between the frequency of ultrasonic waves and damage to the original plate 1.

In the example shown in FIG. 45, a sample in which the recess 14a of the original plate 1 was filled with the toner particles 55 was prepared, severe dry conditions were created by evaporating the solvent 54, and the original plate 1 was cleaned by changing ultrasonic waves to be applied to measure a cleaning index S3 of the recess 14a in each case. Here, A particles having a particle diameter distribution ranging from 2 to 10 [μm] and B particles whose particle diameter is 1 [μm] or less were prepared as the toner particles 55 and the cleaning index S3 was measured for each type of particles.

The cleaning index S3 is an index showing a state of cleaning of the recess 14a. In the present embodiment, if, as shown in FIG. 46, the opening area of the recess 14a when no toner particle 55 adheres is S1 and the area of the recess 14a in which the toner particles 55 remain detected by the detector 11 after cleaning is S2, cleaning index is defined as S3=1−(S2/S1). FIG. 46 illustrates a case when the cleaning index S3 is 0.8.

For measurement of the cleaning index S3, as described above, the surface of the prepared original plate 1 was filled with the cleaning liquid L, the piezoelectric elements 306 were operated in this state for 20 seconds to apply ultrasonic waves of various frequencies, the cleaning liquid L was caused to flow, and then the area S2 of the toner particles 55 remaining in the recess 14a of the original plate 1 was detected via the detector 11. Then, the opening area S1 of the recess 14a measured in advance was used to calculate the cleaning index S3 for each of the A particles and B particles when the frequency of ultrasonic waves was changed. We confirmed that when the cleaning index S3 exceeded 0.95, pattern formation in the next process was not affected.

Results thereof shown in FIG. 45 show that satisfactory values exceeding 0.95 of the cleaning index S3 is obtained for A particles when the frequency of ultrasonic waves is 100 [KHz] or less, and satisfactory values exceeding 0.95 of the cleaning index S3 is obtained for B particles when the frequency of ultrasonic waves is 200 [KHz] or less. That is, for both A particles and B particles, it became clear that satisfactory cleaning whose influence on the next process is permissible can be done if ultrasonic waves of a specific frequency or below are applied.

Examination of a relationship between the frequency of ultrasonic waves and damage to the original plate 1 showed that, as shown in FIG. 47, damage to the original plate 1 could be serious depending on the frequency band of ultrasonic waves. Thus, the frequency band that could damage the original plate 1 seriously should be excluded as an appropriate frequency of ultrasonic waves for cleaning of each of the above particles. That is, frequencies appropriate for A particles are 28 [KHz] to 100 [KHz], preferably 40 [KHz] to 100 [KHz], and frequencies appropriate for B particles are 28 [KHz] to 200 [KHz], preferably 40 [KHz] to 200 [KHz].

The above results show that, when ultrasonic waves are used for removing developer particles, there is a range of optimum frequencies of ultrasonic waves in accordance with the particle diameter and satisfactory cleaning can be done by applying ultrasonic waves to developer particles within this range.

The embodiment described above describes a case in which ultrasonic waves of specific frequencies are applied to developer particles remaining on the original plate 1, but the present invention is not limited to this and a combination of a plurality of ultrasonic waves having different frequencies may be applied. In this case, by applying, for example, three types of ultrasonic waves of 28 [KHz], 40 [KHz], and 75 [KHz] simultaneously, a difference of intensity of an oscillation field depending on the position can be made smaller, leading to uniform cleaning on the whole surface of the original plate 1.

Also, the applied frequency of ultrasonic waves may be changed with time. For cleaning of the above A particles whose particle diameter is relatively large, for example, the frequency in the initial stage of applying ultrasonic waves may be about 28 [KHz] to improve the cleaning efficiency by increasing a fluctuating force acting on developer particles before switching the frequency to about 45 [KHz] at an appropriate time to reduce damage to the original plate 1.

Also, power for applying ultrasonic waves may be changed with time. For cleaning of the above A particles, for example, a relatively high voltage may be applied to the piezoelectric elements 306 in the initial stage of applying ultrasonic waves to increase a fluctuating force acting on developer particles before lowering the applied voltage at an appropriate time to reduce damage to the original plate 1 and to improve the cleaning efficiency.

Also in the embodiment described above, a case in which the amount of remaining developer is detected by the detector 11 after doing the cleaning of the original plate 1 by the cleaner 8 and then the cleaning apparatus 300 is operated only once, but after operating the cleaning apparatus 300 once, the amount of developer remaining on the original plate 1 may be redetected. If the cleaning index S3 is less than 0.95, the cleaning by the cleaning apparatus 300 is done once again without performing the next pattern formation. In this case, the first cleaning operation and the second cleaning operation can be performed under the same conditions, but for the second cleaning operation, for example, the application time of ultrasonic waves may be made longer or the voltage applied to the piezoelectric elements 306 higher than for the first cleaning operation. Alternatively, a program may be written so that the application time and applied voltage are optionally changed in accordance with the cleaning index S3.

Incidentally, in the embodiment described above, the relative movement between the original plate 1 and the cleaning apparatus 300 during the cleaning operation of the cleaning apparatus 300 is not described, but, as shown in FIG. 40, the original plate 1 may be rotated as shown by an arrow R or may not be rotated during the cleaning operation. If the original plate 1 should be rotated, it is necessary to provide the above ultrasonic waves at least once in all areas of the circumferential surface of the original plate 1 opposite to the cistern 302 of the cleaning apparatus 300. In this case, ultrasonic waves may continue to be provided while the cleaning liquid L is always flowing.

If the original plate 1 should not be rotated, after cleaning of an area of the circumferential surface of the original plate opposite to the cistern 302 of the cleaning apparatus 300 is completed, the cleaning is done several times by intermittently rotating the original plate 1 so that the cistern 302 faces areas adjacent to this area. In this case, it is preferable to set the distance of rotation of the original plate 1 so that two adjacent areas to be cleaned overlap only slightly.

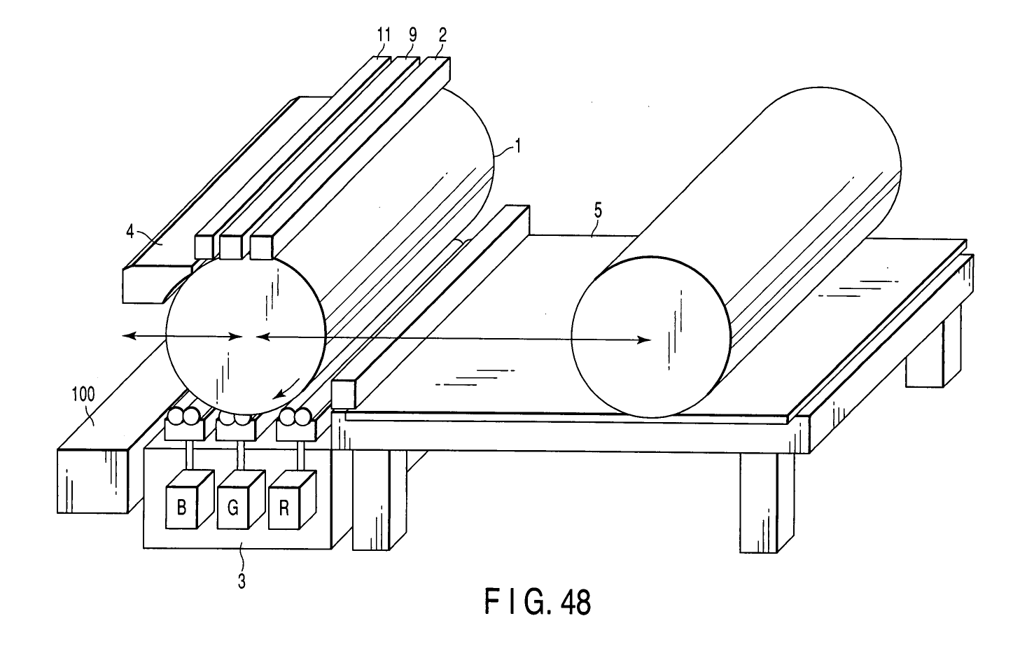

Moreover, in the embodiment described above, a case in which both the cleaner 8 and the cleaning apparatus 300 are used as cleaning means of the original plate 1 is described, but the present invention is not limited to this, and, as shown in FIG. 48 only the cleaning apparatus 300 having a higher developer particle removal capability may be used by excluding the cleaner 8 from components of the pattern formation apparatus 10.

Also, in the embodiment described above, the original plate 1 is moved to the cleaning position to be arranged above the cleaning apparatus 300 when the cleaning operation of the cleaning apparatus 300 is performed, but the arrangement position of the cleaning apparatus 300 is not limited to this, and if liquid leakage between edges of the cistern 302 and the circumferential surface of the original plate can reliably be prevented, it is possible to arrange the cleaning apparatus 300 on the circumferential surface of the original plate 1 arranged at the development position. That is, the cistern 302 need not necessarily be arranged in a posture with the opening thereof directed upward and, for example, by using rubber packing (not shown) for preventing liquid leakage in place of the liquid leakage prevention roller 305 described above to enhance the liquid leakage prevention mechanism, the cleaning apparatus 300 can be arranged at the position of the cleaner 8.

Further, in the embodiment described above, the surface of the original plate 1 is filled with the cleaning liquid L by supplying the cleaning liquid L into the cistern 302 after the original plate 1 is caused to approach the cleaning apparatus 300 to be opposite the opening of the cleaning apparatus 300, but a method of pre-wetting the surface of the original plate 1 with the cleaning liquid L in a prior stage can also be considered. Accordingly, even if developer particles held on the original plate 1 are hard and dry for a length of time, they can be soaked by pre-wetting so that they can be removed still more efficiently.

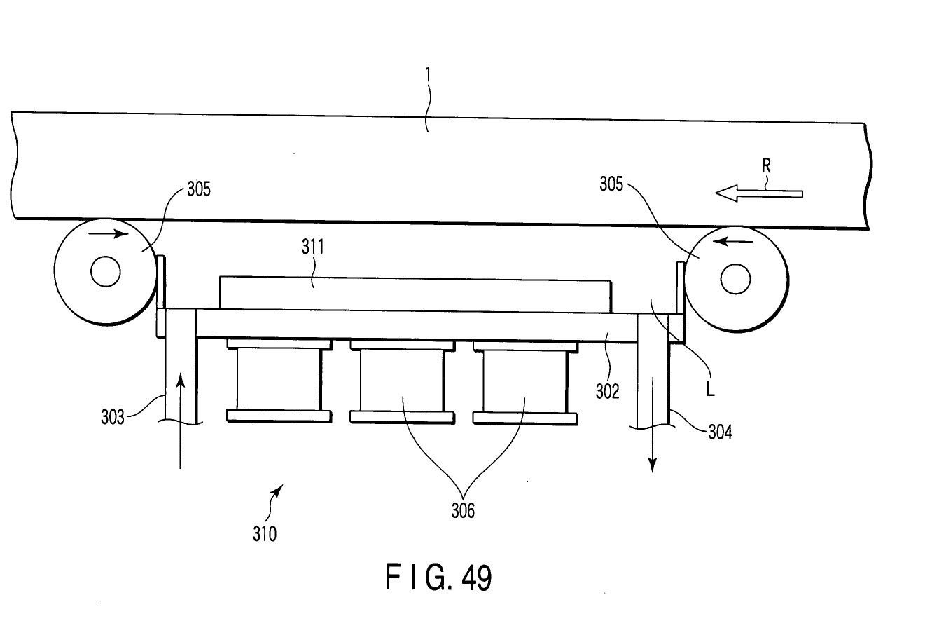

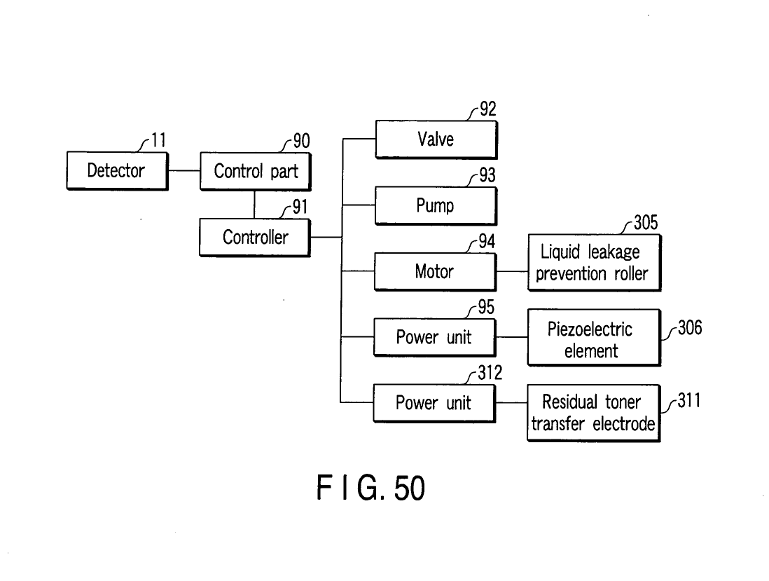

Next, a cleaning apparatus 310 according to the eighth embodiment of the present invention will be described with reference to FIGS. 49 and 50. FIG. 49 shows an outline of the structure of the cleaning apparatus 310 and FIG. 50 shows a block diagram of a control system of the cleaning apparatus 310. The cleaning apparatus 310 has substantially the same structure as that of the cleaning apparatus 300 according to the seventh embodiment described above except that the cleaning apparatus 310 has a residual toner transfer electrode 311 (hereinafter, simply referred to as a transfer electrode 311) at the bottom of the cistern 302 and therefore, the same reference numerals are attached to components that function similarly and a description thereof is omitted.

The transfer electrode 311 is arranged at the bottom of the cistern 302 between the plurality of piezoelectric elements 306 and the original plate 1 and has a size covering substantially the whole surface of the bottom of the cistern 302. The transfer electrode 311 is curved to form a recess toward the original plate 1 matching the curvature of the original plate 1. In the present embodiment, the transfer electrode 311 is formed by applying a gold coating of thickness of 5 [μm] to the surface of a nickel plate having a thickness of almost 0.5 [mm] and a gap between the circumferential surface of the original plate 1 and the transfer electrode 311 is set to about 100 [μm]±20 [μm]. While, as described above, the bottom of the inner cistern 302a is preferably constituted by a conductive material such as a metallic plate to prevent attenuation of ultrasonic waves, the transfer electrode 311 is fixed to the bottom of the inner cistern 302a via an insulating adhesive or the like (details not shown), and it is needless to say that the transfer electrode 311 and the inner cistern 302a are electrically insulated.

As shown in FIG. 50, a power unit 312 is connected to the transfer electrode 311. Then, in the present embodiment, a voltage of, for example, −500 [V] is applied to the transfer electrode 311 via the power unit 312 to form an electric field between the metallic film 12 (not shown here) at the earth potential arranged at the bottom of the recess 14a and the transfer electrode 311.

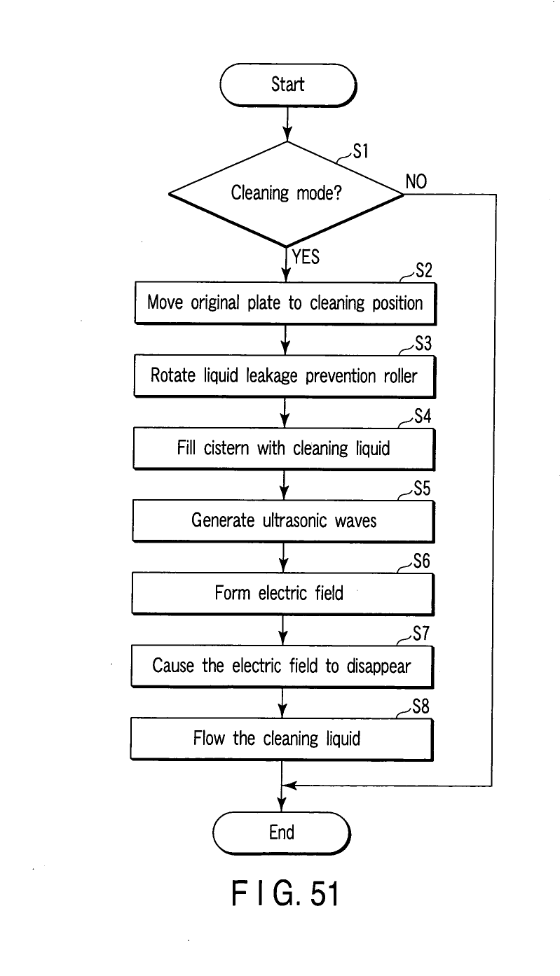

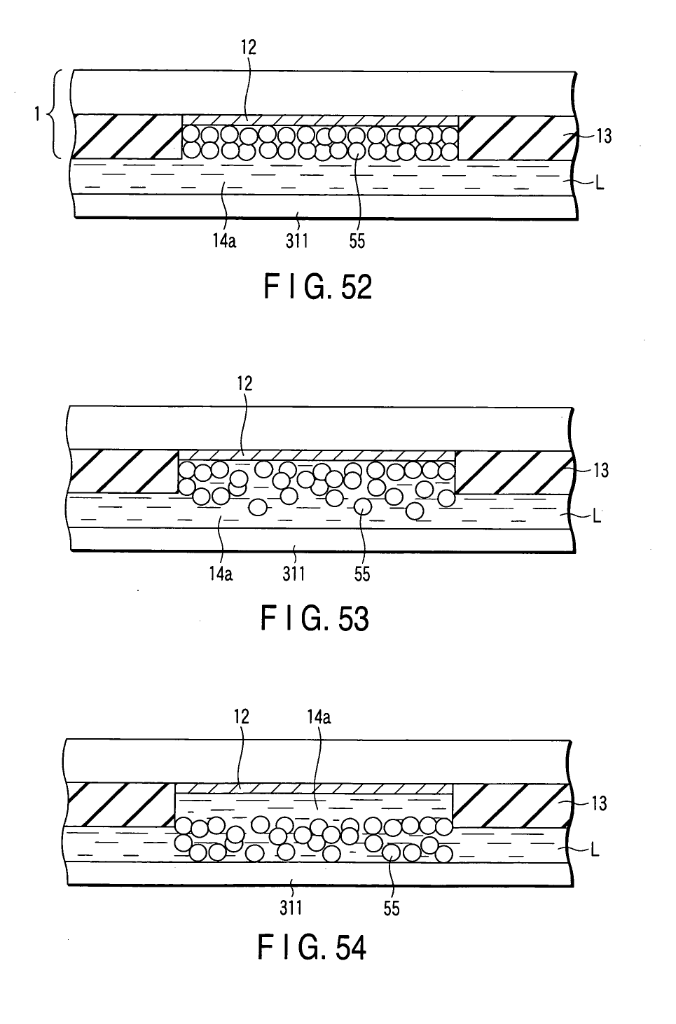

Cleaning operations of the cleaning apparatus 310 of the above structure will be described below with reference to operation illustration diagrams shown in FIG. 52 to FIG. 56 together with the flow chart shown in FIG. 51. Here, the configuration of principal parts is shown as partially enlarged views and cleaning operations of developer particles will be described by focusing on one of the recesses 14a of the original plate 1.

When the cleaning mode of the cleaning apparatus 310 is selected by the control part 90 of the pattern formation apparatus 10 (step 1; YES), the original plate 1 approaches the cleaning apparatus 310 to move to the above-described cleaning position adjacently opposite to the cleaning apparatus 310 (step 2). At this point, the control part 90 detects the amount of the toner particles 55 remaining in the original plate 1 via the detector 11 and compares the amount with a preset threshold before selecting the operation mode.

Then, the controller 91 of the cleaning apparatus 310 rotates the plurality of liquid leakage prevention rollers 305 in the direction described above (step 3) and opens the valve 92 to operate the pump 93 to supply the cleaning liquid L into the cistern 302 via the inflow port 303. At this point, the cistern 302 is filled with the cleaning liquid L by not allowing the cleaning liquid L to flow out via the outflow port 304 of the cistern 302 so that the cistern 302 is filled with the cleaning liquid L (step 4). This state is shown in FIG. 52.

Then, after the surface of the original plate 1 is filled with the cleaning liquid L at step 4, the controller 91 controls the power unit 95 to supply power of about 1 [KW] to the plurality of piezoelectric elements 306 to create an ultrasonic wave oscillation field of about 45 [KHz] in the cleaning liquid L (step 5). At this point, the frequency, applied voltage, and application time of the generated ultrasonic waves can optionally be changed by the power unit 95, which is controlled by the controller 91, and desired values in accordance with the amount of remaining toner particles detected via the detector 11, elapsed time and the like can be set.

When ultrasonic waves are generated at step 5, as shown in FIG. 53, the cleaning liquid L penetrates into the recess 14a of the original plate 1 satisfactorily and the toner particles 55 peel off the recess 14a and fall. That is, the cleaning liquid L penetrates into the toner particles 55 firmly fixed to the recess 14a effectively in a short time under the influence of ultrasonic waves and, as shown in FIG. 53, with the charged toner particles 55 being subjected to forced vibration in the liquid, the toner particles 55 are made to float in the cleaning liquid L.

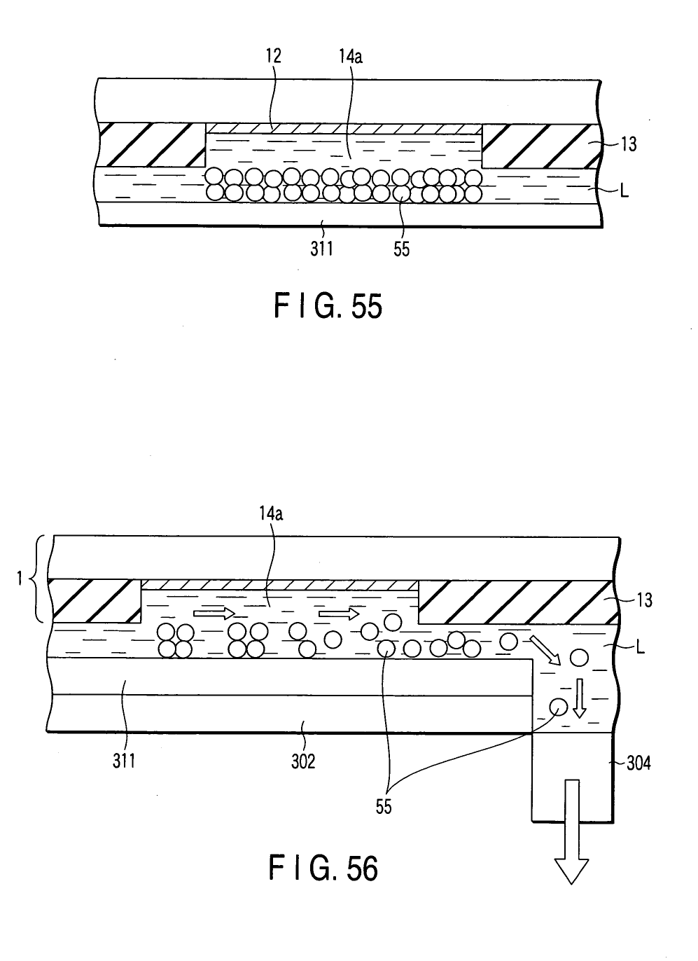

In this state, the controller 91 applies a voltage of about −500 [V] to the transfer electrode 311 via the power unit 312 to form an electric field between the metallic film 12 present in the recess 14a of the original plate 1 and the transfer electrode 311 (step 6). This state is shown in FIG. 54. Accordingly, developer particles floating inside the recess 14a migrate through the cleaning liquid L filling the space between the recess 14a and the transfer electrode 311 before being adsorbed onto the transfer electrode 311. This state is shown in FIG. 55.

Then, the controller 91 turns off the power unit 312 at an appropriate time to make the potential of the transfer electrode 311 equal to that of the metallic film 12 to cause the electric field formed at step 6 to disappear (step 7). Then, the controller 91 operates the pump 93 to cause the cleaning liquid L to circulate in the cistern 302 at a predetermined flow rate to cause the toner particles 55 adsorbed by the transfer electrode 311 to flow out via the outflow port 304 together with the cleaning liquid L in the cistern 302 (step 8). This state is shown in FIG. 56. With the above operations, the toner particles 55 held by the original plate 1 are removed.

When the cleaning liquid L is caused to flow at step 8, the ultrasonic wave oscillation field created by the piezoelectric elements 306 and the electric field formed by the transfer electrode 311 have been made to disappear, but formation and disappearance of an electric field may be repeated by applying a pulse-shaped voltage to the transfer electrode 311 while the ultrasonic wave oscillation field is formed.

By using the cleaning apparatus 310 in the present embodiment, as described above, even if a relatively large amount of developer particles remains in the pattern-like recess 14a of the original plate 1 and is firmly fixed, for example, after a failure of a development process or a failure of a transfer process, developer particles held on the original plate 1 can reliably and quickly be removed. Thus, high-resolution and high-precision patterns can be formed with stability by incorporating the cleaning apparatus 310 in the present embodiment into the pattern formation apparatus 10.

Particularly, the cleaning apparatus 310 in the present embodiment forms an electric field, in addition to an ultrasonic wave oscillation field, and therefore, developer particles peeled off the recess 14a by ultrasonic waves can be actively adsorbed onto the transfer electrode 311 to remove developer particles remaining in the recess 14a more efficiently.

Here, a single insulating solvent is used as the cleaning liquid L, but developer particles peeled off the recess 14a can be actively adsorbed onto the transfer electrode 311 by supplementally adding an appropriate amount of a metallic soap component, such as zirconium naphthenate, to the insulating solvent to provide conductivity to the cleaning liquid, which leads to increased charging characteristics of remaining developer particles to enhance an effect of electric field application. In this case, by restricting the amount of added metallic soap to 0.1% by weight or less, it has been confirmed that the next development process is not affected even if the cleaning liquid L remains on the surface of the original plate 1.

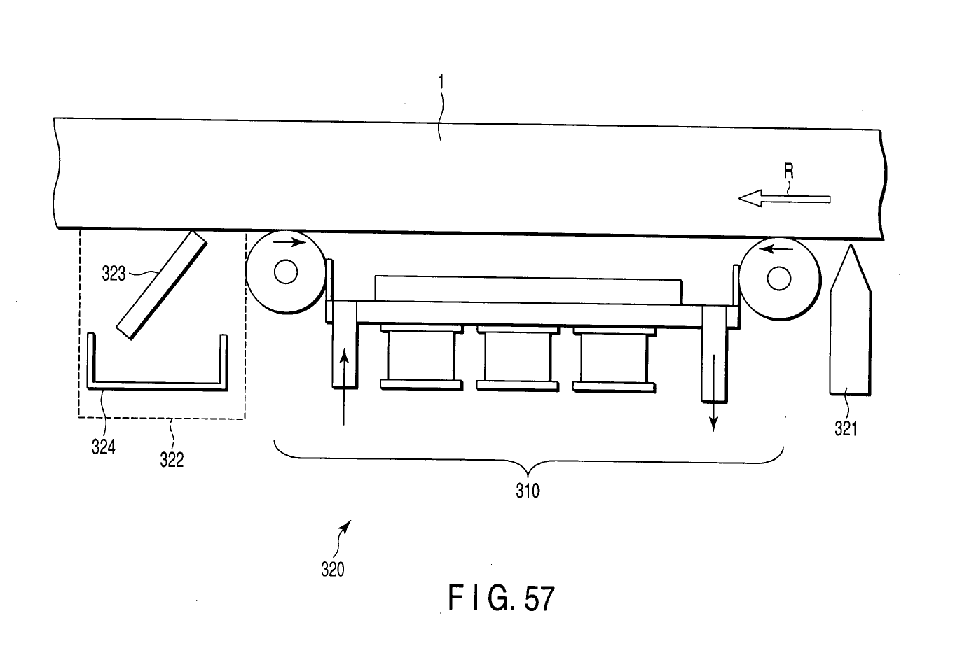

Next, a cleaning apparatus 320 according to a first modification having the configuration of the cleaning apparatus 310 in the eighth embodiment described above will be described with reference to FIGS. 57 to 60. In each modification and the ninth embodiment described below, the same reference numerals are attached to components that function like those of the cleaning apparatuses 300 and 310 in the seventh and eighth embodiments described above respectively and a description thereof is omitted. Moreover, the cleaning apparatus 310 in each of the modifications described below can be replaced by the cleaning apparatus 300 in the seventh embodiment.

As shown in FIG. 57, the cleaning apparatus 320 has, in addition to the components of the cleaning apparatus 310 in the eighth embodiment, a nozzle 321 functioning as a pre-wet device and a removal device 322. The nozzle 321 is arranged on the upstream side in the rotation direction (arrow R direction) of the original plate 1 from the cleaning apparatus 310 and the removal device 322 is arranged on the downstream side from the cleaning apparatus 310.

The nozzle 321 functions to pre-wet the surface of the original plate 1 before passing through the cleaning apparatus 310 by supplying a cleaning liquid to the surface. By pre-wetting the surface of the original plate 1 before passing through the cleaning apparatus 310 in this manner, developer particles adhering to the recess 14a of the original plate 1 can be softened to enhance the cleaning effect of the cleaning apparatus 310. For example, a high-pressure one-fluid nozzle of the cleaner 8 described above may be adopted as the nozzle 321.

The removal device 322 has a blade 323 in contact with the surface of the original plate 1 and a tray 324 for collecting the cleaning liquid removed from the surface by the blade 323. The removal device 322 functions to remove the cleaning liquid remaining on the surface of the original plate 1 after passing through the cleaning apparatus 310. That is, the removal device 322 scrapes off the cleaning liquid remaining on the surface by bringing the blade 323 into contact with the surface of the original plate 1 and the scraped-off cleaning liquid is collected in the tray 324. The blade 323 is preferably formed from a resin whose JISA hardness is 30 to 90 and in the present embodiment, the blade 323 is formed from a resin whose JISA hardness is 60.

Operations of the cleaning apparatus 320 of the above structure will be described below. Operations of the cleaning apparatus 310 incorporated into the cleaning apparatus 320 are the same as those described in the eighth embodiment and therefore, a detailed description thereof is here omitted.

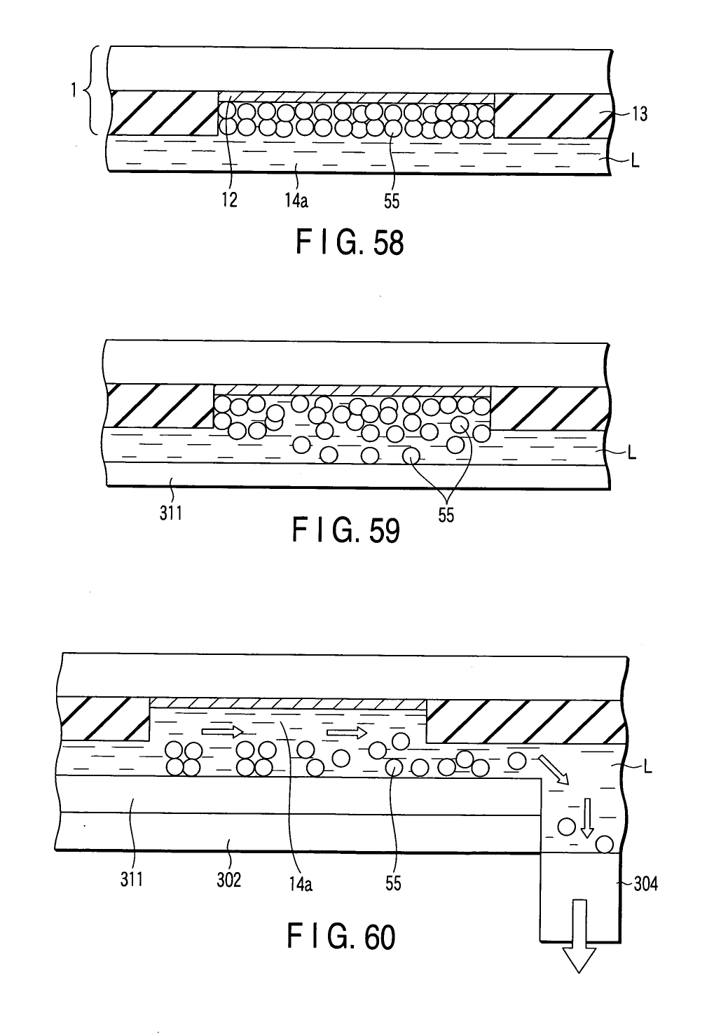

First, the surface of the original plate 1 is wetted with a cleaning liquid supplied via the nozzle 321 on the upstream side in the rotation direction of the original plate 1. At this point, the nozzle 321 supplies the cleaning liquid to areas covering the whole length of the original plate 1 in the axial direction crossing the rotation direction of the original plate 1 to wet the whole surface of the original plate 1 with the cleaning liquid. Accordingly, the toner particles 55 remaining in the recess 14a of the original plate 1 are soaked and softened. This state is shown in FIG. 58.

Then, an area of the wetted surface of the original plate 1 is passed through the cleaning apparatus 310 and, as described above, the toner particles 55 remaining in the recess 14a are peeled off by an ultrasonic wave oscillation field created via the piezoelectric elements 306 and an electric field formed by the transfer electrode 311 and caused to migrate through the cleaning liquid L before being adsorbed onto the transfer electrode 311. This state is shown in FIG. 59.

Then, after the electric field is made to disappear, the cleaning liquid L is continuously caused to circulate while the ultrasonic wave oscillation field is formed. The toner particles 55 floating in the cleaning liquid L and the toner particles 55 adsorbed by the transfer electrode 311 are thereby caused to flow out. This state is shown in FIG. 60.

Further thereafter, the surface of the original plate 1 is passed through the removal device 322 so that the cleaning liquid L remaining on the surface is removed. At this point, the cleaning liquid L remaining on the surface of the original plate 1 is scraped off by the blade 323 and collected in the tray 324 before being discharged via a drainage tube (not shown). The blade 323 in contact with the surface of the original plate 1 has a length covering the whole length in the axial direction crossing the rotation direction R of the original plate 1 and is slidingly brought into contact with the whole surface of the original plate 1.

According to the cleaning apparatus 320 in the present comparative example, as described above, the same effect as that of the cleaning apparatus 310 in the eighth embodiment can be achieved, and in addition, the surface of the original plate 1 before passing through the cleaning area is wetted with the cleaning liquid L in advance so that even the toner particles 55 in a firmly fixed state after the passage of time can be soaked and softened in advance, further enhancing cleaning performance. Also according to the present comparative example, the cleaning liquid L adhering to the surface of the original plate 1 after cleaning is actively removed and therefore, any influence on the next process can be almost completely eliminated.

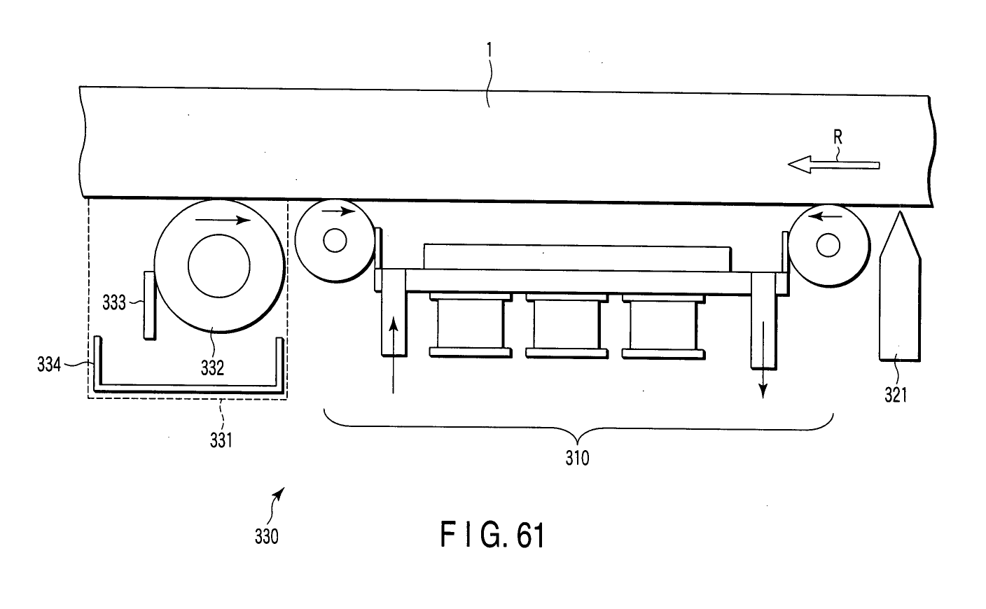

Next, a cleaning apparatus 330 according to a second comparative example will be described with reference to FIG. 61. The cleaning apparatus 330 has a different structure from that of the cleaning apparatus 320 in the first modification in that the cleaning apparatus 330 has a removal device 331 in place of the removal device 322 on the downstream side of the cleaning apparatus 310 in the rotation direction R of the original plate 1.

Like the above removal device 322, the removal device 331 functions to remove the cleaning liquid L remaining on the surface of the original plate 1 after passing through the cleaning apparatus 310. The removal device 331 has a sponge roller 332 for collecting the cleaning liquid L adhering to the surface by being brought into contact with the surface of the original plate 1 and rotating in the direction opposite to the rotation direction R of the original plate 1, a scraper 333 for scraping off contaminants such as a cleaning liquid from the circumferential surface of the sponge roller 332, and a vessel 334 for collecting deposits scraped off by the scraper 333.

The sponge roller 332 has a sponge layer having cells whose average cell diameter is 20 [μm] to 400 [μm] and collects the cleaning liquid remaining on the surface of the original plate 1 through adhesion. In the present comparative example, the urethane sponge roller 332 whose average cell diameter is 200 [μm] was used. The scraper 333 is formed from a metallic plate.

The same effect as that of the cleaning apparatus 320 in the first comparative example can be achieved by the cleaning apparatus 330 and developer particles remaining in the recess 14a of the original plate 1 can reliably be collected. That is, the sponge roller 332 can follow the shape of the recess 14a by elastically being deformed by the shape of the recess 14a of the original plate 1 and also has an action of sucking a cleaning liquid by many cells.

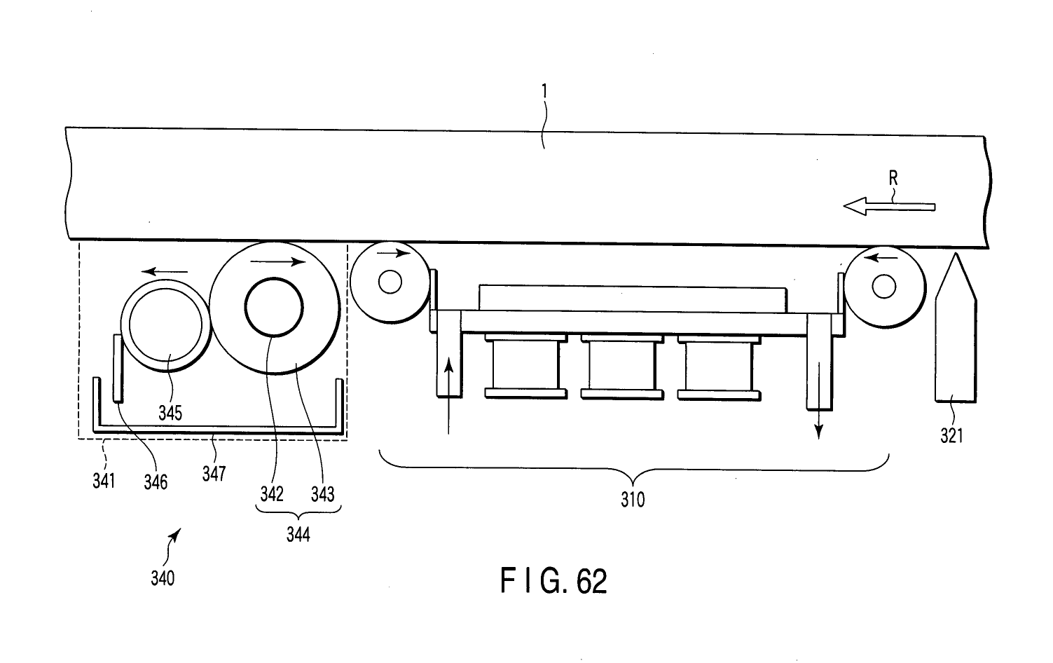

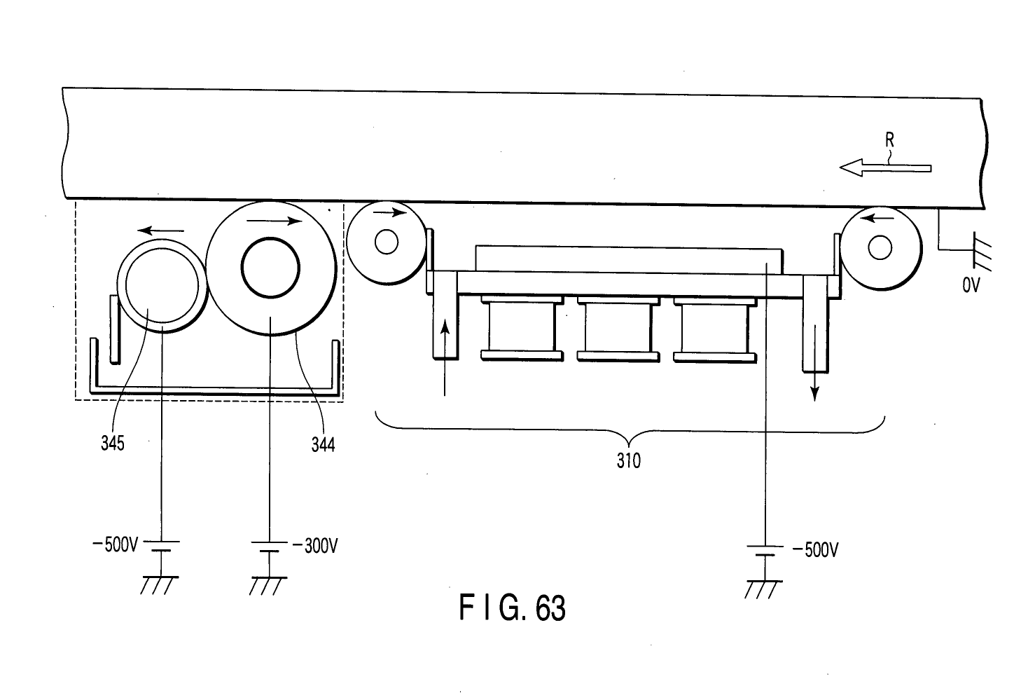

Next, a cleaning apparatus 340 according to a third comparative example will be described with reference to FIGS. 62 and 63. FIG. 62 shows an outline configuration of the cleaning apparatus 340 and FIG. 63 shows a diagram for illustrating the voltage to be applied to each component of the cleaning apparatus 340. The cleaning apparatus 340 has a different structure from that of the cleaning apparatus 320 described above in that the cleaning apparatus 340 has a removal device 341 in place of the removal device 322 on the downstream side of the cleaning apparatus 310 in the rotation direction R of the original plate 1.

As shown in FIG. 62, the removal device 341 functions, like the above removal device 322, to remove the cleaning liquid L remaining on the surface of the original plate 1 after passing through the cleaning apparatus 310. The removal device 341 has a suction sponge roller 344, and is constructed by forming a urethane sponge layer 343 of thickness of about 7 [mm] having continuous cells whose average cell diameter is 70 μm outside a hollow pipe 342. The suction sponge roller 344 is arranged by being positioned so that the circumferential surface of the sponge layer 343 is in contact with the surface of the original plate 1 and rotates in the opposite direction to the rotation direction R of the original plate 1.

The sponge layer 343 is formed from a material that has a JIS-C hardness of about 30, volume resistivity of 10³ [Ω·cm] to 10¹¹ [Ω·cm], 10⁹ [Ω·cm] in the present embodiment, and average cell diameter of 20 [μm] to 200 [μm], 70 [μm] in the present embodiment, and a negative pressure is caused on the circumferential surface thereof by operating a suction pump (not shown) connected to the hollow pipe 342. That is, the cleaning liquid collected by the suction sponge roller 344 from the original plate 1 is mostly collected via the hollow pipe 342.

Then, a very small amount of cleaning liquid (including developer particles) remaining on the circumferential surface of the suction sponge roller 344 is removed by a cleaning roller 345 in rotational contact with the suction sponge roller 344. The cleaning roller 345 is constructed by forming an alumite layer of thickness of about 6 [μm] by anodic treatment of the surface of an aluminum hollow pipe.

Further, deposits adhering to the circumferential surface of the cleaning roller 345 are scraped off by a blade 346 before being collected in a vessel 347. The blade 346 is formed from urethane rubber of JIS-A hardness of about 80, 300% modulus 300 [kgf/cm²], and thickness of 1 [mm].

As shown in FIG. 63, an appropriate voltage is applied to each constituent member of the above removal device 341. That is, a metallic film (here not shown) of the original plate 1 is grounded, a voltage of −300 [V] is applied to the suction sponge roller 344 via a power unit (not shown), and a voltage of −500 [V] is applied to the cleaning roller 345. By applying the voltage to each constituent member in such a way that the potential gradually decreases in the movement direction of developer particles, developer particles remaining on the original plate 1 can electrically effectively be moved, further increasing the removal efficiency of developer particles.

The cleaning apparatuses 320, 330, and 340 in the eighth embodiment have, as described above, a removal device of the cleaning liquid L and therefore, an effect of electric field application can be enhanced by using a conductive cleaning liquid whose amount of added metallic soap is increased to about 0.3% by weight so that cleaning can be done in a process in which the cleaning effect is enhanced. In this case, the cleaning liquid L can reliably be removed by the removal device and thus, any influence on the next development process can be prevented.

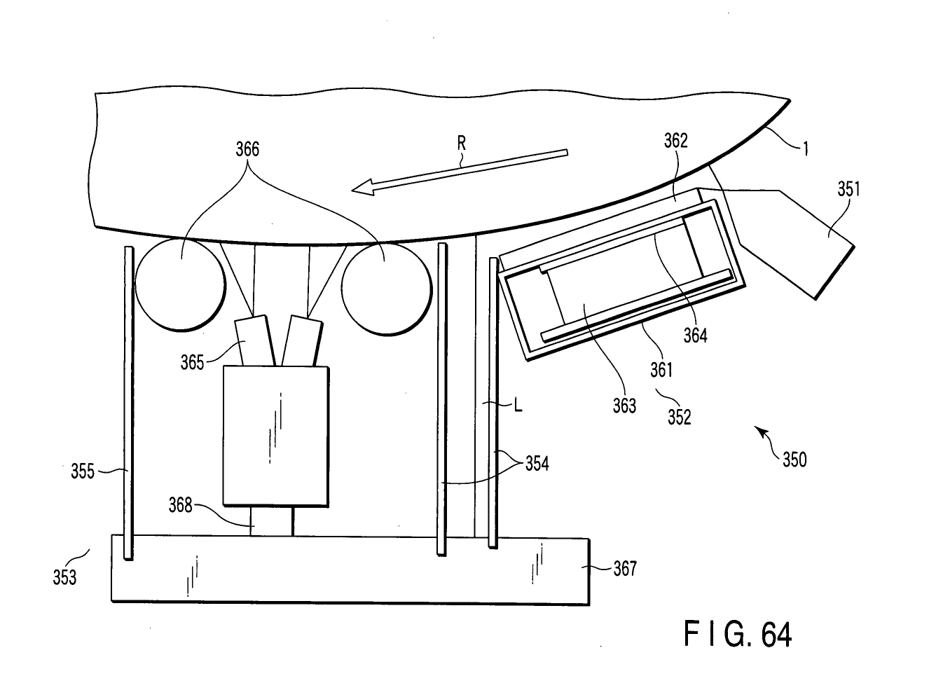

Next, a cleaning apparatus 350 according to the ninth embodiment will be described with reference to FIGS. 64 to 68.

As shown in FIG. 64, the cleaning apparatus 350 has liquid supply nozzles 351 (pre-wet device), a pretreatment unit 352 (ultrasonic device), and a blowing removal unit 353 (blowing device) from the upstream side in the rotation direction R of the original plate 1. Two liquid shielding plates 354/354 are arranged between the pretreatment unit 352 and the blowing removal unit 353 and a liquid shielding plate 355 is arranged on the downstream side from the blowing removal unit 353. These liquid shielding plates 354 and 355 are formed from, for example, acrylic plates, have a length covering the whole length of the original plate 1 in the axial direction, and function to prevent the cleaning liquid L from contaminating other areas by being scattered.

A plurality of the liquid supply nozzles 351 are arranged in the axial direction crossing the rotation direction R of the original plate 1 so that a uniform amount of the cleaning liquid L can be supplied to the whole surface of the original plate 1. The cleaning liquid L supplied to the surface of the original plate 1 via the liquid supply nozzles 351 passes through the pretreatment unit and the two liquid shielding plates 354 before being discharged.

The pretreatment unit 352 has a rectangular frame-shaped metallic case 361 that is long and thin in the axial direction, a transfer electrode 362 for forming an electric field between the metallic film (not shown) of the original plate 1 and the transfer electrode 362, and a plurality of piezoelectric elements 363 for providing ultrasonic waves to the surface of the original plate 1. The transfer electrode 362 is pasted on a surface of the case 361 opposite to the surface of the original plate 1 using an insulating adhesive and the plurality of piezoelectric elements 363 are adhesion-fixed to an inside surface of the case 361 on the original plate 1 using an insulating adhesive 364.

More specifically, the case 361 is a hollow metallic case having a length at least exceeding the whole length of the original plate 1 in the axial direction (direction perpendicular to the paper surface of FIG. 64) and houses the plurality of piezoelectric elements 363 inside by being arranged in the axial direction. The transfer electrode 362 is arranged at a position opposite to the original plate 1 with a gap of 0.1 to 1 mm therebetween and forms an electric field and an ultrasonic wave oscillation field between the original plate 1 and the transfer electrode 362 after pouring the cleaning liquid L into the gap between the original plate 1 and the transfer electrode 362 from the liquid supply nozzles 351 to fill the gap with the cleaning liquid L.

The blowing removal unit 353 has a nozzle array 365 in which two systems of nozzles are disposed and a pair of liquid shielding rollers 366 opposite to each other by sandwiching the nozzles. The blowing removal unit 353 also has a liquid receiving tray 367 for collecting the cleaning liquid L used for cleaning. The liquid receiving tray 367 also collects the cleaning liquid L that has passed through the pretreatment unit 352 described above. The cleaning liquid L is supplied to the liquid supply nozzles 351 and the nozzle array 365 from a common cleaning liquid tank (not shown) via a liquid supply pipe 368. The collected liquid from the liquid receiving tray 367 is stored in a waste liquid tank and, after developer particles are removed via a filter device, returned to a cleaning liquid tank to be reused as a cleaning liquid (not shown).

The nozzle used for the liquid supply nozzle 351 and the nozzle array 365 is a high-pressure one-fluid nozzle for both cases and the liquid supply nozzle 351 jets a cleaning liquid toward a cleaning area of the original plate 1 at a liquid pressure of 0.2 to 1.0 [MPa]. The nozzle array 365 is a two-system nozzle array slightly inclined in the forward and backward directions with respect to the rotation direction R of the original plate 1 and each nozzle jets the cleaning liquid L toward the cleaning area of the original plate 1 at liquid pressure of 0.2 to 2.0 [MPa].

The two liquid shielding rollers 366 have a structure in which urethane rubber is wound around a shaft and is arranged at positions opposite to each other sandwiching the nozzle array 365 in the rotation direction R in a state where the liquid shielding rollers 366 are in contact with the surface of the original plate 1. Each of the liquid shielding rollers 366 has a length covering the whole length of the original plate 1 in the axial direction and rotates together with rotation of the original plate 1. In this manner, the liquid shielding rollers 366 function to prevent the cleaning liquid L being jetted at high pressure from the nozzle array 365 of two nozzles from contaminating the original plate 1 by being scattered to other areas.

Cleaning operations of the cleaning apparatus 350 of the above structure will be described below.

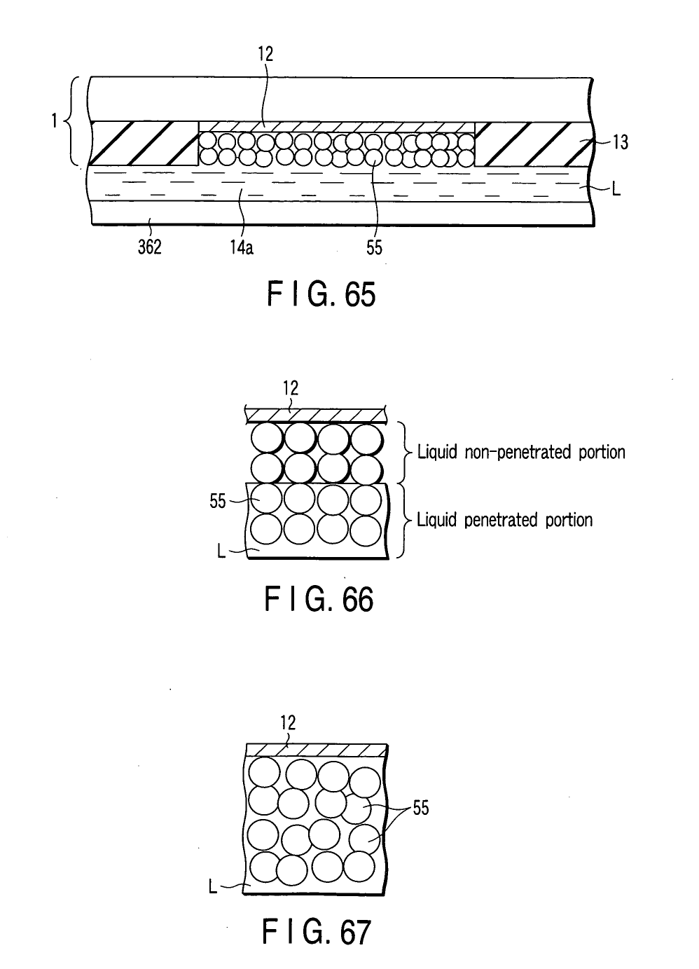

First, the cleaning liquid L is supplied to the surface of the original plate 1 via the liquid supply nozzle 351. At this point, the supplied cleaning liquid L fills a gap between the transfer electrode 362 of the pretreatment unit 352 and the surface of the original plate 1 and, as shown in FIG. 65, the toner particles 55 adhering to/remaining in the recess 14a of the original plate 1 are pre-wetted. The cleaning liquid L further circulates between the original plate 1 and the transfer electrode 362 and passes through the two liquid shielding plates 354 before being collected in the liquid receiving tray 367.

Next, while a gap between the transfer electrode 362 and the original plate 1 is filled with the cleaning liquid L as described above, an electric field is formed and also an ultrasonic wave oscillation field is formed between the original plate 1 and the transfer electrode 362 via the pretreatment unit 352. That is, a voltage of about 3 [KW] is applied to the plurality of piezoelectric elements 363 to form an ultrasonic wave oscillation field of about 45 [KHz] and at the same time, a voltage of about −500 [V] is applied to the transfer electrode 362 to form an electric field between the metallic film 12 (conductive member) and the transfer electrode 362. Accordingly, the toner particles 55 adhering to the recess 14a are peeled off and a portion thereof can be adsorbed by the transfer electrode 362.

Particularly when the toner particles 55 in the recess 14a are dried and firmly sticking, as shown in FIG. 66, the cleaning liquid L cannot be adequately caused to penetrate to the bottom of the recess 14a only by supplying the pre-wet liquid L via the liquid supply nozzle 351. That is, only supplying the cleaning liquid L to the surface of the original plate 1 via the liquid supply nozzle 351 splits the toner particles 55 into a liquid penetrated portion and a liquid non-penetrated portion.

Thus, like the present embodiment, by applying ultrasonic waves passing through the cleaning liquid L, as shown in FIG. 67, the cleaning liquid can be caused to penetrate to the bottom of the recess 14a adequately in a short time, and peeling of the toner particles 55 from the bottom of the recess 14a and that among particles are made easier by oscillation of the toner particles 55 in the liquid. Moreover, by forming an electric field between the transfer electrode 362 and the original plate 1 in this state, a portion of the toner particles 55 floating in the cleaning liquid L can be caused to flow to the liquid receiving tray 367 together with the cleaning liquid L.

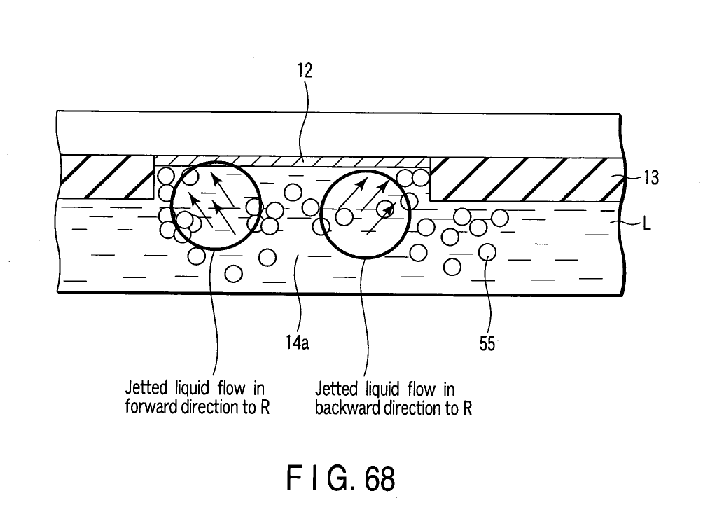

Further, the cleaning liquid L is blown against the toner particles 55 remaining on the surface of the original plate 1 via the blowing removal unit 353 arranged on the downstream side of the pretreatment unit 352 in the rotation direction R of the original plate 1 to do the cleaning of particularly the toner particles 55 adhering to the inside the recess 14a. At this point, as shown in FIG. 68, the blowing removal unit 353 blows high-pressure liquid in two directions (arrow directions in FIG. 68) against the toner particles 55 to do the cleaning by blowing off the toner particles 55 remaining at corners of the recess 14a. Accordingly, the toner particles 55 remaining in the recess 14a can be substantially completely removed from the original plate 1.

Incidentally, the toner particles 55 adsorbed once onto the transfer electrode 362 by the action of the electric field in the pretreatment unit 352 described above are washed away from the surface of the transfer electrode 362 by a liquid being continuously supplied from the liquid supply nozzle 351 in a state where the electric field is made to disappear (not shown). At this point, it is preferable to maintain the ultrasonic wave oscillation field formed to further enhance the cleaning effect.

In the present embodiment, the case 361 is made of SUS and the transfer electrode 362 is fixingly mounted on the case 361 via an SUS plate of thickness of 1 [mm] using an adhesive. The piezoelectric elements 363 are each an element constructed by housing a piezoelectric body inside a cylindrical case having the diameter of 45 [mm] and height of 60 [mm], arranged over the entire surface of the transfer electrode 362, and mounted fixingly on the case 361 via the adhesive layer 364.

In the present embodiment, the surface of the original plate 1 after passing through the blowing removal unit 353 will transition to the next process while a thin liquid film of the clean cleaning liquid L is formed thereon, but the transition to the removal process may occur after a liquid film is removed by passing through a drier (not shown). Also in the present embodiment, like the seventh and eighth embodiments described above, liquid film may be removed by bringing a liquid removal means such as a blade and suction sponge roller into contact with the surface of the original plate 1 after passing through the blowing removal unit 353.

In the cleaning apparatus 350 in the ninth embodiment, the tank of the pre-wet liquid L supplied via the liquid supply nozzle 351 and that of the cleaning liquid L supplied from the blowing removal unit 353 may be separate (not shown). That is, the pre-wet liquid L can reliably be removed in the blowing removal process by using a conductive cleaning liquid whose amount of added metallic soap is about 0.3% by weight as the pre-wet liquid L and a single insulating solvent as the cleaning liquid L of the blowing removal unit 353 and therefore, an influence on the next development process can be prevented.

Incidentally, the present invention is not limited to the above embodiments and components may be modified in an implementation stage without deviating from the spirit thereof. Moreover, a plurality of components disclosed in the above embodiments may appropriately be combined to form various inventions. For example, some components may be omitted from all components shown in the above embodiments. Further, components covering different embodiments may appropriately be combined.

For example, the present invention is not limited to a pattern formation apparatus using the original plate 1 on which a pattern is formed using the recess 14a in advance and is also applicable to an apparatus that forms an electrostatic latent image on the surface of a photosensitive material by known electrophotography and develops the image by a liquid developer for transfer.

In the above embodiments, a pattern formation apparatus is operated by positively charging developer particles, but the present invention is not limited to this and the apparatus may be operated by charging all components in opposite polarity.

Also in the above embodiments, the present invention is applied to an apparatus in which a phosphor layer or color filter is formed on the front substrate of a flat type image display apparatus, but the present invention can widely be used as a manufacturing apparatus in other technical fields.

For example, the present invention can be applied to an apparatus for forming conductive patterns on circuit substrates and IC tags by changing the composition of a liquid developer. In this case, if the liquid developer is composed of, for example, resin particles whose average particle diameter is 0.3 [μm], metallic particles (for example, copper, palladium, and silver) whose average particle diameter is 0.02 [μm] and adhering to the surface of resin particles, and a charge control agent such as metallic soap, wiring patterns by the developer can be formed, for example, on a silicon wafer by the technique similar to that described in the above embodiments. It is generally not easy to form circuit patterns having sufficient conductivity only by such a developer; it is preferable to apply a coating after pattern formation using the above metallic particles as a core. In this manner, patterning of a conductive circuit, capacitor, resistor, and the like can also be performed.

A pattern formation apparatus according to another embodiment of the present invention will be described below.

The pattern formation apparatus of the present embodiment has a waste liquid treatment unit for collecting, after performing development using toner containing an ionic compound and a liquid developer containing a carrier liquid, a waste liquid containing toner solid content, ionic compounds contained in the toner, and the carrier liquid before or after transcription and returning a recycled carrier liquid after removing the toner solid content and ionic compounds in the waste liquid to a development unit or cleaning unit for reuse.

In the pattern formation apparatus of the present embodiment, the waste liquid treatment unit has a strainer containing a conductive barrier structure having a gap of a size 30 to 100 μm in diameter, adsorbent particles whose particle diameter, which indicates the maximum frequency of particle diameter distribution, is 5 μm to 100 μm are applied to the surface of the barrier structure as a filter of the strainer to form an adsorbent particle layer of thickness of 0.5 mm to 10 mm, and while the waste liquid is passed through gaps between particles of the adsorbent particle layer to the barrier structure side, toner solid content is physically removed by filtration of gaps between adsorbent particles and ionic compounds are chemically removed by adsorbing action of adsorbent particles to recycle the carrier liquid.

The liquid developer used in the present invention is constituted by a carrier liquid containing toner solid content as fine particles and ionic compounds.

A petroleum-based highly-insulating solvent, for example, Isopar L manufactured by Exxon, can be used as a carrier liquid. Resin particles whose average particle diameter is about 0.05 μm to 1 μm and which are impregnated with, for example, a colorant and/or to which a colorant is affixed are used as toner solid content, and the resin includes, for example, a graft copolymer made of a backbone insoluble in a highly-insulating solvent and side chains soluble in a highly-insulating solvent.

One or two or more among inorganic pigments, organic pigments, and dyes can be used as the colorant. The proportion of toner solid content in a developer is adjusted to 0.5% by weight to 30% by weight.

Ionic compounds are added to adjust charging characteristics of toner solid content and include metallic salt such as naphthenic acid, octylic acid, and stearic acid, metal complex ethylenediaminetetraacetate, and zinc phosphate and one, two or more of these may be used. These ionic compounds are normally added excessively to toner solid content and a large portion thereof is chemically or physically adsorbed onto the surface of toner particles, but a portion thereof is contained in the carrier liquid. The amount of added ionic compounds is, for example, 5% by weight to 30% by weight with respect to the toner solid content.

Adsorbent particles used in the present invention exhibit charging characteristics in an insulating solvent. Adsorbent particles are dispersed in an insulating solvent in predetermined concentrations in advance to prepare an adsorbent particle dispersion liquid and conductivity is measured in this state. By flowing the adsorbent particle dispersion liquid following a flow channel inwardly from the surface of the barrier structure, adsorbent particles are deposited on the surface of the barrier structure to form an adsorbent particle layer. The barrier structure is formed from a conductive material and formation of the adsorbent particle layer can be performed more precisely and quickly by providing a predetermined potential to the barrier structure when adsorbent particles are deposited. If a waste liquid is caused to flow in this state, toner solid content physically clogs tiny gaps formed by adsorbent particles in the adsorbent particle layer deposited on the surface of the barrier structure when passing through the tiny gaps before being stuck and removed by the adsorbent particle layer and at the same time, ionic compounds are chemically adsorbed and removed by the adsorbing action of adsorbents.

Diatomaceous earth, zeolite, hydrotalcite, and carbon, for example, can be used as adsorbent particles used in the present invention. Since such adsorbent particles have a maximum frequency of particle diameter distribution in the range of 5 μm to 100 μm, a sufficient amount of liquid that passes through can be secured compared with the precipitation method by setting the thickness of sedimentary layer of adsorbent particles in the range of 0.5 mm to 10 mm, and because the surface area of adsorbent that comes into contact the waste liquid passes is large, an adsorption capability can be exhibited even if the amount of adsorbent to be used is small, so that the adsorption efficiency of adsorbent per unit weight can be improved.

If the maximum frequency of particle diameter distribution of adsorbent particles is less than 5 μm, adsorbent particles that are not held on the surface of the barrier structure and in gaps and pass through the strainer together with the waste liquid increase, showing a tendency to make a treated waste liquid inappropriate for reuse. If the maximum frequency of particle diameter distribution of adsorbent particles exceeds 100 μm, it becomes difficult to deposit adsorbent particles on the surface of the barrier structure precisely at high density, which means that a stable adsorbent sedimentary layer cannot be formed for liquid circulation and it also becomes difficult to remove toner solid content by physical filtration because gaps between adsorbent particles become large, showing a tendency to make a treated waste liquid inappropriate for reuse.

The particle diameter distribution here is, for example, measured values of numbers of particles and sizes measured by a Coulter counter, after replacing an electrolytic solution corresponding to the volume of particles when particles suspended in the electrolytic solution pass through an aperture tube having a predetermined diameter, based on changes in current flowing between electrodes set up on both sides of the aperture.

It is preferable that adsorbent particles having a particle diameter of 5 μm to 100 μm account for 80% or more of the distribution frequency of all particles.

If the thickness of the adsorbent particle layer is less than 0.5 mm, a narrow path of waste liquid formed by gaps between adsorbent particles is short and thus, it becomes difficult to remove toner solid content by physical filtration, and also the surface area of the adsorbent that comes into contact when the waste liquid passes is small, showing a tendency that the adsorption efficiency of the adsorbent declines sharply. If the thickness of the adsorbent particle layer exceeds 10 mm, a narrow path of waste liquid formed by gaps between adsorbent particles is long and thus, a high pressure is needed to cause the waste liquid to pass, showing a tendency of stagnant liquid circulation.

When replacing adsorbent particles, it becomes possible to separate the adsorbent easily from the surface of the barrier structure and peel off the adsorbent particle layer by flowing an insulating solvent in an opposite direction from inside the barrier structure. By taking out peeled-off adsorbent particles separately from an output port and introducing a new adsorbent, the adsorption capability of the waste liquid treatment unit can easily be maintained.

When a system containing particles having the particle diameter of 1 μm or more, particles having the particle diameter of less than 1 μm, and ionic compounds particularly as a liquid developer is treated, a waste liquid treatment unit having a plurality of treatment cisterns can be used. Particles having the particle diameter of 1 μm or more can be removed in a first cistern and particles having the particle diameter of 1 μm or less and ionic compounds in second and following cisterns. This is a pattern formation apparatus having a waste liquid treatment unit in an embodiment in which when the amount of treatment liquid in the first cistern reaches a certain amount, the second and following cisterns are operated, the second cistern, which is a treatment cistern of particles having the particle diameter of 1 μm or less or ionic compounds, has an input port and output port of the adsorbent and a barrier structure having gaps of 30 to 100 μm, which are a support material of the adsorbent, and the second cistern forms a circulating system independent of the main body of the apparatus when needed in a recycling treatment process of waste liquid to return the liquid to the main body of the apparatus after a waste liquid treatment process is completed. Particles of 1 μm or more are more likely to deposit and thus are caused to deposit in the first cistern and, for example, by extracting a supernatant liquid or deposits thereof, such particles can sufficiently be separated and removed. By removing particles of 1 μm or less and ionic compounds in the second and following cisterns from a waste liquid after particles of 1 μm or less are removed in the first cistern, the adsorption efficiency of adsorbent can be maintained at an adequate level.

Further, when conductivity of a solution in which an adsorbent to whose surface toner solid content and ionic compounds are caused to adhere is dispersed in predetermined concentrations is measured after the waste liquid treatment process, a lower value of conductivity than that of a solution in which the initial adsorbent itself is dispersed in predetermined concentrations is experimentally obtained. Thus, conductivity is measured in advance in a state where the adsorbent is dispersed in an insulating solvent used as a carrier liquid in predetermined concentrations and after the waste liquid treatment process, the adsorbent is peeled off the surface of the barrier structure and a monitor liquid dispersed in predetermined concentrations is extracted to measure conductivity. If the measured value is a value above a certain value, the adsorbent is considered not to be saturated to its limit and the surface of the barrier structure is again coated with the adsorbent to continue waste liquid treatment. If the measured conductivity is a value below a certain value, the adsorbent is considered to be in a state of near saturation after adsorbing sufficient toner solid content and ionic compounds and thus, by taking the adsorbent out of the unit through the output port and introducing a new adsorbent, recycling of the waste liquid treatment unit continuously is made easier.

According to the present invention, the surface area of the adsorbent that comes into contact when a waste liquid passes through a narrow path formed by the adsorbent is large and thus, the adsorption efficiency of the adsorbent can be improved. Moreover, a carrier liquid can be recycled by simply passing the carrier liquid through a strainer to remove ionic compounds and toner solid content simultaneously, and thus the treatment capability per unit time is excellent. Further, a stirring mechanism is unnecessary for an adsorbent more likely to deposit and the replacement time of an adsorbent can advantageously be detected by a simple method by which the conductivity of a solution in which the adsorbent is dispersed in predetermined concentrations is monitored.

The present invention will be described concretely below with reference to drawings.

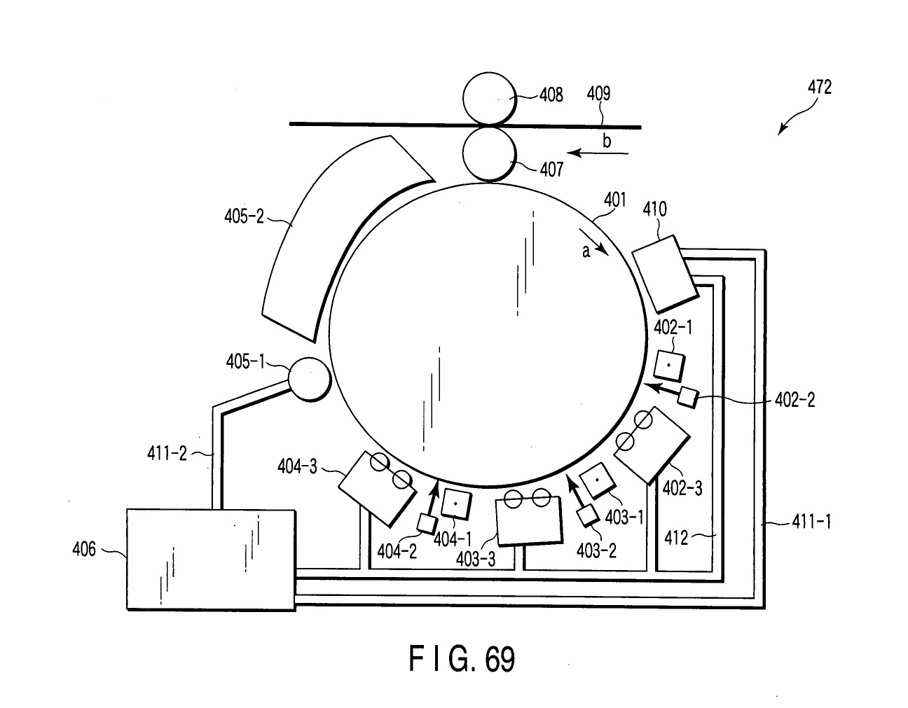

FIG. 69 shows a schematic representation showing an outline of an exemplary pattern formation apparatus according to another embodiment of the present invention.

As shown in FIG. 69, a pattern formation apparatus 472 includes a photosensitive material drum 401 on which a fine pattern is formed, a pattern formation part having a development unit provided opposite to the photosensitive material drum 401 to develop a toner image using a liquid developer, a drying unit for removing any excessive developer of the toner image formed on the photosensitive material drum, a transfer unit for transferring the toner image to a transfer medium, and a pattern formation part having a cleaning unit for cleaning the surface of the photosensitive material drum 1, and a waste liquid treatment mechanism 406 for treating a waste liquid discharged from the fine pattern formation part for recycling.

The development unit has chargers 402-1, 403-2, and 404-1, laser light filters 402-2, 403-2, and 404-2, and developing machines 402-3, 403-3, and 404-3.

The drying unit has a drying hood 405-2.

The transfer unit has a primary transfer roller 407 rotatable in contact with the photosensitive material and a secondary transfer roller 408 rotatable synchronously while being pressed against the primary transfer roller 407 via a transfer medium 409.

The cleaning unit has a cleaner 410.

Next, the formation process of a toner image will be described below.

The photosensitive material drum 401 has, for example, an organic or amorphous silicon photosensitive layer.

After charging the surface of the photosensitive material drum 401 by the charger 402-1, a latent image is selectively formed in accordance with pattern information of the first color by the laser light filter 402-2 in the development unit and an electrostatic latent image is developed by a liquid developer of the first color supplied by the developing machine 402-3.

The liquid developer to be used includes, for example, Isopar L, manufactured by Exxon, as a carrier liquid, resin particles whose average particle diameter is about 0.05 μm to 1 μm and which are impregnated with a colorant and/or to which a colorant is affixed as toner solid content, and naphthenate as ionic compounds.

A graft copolymer made of a backbone insoluble in a highly-insulating solvent and side chains soluble in a highly-insulating solvent can be used as a resin.

Patterns of the second and third colors are developed in the same manner by the chargers 403-1 and 404-1, the laser light filters 403-2 and 404-2, and the developing machines 402-3, 403-3, and 404-3 respectively. The toner image formed on the photosensitive material drum 401 contains an excess of developer, and 85% or more of the excess liquid is suction-removed in the subsequent drying unit by a solvent collection roller 405-1 in which a continuous cell sponge layer is formed around a hollow shaft having a through hole provided therein to suction-remove the excessive developer from inside the hollow shaft. Then, the remaining developer is removed by a high-speed wind of 80 m/s blown from a slit nozzle under the drying hood 405-2 for transition to the next transfer process in a state where the toner solid content accounts for 90% or more.

In the transfer process, a primary transcription onto the primary transfer roller 407 is made by pressure heating while the silicon rubber layer is maintained at 100° C. by putting a heater into the primary transfer roller 407 made of a hollow silicon rubber roller. Further, a transcription is made onto the paper 409, which is a recording medium, via the secondary transfer roller 408. The photosensitive material drum 401, after undergoing the transfer process, moves to the cleaning process, in which remaining toner after the transcription is collected together with the cleaning liquid by a cleaner 410 constituted by a cleaning liquid supply nozzle, a sponge, and a blade.

The excess developer suction-removed by the solvent collection roller 405-1 and a cleaning liquid containing toner particles collected by the cleaner 410 are also discharged from the pattern formation apparatus as waste liquid. Both of these liquids contain toner particles of 1 μm or less and an ionic compound naphthenate, so-called metallic soap. These waste liquids are connected to the cleaner 410 and from here, connected to a waste liquid collection line 411-1 for extracting a waste liquid and the solvent collection roller 405-1 and from here, sent to the waste liquid treatment mechanism 406 via a waste liquid collection line 411-2 for extracting a waste liquid. Here, the waste liquid is recycled to a carrier liquid by removing toner solid content and metallic soap content. The recycled carrier liquid is returned, for example, to the developing machines 402-3, 403-3, and 404-3 or the cleaner 410 for reuse via recycled liquid supply line 412.

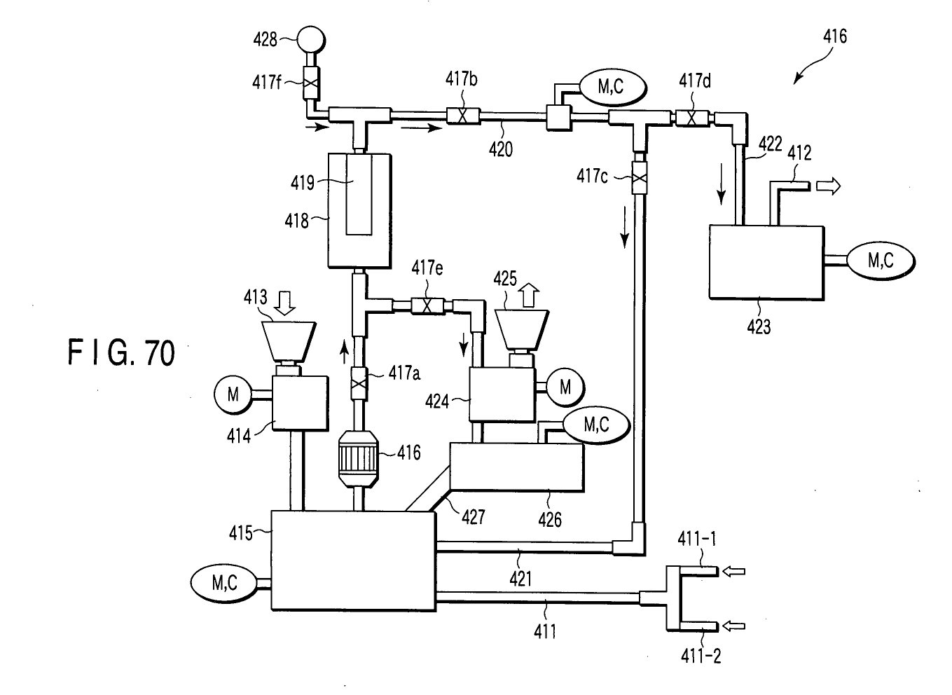

FIG. 70 shows a schematic representation illustrating the configuration of an exemplary waste liquid treatment mechanism applied to a pattern formation apparatus according to the present invention.

In the waste liquid treatment mechanism 406, as shown in FIG. 70, a waste liquid collected through the waste liquid collection lines 411-1/411-2 and a waste liquid collection line 411 is gathered in a waste liquid tank 415. Kyowado 2000, manufactured by Kyowa Chemical Industry, which is a hydrotalcite based adsorbent particle having the maximum frequency of particle diameter distribution in the range of 5 μm to 100 μm, can be used as adsorbent particles that can remove toner solid content and metallic soap content at the same time. 80 g of Kyowado 2000 is introduced through an adsorbent input port 413 and dispersed in Isopar L of 10% by weight in an initial conductivity measuring tank 414. Measurement of conductivity in this state yielded 3 pS/cm. This dispersion liquid is added to the waste liquid tank 415, a valve 417a is opened, and the dispersion liquid is pumped up into a strainer 418 by a pump 416 together with a waste liquid. The strainer 418 has a filter 419 therein, and after passing through the filter 419, the waste liquid passes through a circulation path via a filtrate circulation line 420 and a second filtrate circulation line 421 after opening valves 417b/417c while a valve 417d is closed before returning once to the waste liquid tank 415. Here, M in FIG. 70 means a conductivity meter and C a toner particle densitometer.

In the foregoing description, the dispersion liquid is added to the waste liquid tank 415 and pumped up together with a waste liquid by the pump 416 into the strainer 418 to form an adsorbent particle layer on the surface of the filter 419, but according to circumstances, a method may be applied in which an adsorbent particle layer is formed on the surface of the filter 419 by directly pumping up a dispersion liquid from the initial conductivity measuring tank 414 into the strainer 418 through a bypass (not shown) that does not pass through the waste liquid tank 415. If the initial conductivity measuring tank 414 has a stirrer provided therein, conductivity of the dispersion liquid can be measured correctly and at the same time, the adsorbent can be dispersed in uniform concentrations for a sufficiently long time. It is needless to say that the efficiency is improved when the dispersion liquid is directly pumped up into the strainer 418 through a bypass.

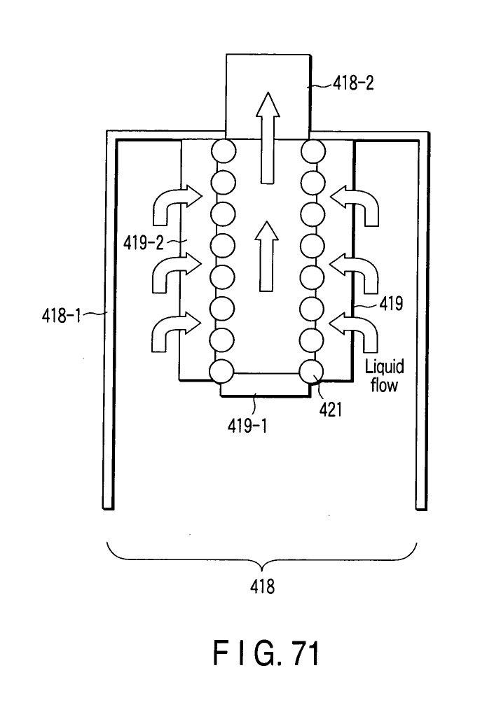

FIG. 71 is a schematic representation showing the configuration of an exemplary filter used for the waste liquid treatment mechanism.

The configuration of the strainer 418 has a conductive barrier structure 419-1 having gaps of 30 μm to 90 μm inside a filter housing vessel 418-1. In this example, a coil spring having a diameter of 15 mm, length of 250 mm, and a barrier structure gap 419-4 of 90 μm manufactured, for example, by Ergotech is used as a barrier structure 419-2.

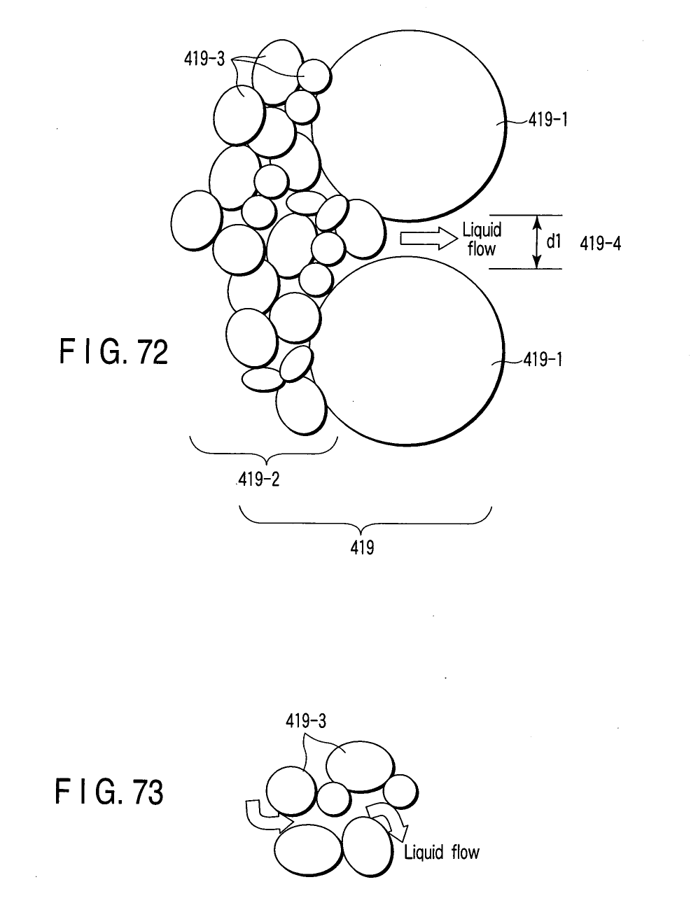

FIG. 72 shows an enlarged view of a portion of the barrier structure in FIG. 71.

If a waste liquid to which a liquid in which adsorbent particles are dispersed is added is caused to circulate at a suction pump 416 pressure of 2 kgf and flow rate of 6 liters/min, as shown in FIG. 72, adsorbent particles 419-3 adhere to gaps 419-4 of 90 μm by being deposited there when the waste liquid passes through the strainer 418 in a first circulation path to form the adsorbent particle layer 419-2 of thickness of 8 mm on the surface of the coil spring 419-1.

FIG. 73 shows a diagram illustrating an exemplary operation in the adsorbent particle layer in FIG. 72.

As shown in FIG. 73, toner solid content (not shown) in the waste liquid physically causes clogging when passing through tiny gaps formed by the adsorbent particles 419-3 inside the adsorbent particle layer 419-2 formed on the surface of the coil spring 419-1 so that the toner solid content is adhesion-removed by the adsorbent particle layer 419-2. Ionic compounds, which form the metallic soap content, are chemically adsorption-removed by the adsorbing action of the adsorbent particles 419-3. By circulating the waste liquid several times through the circulation path in accordance with the amount of toner particles and metallic soap contained in the waste liquid, the toner solid content and metallic soap content can almost completely be removed.

As an experimental example, the amount of metallic soap that can be removed by an adsorbent when Kyowado 2000 is used as the adsorbent was examined.

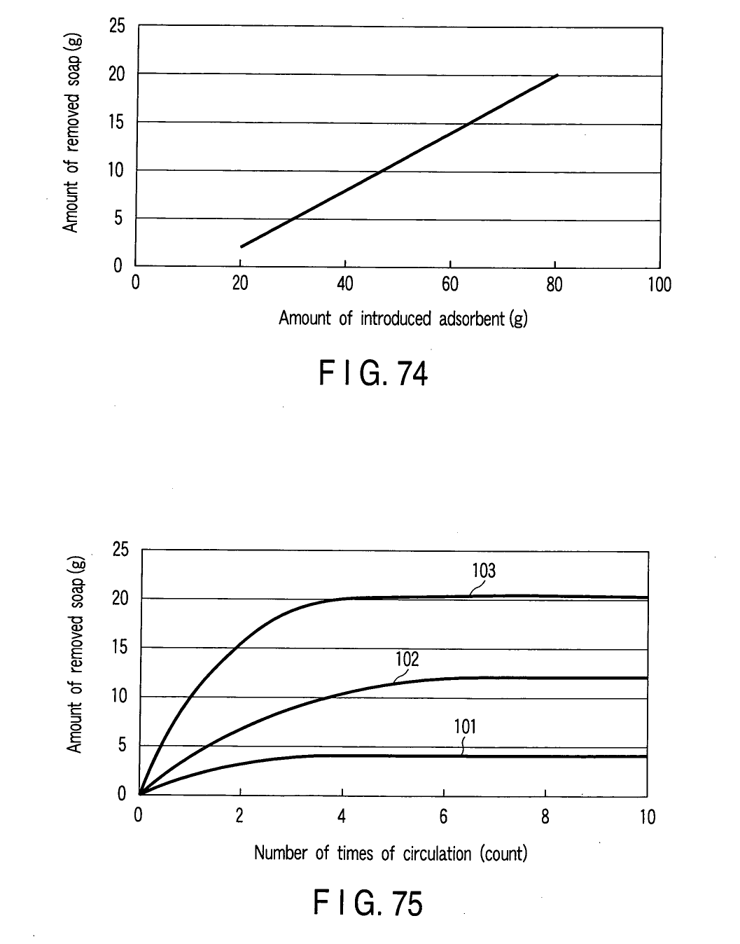

FIG. 74 is a graph diagram showing a relationship between the amount of introduced adsorbent and that of removed metallic soap.

Adsorbents of various kinds of weight were each introduced into 500 ml of Isopar L solution of several kinds of metallic soap concentrations and after the passage of a long time during which the liquid was stirred, concentrations of metallic soap remaining in the liquid were examined. These results are shown in various graphs. The concentration of metallic soap is proportional to the conductivity of liquid and thus, by creating a conversion graph between metallic soap concentration and conductivity in advance, metallic soap content in the liquid can be determined by measuring the conductivity of the liquid. To measure the conductivity of the liquid, stirring is stopped, and after waiting for a time long enough for the adsorbent to deposit on the bottom of the experimental cistern, a supernatant liquid is extracted to measure the conductivity. Data in FIG. 74 confirms that the conductivity does not change for a long period of time with respect to the introduced weight of each sample by stirring liquids into which adsorbents were introduced for a month or longer and shows values near the saturated weight.

Next, based on data in FIG. 74, a relationship between the number of times of circulation when Kyowado 2000 is used as the adsorbent and the amount of removed metallic soap is explained.

FIG. 75 shows a graph diagram showing a relationship between the number of times of circulation in the waste liquid treatment unit and the amount of removed metallic soap.

Adsorbents of weight of 20 g, 50 g, and 80 g were each added to 500 ml of Isopar L solution and each solution was caused to circulate inside a waste liquid treatment unit 16.

When 80 g of adsorbent is introduced, almost all metallic soap content contained in the waste liquid was removed after the waste liquid was circulated four times. When 18 liters of waste liquid containing 20 g of metallic soap was used, the time required for four times of circulation was only 12 min. By using the waste liquid treatment unit, the recycling treatment is completed in an extremely short time because metallic soap content is removed to almost the limit of the adsorption capability of the adsorbent.

The adsorbent to be used shows slight conductivity in Isopar L. Measurement of conductivity in which Kyowado 2000 was used as the adsorbent after preparing a liquid in which only the adsorbent was dispersed in Isopar L in concentrations of 10% by weight yielded 3 pS/cm.

It was evident from data in FIG. 75 that 80 g of adsorbent adsorption-removed about 20 g of metallic soap before adsorbing metallic soap content becoming saturated. The conductivity of the Isopar L dispersion liquid in concentrations of 10% by weight of the adsorbent that had adsorbed the metallic soap content almost completely dropped to 0.3 pS/cm. By defining the state in which 80 g of adsorbent adsorbs 20g of metallic soap content as 100% of saturation, a relationship between the adsorption amount up to 20 g and conductivity.

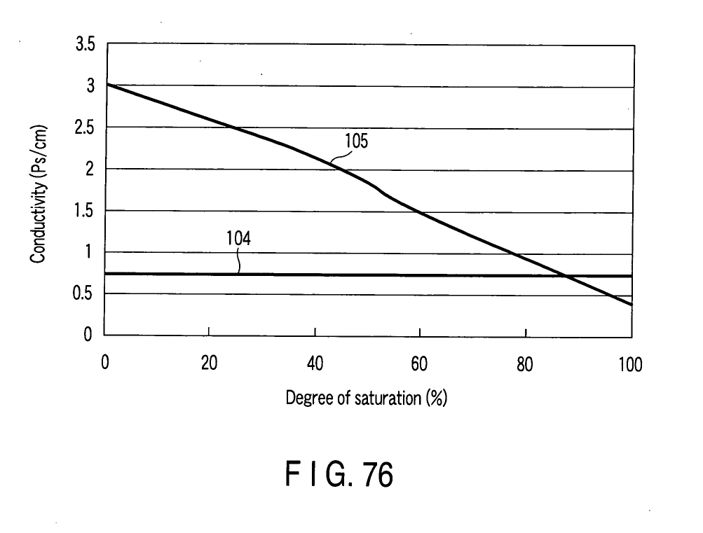

FIG. 76 shows a graph diagram showing a relationship between saturation of adsorbent particles and conductivity of a waste liquid.

The graph shows that in an Isopar L solution in which the adsorbent is dispersed in concentrations of 10% by weight, 0.75 pS/cm is standard conductivity and the adsorption capability is near the limit when nearly 90% of soap content is adsorbed. Using this data, a method of detecting a standard time for replacing the adsorbent will be described below.

The conductivity of the adsorbent was measured in a state of 10% by weight by adding Isopar L in the initial conductivity measuring tank for initial introduction. The conductivity of the initial adsorbent alone was 3 pS/cm.

The waste liquid collected from the waste liquid collection line 411 contains toner particles and metallic soap content. When the conductivity and concentration of the toner solid content in the waste liquid tank 415 were measured, the conductivity was 80 pS/cm and the concentration of solid content was 2% by weight. The waste liquid, and the above Isopar L dispersion liquid in a concentration of 10% by weight of the initial adsorbent, were added and circulated in the first circulation path at the flow rate of 6 liters/min four times, and then the circulation of the liquid was stopped to measure the conductivity and concentration of toner solid content by a monitor set up on the filtrate circulation line 420. At this time, the conductivity was 0.03 pS/cm, which is the conductivity of pure Isopar L, and the solid content concentration was below a threshold value of detection. Then, the valve 417c was closed and the valve 417d was opened before allowing the filtrate to flow into a reuse tank 423 via a recycled liquid line 422. A recycled liquid is supplied when needed from the reuse tank 423 to the development unit and the cleaning unit via a recycled liquid supply line 412.

Also at this point, a portion of the filtrate was left, the valve 417a and the valve 417b were closed and valves 417e/f were opened to supply high-pressure air to the strainer from a high-pressure air supply valve 428 to peel off the adsorbent from the surface of the coil spring 419-1, and the adsorbent was put into a post-filtration conductivity measuring tank 424 and the liquid was put into a temporary storage tank 426 to temporarily separate the adsorbent and filtrate. Isopar L was added to the post-filtration conductivity measuring tank 424 containing the adsorbent to prepare a dispersion liquid in a concentration of 10% by weight of the adsorbent and measurement of conductivity in this state resulted in 0.55 pS/cm, a drop in conductivity.

From experimental results shown in FIG. 76, conductivity in a concentration of 10% by weight of the adsorbent is 0.75 pS/cm or less, which is a standard value for replacement of the adsorbent, and thus, the adsorption of 80 g of adsorbent introduced this time was considered to be near saturation so that all adsorbents introduced were taken out from an output port 425.

A waste liquid was collected from the waste liquid collection line 411 into the waste liquid tank 415, a new adsorbent was added through the input port 413, initial conductivity was measured in a predetermined concentration in Isopar L, and then a waste liquid was added to the waste liquid tank 415 and a similar waste liquid treatment was again carried out.

The adsorbent was discarded in the above experimental example because measurement of conductivity of the used adsorbent dispersion liquid resulted in conductivity below a standard value for replacement, but if the resultant conductivity is equal to or greater than a predetermined value, the adsorbent is considered still to have sufficient adsorption capability and is returned to the waste liquid tank 415 via a bypass line 427, pumped up again together with the waste liquid to be adhered to the surface of the barrier structure 419-1 by being deposited to form the adsorbent particle layer 419-2, allowing to continue the waste liquid recycling treatment.

In the above experimental example, the coil spring 419-1 is used as a barrier structure, but a barrier structure of other shapes may also be used.

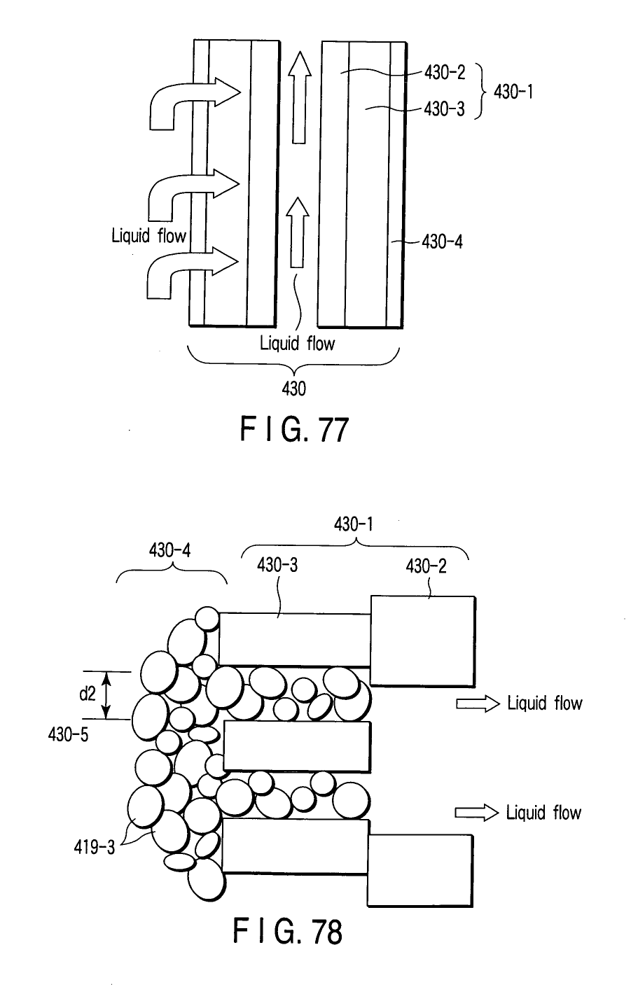

FIG. 77 shows a schematic representation showing the configuration of another exemplary barrier structure used for the strainer in the waste liquid treatment mechanism.

FIG. 78 shows a partially enlarged view of the barrier structure in FIG. 77.

As another example of the barrier structure, for example, a barrier structure 430-1 having a structure formed by a urethane continuous cell sponge 430-3 having cells of 30 μm to 100 μm in diameter to a thickness of 3 mm around a hollow shaft 430-2 having an outside diameter of 10 mm and an inside diameter of 8 mm with a plurality of through holes of 0.5 mm in diameter provided on the side thereof is shown. In this case, an adsorbent particle layer 430-4 can be formed on the surface of the sponge to a thickness of 0.5 to 2 mm.

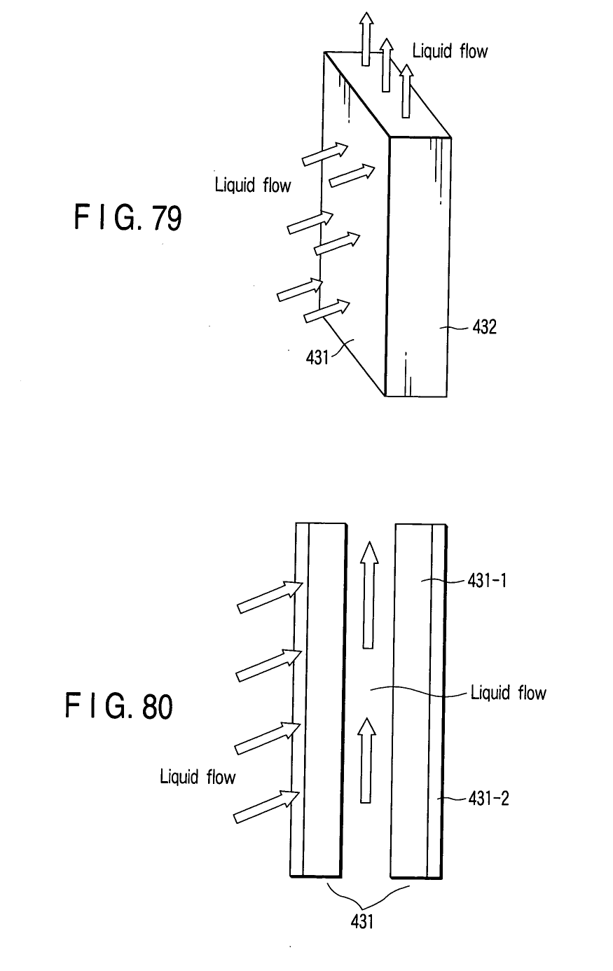

FIG. 79 shows a schematic representation showing the configuration of another exemplary barrier structure used for the strainer in the waste liquid treatment mechanism.

FIG. 80 is a schematic representation showing a sectional view of the barrier structure in FIG. 79.

The barrier structure may have a structure in which, like a box-shaped one shown in FIG. 79, a side 431 has a filter function and a constant distance is maintained by a support medium provided between ends of a pair of filters 431-1/431-1 facing each other to allow a liquid flow through a main surface of the filter 431. In this case, the barrier structure 431-1 constituting the filter 431 is a stainless plate of thickness of 3 mm in which through holes from the front side to the rear side are provided, and has an adsorbent particle layer 431-2 formed on the front side.

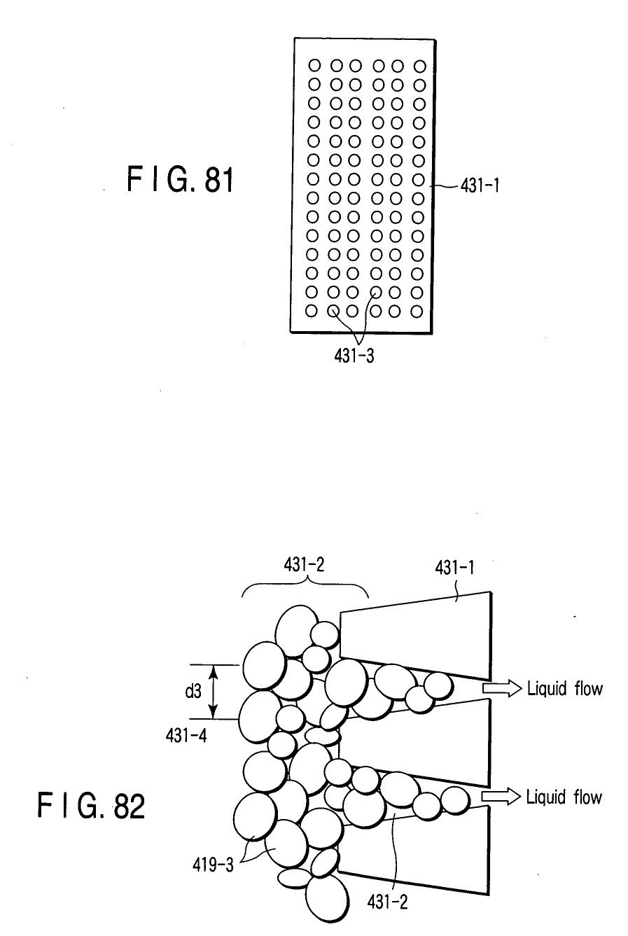

FIG. 81 is a diagram showing the configuration of a stainless plate used as the filter 431-1.

The stainless plate 431-1 has, as shown in FIG. 81, through holes whose opening diameter changes continuously, which are formed by an etching treatment from the front side by, for example, a ferric chloride etchant.

FIG. 82 shows a schematic representation showing the state of a cross section of a barrier structure gap in FIG. 81.

The average opening diameter d3 on the front side as a barrier structure gap 431-4 was in the range of 60 μm to 80 μm and that on the rear side was in the range of 30 μm to 40 μm. In each of the configurations of a hollow shaft and a continuous cell sponge and that of the stainless plate provided with through holes 413-2 described above, the hydrotalcite adsorbent particle layer 431-2 having the maximum frequency of particle diameter distribution in the range of particle diameter 5 μm to 100 μm is held on the surface thereof, and, as a result of performing a recycling process of waste liquid, a waste liquid recycling treatment that is effective in removing toner solid content and ionic compounds and maximally utilizing the adsorption capability of the adsorbent in a short time is achieved for both configurations.

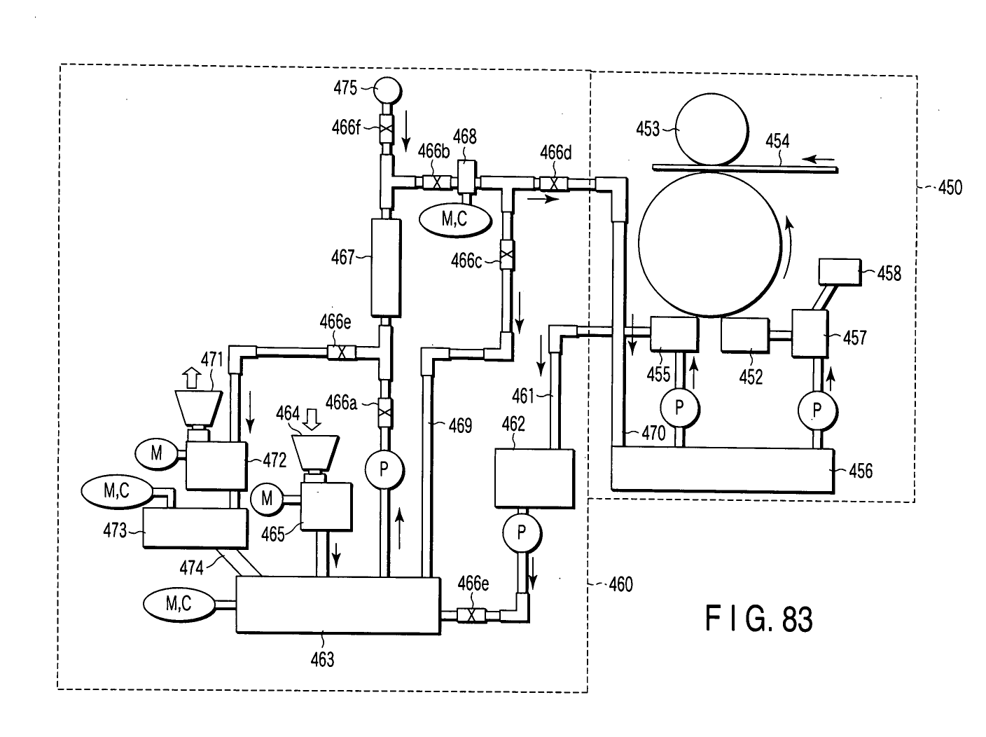

FIG. 83 is a schematic representation showing the outline of an exemplary pattern formation apparatus according to a further embodiment of the present invention.

A pattern formation apparatus 471 is divided into a pattern formation unit 450 in which a fine pattern is formed and a waste liquid treatment unit 460 that performs recycling treatment of waste liquid.

The pattern formation unit 450 has an intaglio drum 451, a development unit 452 for forming a particle layer on the intaglio drum 451, a backup roller 453 for transferring the fine pattern at a position to make the intaglio drum 451 opposite to a recording medium 454, and a cleaner 455 for removing developer particles remaining on the surface of the intaglio drum 451 after transcription.

The development unit 452 includes a charger (not shown) for charging the surface of the intaglio drum 451. The cleaner 455 is a mechanism that sucks up Isopar L, which is a carrier liquid, from a carrier liquid tank 456 to supply Isopar L to the surface of the intaglio drum 451 via a nozzle and collects a waste liquid and remaining developer simultaneously by a suction sponge roller (not shown). The collected waste liquid is collected to the waste liquid treatment unit 460 via a waste liquid collection line 461.

New Isopar L and a recycled liquid sent from the waste liquid treatment unit 460 through a recycled liquid supply line 470 are mixed in the carrier liquid tank 456 before being supplied to the cleaner 455 and also to a developer tank 457, where a high-concentration developer liquid supplied from a conc developer liquid tank 458 is mixed before being used by the development unit 452 as a developer liquid in a predetermined concentration.

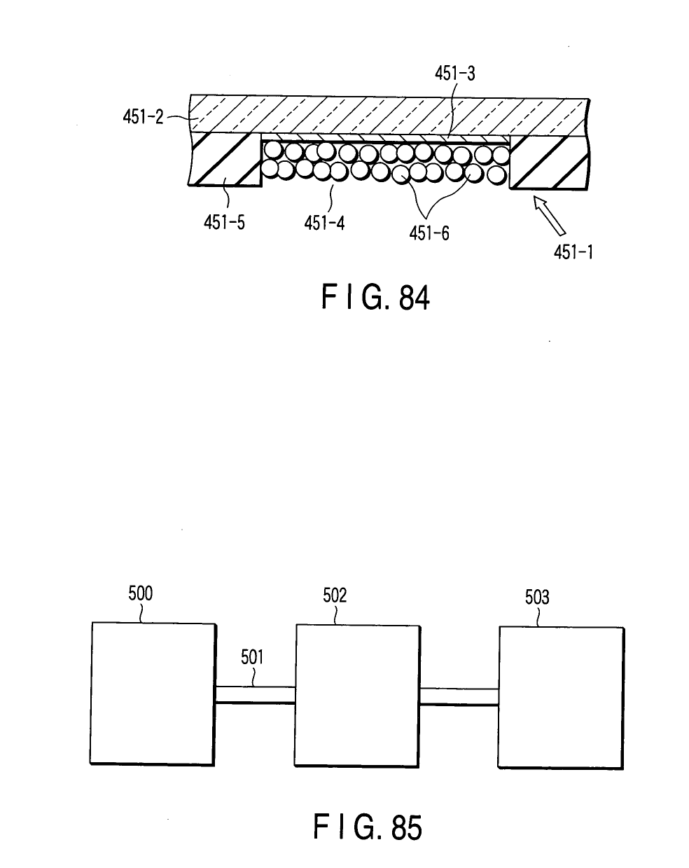

FIG. 84 shows a diagram illustrating the configuration of an intaglio drum used for the pattern formation apparatus in FIG. 83.

As shown in FIG. 84, the configuration of the intaglio drum 451 has, on a drum surface 451-1, an insulating electrode supporter 451-2 made of a resin material such as polyimide, PET, or PEN, a glass material or the like having a thickness of about 20 μm to 50 μm, fine pattern formation electrodes 451-3 formed thereon, a common electrode (not shown) provided on the rear surface of the electrode supporter 451-2, and a high-resistance layer 451-5 for forming a recess pattern 451-4 by the fine pattern formation electrodes 451-3.

The common electrode is constituted by a conductive material such as aluminum or stainless and has a thickness of about 100 μm to 3000 μm.

The high-resistance layer 451-5 is formed from a material (including an insulator) whose volume resistivity is 1010 Ωcm, such as polyimide, acrylics, polyester, urethane, epoxy, Teflon (registered trademark), or nylon, and has a thickness of 10 μm to 30 μm.

A predetermined power is supplied to each of the fine pattern formation electrodes 451-3 from a power unit (not shown) through a wiring electrode (not shown) and each electrode group is electrically independent so that a different voltage can be supplied to each electrode group.

The development unit 452 has, for example, first and third developer supply parts (not shown) and first and third excess liquid removal parts (not shown) and a developer is thereby supplied to the intaglio surface 451-1. A particle containing liquid supply roller constituting the developer supply part is arranged opposite to the high-resistance layer 451-5 on the intaglio drum 451 with a gap of about 100 to 200 μm and the excess liquid removal roller constituting the excess liquid removal part is positioned opposite to the high-resistance layer 451-5 with a gap of about 30 to 60 μm.

The developer has a constitution in which toner particles 451-6 including coloring materials such as pigments and dyes, and functional materials such as fluorescent materials are dispersed in an insulating solvent and the toner particles 451-6 are charged in the insulating solvent. The charger is, for example, a scorotron charger and is provided with a gap of about 1 to 2 mm from the surface of the intaglio drum 451. A scorotron charger having no grid electrode and an ion generator that does not use a wire can also be used.

After only the surface of the high-resistance layer 451-5 is charged, for example, at about +400 V by the charger of the development unit 452, the intaglio drum 451 receives a supply of developer and forms a toner layer of the toner particles 451-6 on the fine pattern formation electrodes 451-3 inside the desired recess pattern 451-4. Next in the transfer process, a development layer of the toner particles 451-6 arranged at a position opposite to the transfer medium 454 and formed on the fine pattern formation electrodes 451-3 inside the desired recess pattern 451-4 of the intaglio drum 451 is transferred to the transfer medium 454 to form a pattern of toner particles on the transfer medium 454 by bringing the rear surface of the intaglio drum 451 into close contact with the transfer medium 454 having a conductive material layer, or causing the rear surface of the intaglio drum 451 and the transfer medium 454 to face each other with a gap of about 30 to 400 μm, and applying a bias voltage of +100 V to the fine pattern formation electrodes 451-3 and that of −10 kV to the conductive material layer.

After the transfer process, the intaglio drum 451 proceeds to the process of removal of toner particles remaining on the recess pattern 451-4. The cleaner 455 supplies a carrier liquid as a cleaning liquid to the intaglio drum surface 451-1 from a two-fluid nozzle (not shown) serving as a cleaning liquid supply member at a liquid pressure 0.5 MPa and air pressure 0.5 MPa. The toner particles 451-6 remaining inside the recess pattern 451-4 are peeled off the surface of the intaglio by an outburst pressure of the cleaning liquid and are in a liberated state in the cleaning liquid.

By bringing a suction sponge roller into contact with the toner particles 451-6, liberated particles can be suction-removed together with the cleaning liquid. The suction sponge roller used in the cleaner 455 has a hollow pipe having a plurality of through holes and a urethane sponge layer (JIS-C hardness: 30) having continuous cells with an average cell diameter of 70 μm formed to a thickness of 7 mm thereon. The hollow pipe is connected to a suction pump, and the cleaning liquid and toner particles are removed from the intaglio surface 451-1 via continuous cells of the sponge layer and the hollow pipe before being sent to the waste liquid treatment unit 460 via the waste liquid collection line 461.

The intaglio drum 451 after the removal process of toner particles undergoes the drying process and a discharge process to be discharged to proceed to the next pattern formation operation.

The toner solid content in a collected waste liquid mainly comprises three types: a toner resin base material and coloring material whose average particle diameter is 1 μm or less, a fluorescent material whose average particle diameter is 4 to 6 μm, and metallic soap. In the waste liquid treatment unit 460, a waste liquid is first stored in a first treatment cistern 462 to allow the fluorescent material particles of 1 μm or more, which have a large particle diameter and are more likely to deposit, to deposit. When the waste liquid reaches a predetermined amount of storage and precipitation of the fluorescent material is completed, a valve 466e is opened to send the waste liquid to a second treatment cistern 463. The fluorescent material deposited at the bottom of the first treatment cistern 462 can be taken out and discarded.

The waste liquid sent to the second treatment cistern 463 contains toner resin base materials and coloring materials whose average particle diameter is 1 μm or less, and metallic soap. When the conductivity and toner solid content concentration were measured in the second treatment cistern 463, the conductivity was 160 pS/cm and the solid content concentration was 2% by weight. As adsorbent particles, 80 g of Kyowado 200 manufactured by Kyowa Chemical Industry having the maximum frequency of particle diameter distribution in the range of particle diameter 5 μm to 100 μm was used. The adsorbent was introduced through an input port 464 and conductivity was measured in a state where the adsorbent was dispersed in a concentration of 10% by weight in Isopar L in an initial conductivity measuring cistern 465 to obtain a value of 3 pS/cm. This dispersion liquid was added to the second treatment cistern 463 and a valve 466a was opened to pump up the dispersion liquid to a strainer 467 by a pump. The strainer 467 has an internal barrier structure having a configuration similar to that shown in FIG. 71 and adsorbent particles are adhered to gaps of 60 μm between coil springs by being deposited there to form an adsorbent particle layer of thickness of 3 mm on the surface of the coil spring.

After passing through the strainer 467, the waste liquid once returns to the second treatment cistern 463 via a circulation path passing through a filtrate circulation line 468 and a second filtrate circulation line 469 after opening valves 466b/c while a valve 466d is closed.

After the waste liquid was circulated four times in the circulation path at the flow rate of 6 liters/min, the circulation of the liquid was once stopped and the conductivity and concentration of toner solid content were measured by a monitor set up on the filtrate circulation line 468. At this time, the conductivity was 20 pS/cm and the concentration of solid content was 0.8% by weight, which indicates a level that does not allow reuse. Thus, the filtrate was returned to the second treatment cistern 463 again.

Also at this point, a portion of the filtrate was left in the strainer 467, the valve 466a and the valve 466b were closed, and the valve 466e and a valve 466f were opened to supply high-pressure air to the strainer 467 from a high-pressure air supply valve 475 to peel off adsorbent particles from the surface of the coil spring, and adsorbent particles were put into a post-filtration conductivity measuring tank 472 and the liquid was put into a temporary storage tank 473 to temporarily separate the adsorbent and filtrate. Isopar L was added to the post-filtration conductivity measuring tank 472 containing the adsorbent to prepare a dispersion liquid in a concentration of 10% by weight of the adsorbent, and measurement of conductivity in this state resulted in 0.70 pS/cm, a drop in conductivity. Since the conductivity at a concentration of 10% by weight of the adsorbent was 0.75 pS/cm or less, which is the standard value for replacement of the adsorbent, the adsorption of 80 g of adsorbent introduced this time was considered to be near saturation so that all adsorbents introduced were taken out from an output port 471.

80 g of adsorbent was newly added through the input port 464 and the initial conductivity was measured in a concentration of 10% by weight in Isopar L and then, the liquid was added to the second treatment cistern 463. This mixed liquid was pumped up and a waste liquid treatment was performed in the circulation path at the flow rate of 6 liters/min, according to a similar procedure. After causing the liquid to circulate four times, the circulation of the liquid was once stopped and the conductivity and concentration of toner solid content were measured by the monitor set up on the filtrate circulation line 468. At this time, the conductivity was 0.03 pS/cm, which is the conductivity of pure Isopar L, and the solid content concentration was below a threshold value of detection. Then, the valve 466c was closed and the valve 466d was opened to put the filtrate into the carrier liquid tank 456 via the recycled liquid line 470. A carrier liquid is supplied when needed from the carrier liquid tank 456 to the developer liquid tank 457 and the cleaner 455.

Next, a further embodiment of the present invention will be described using FIGS. 85 to 89.

FIG. 85 is a diagram schematically showing a wiring substrate manufacturing apparatus according to the present invention.

A detailed description will be given below.

As a pattern formation apparatus, the wiring substrate manufacturing apparatus in FIG. 85 transports a substrate on which a fine pattern is formed using an apparatus 500 of the configuration shown in FIG. 69 to a surface treatment apparatus 502 via a transport system 501. After the surface of the substrate is treated, the substrate is transported to a nonelectrolytic plating apparatus 503 via the transport system 501 to manufacture a finely wired substrate by selectively forming a conductive layer on the fine pattern.

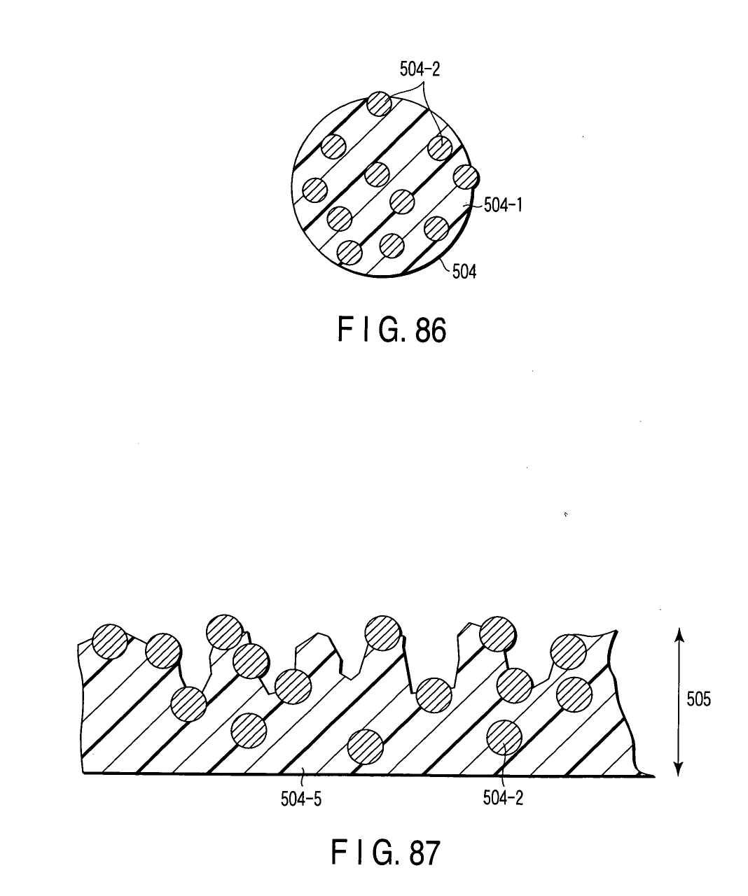

FIG. 86 is a diagram schematically showing the constitution of a liquid developer usable in the present invention.

In the liquid developer, as shown in FIG. 86, resin particles 504-1 whose average particle diameter is about 0.05 μm to 1 μm, to which metallic particles 504-2 in the range of particle diameters 5 nm to 100 nm serving as plating cores are attached instead of a colorant were used as toner solid content 504. The resin particles 504-1 have metallic soap (not shown) attached to the surface thereof. Using the developer, a fine pattern 505 with a line width of 20 μm and an interline space of 20 μm was formed on a polyimide substrate 506-1 in the pattern formation apparatus 500. The substrate 506-1 was transported to the surface treatment apparatus 502 by the transport system 501 and was inserted into a vacuum chamber under a reduced pressure of 10⁻⁴ Pa in the surface treatment apparatus 502. Then, in the vacuum chamber, a mixed gas of an oxygen gas and a fluorine gas was introduced to generate plasma to provide a surface treatment by plasma for 10 sec at a power of 100 W.

FIG. 87 is a diagram schematically showing a sectional shape near a pattern surface after a pattern layer is passed through a surface treatment apparatus.

As shown in FIG. 87, the surface of the line pattern 505 becomes, through this surface treatment, a resin layer 504-5, which is formed by a portion of the resin being selectively removed by the etching, dramatically increasing the number of metallic particles 504-2, which are plating cores, exposed to the surface.

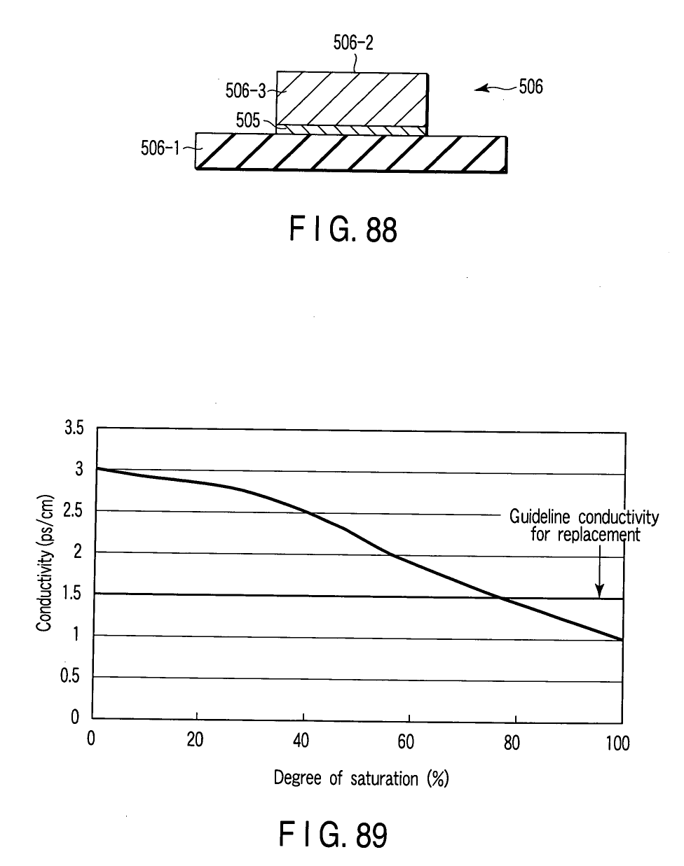

FIG. 88 is a diagram schematically showing the configuration of the cross section of a circuit board using a pattern formed according to the present invention.

The substrate 506-1 was transported to the nonelectrolytic plating apparatus 503 by the transport system 501 and, as shown in FIG. 88, a nonelectrolytic Cu plating layer 506-3 of thickness of 10 μm was formed on the line pattern 505 by the substrate 506-1 being soaked in an ethylenediamine nonelectrolytic plating solution to manufacture a circuit board on which a fine wiring pattern 506-2 with a line width of 20 μm and an interline space of 20 μm was formed.

Next, a strainer having the same configuration as that shown in FIGS. 79, 80, 81, and 82 was used as the strainer used in the waste liquid treatment mechanism of the pattern formation apparatus 500 having the same configuration as that of the pattern formation apparatus shown in FIG. 69. In the present embodiment, particularly suction removal of metallic particles liberated from toner solid content is important.

As shown in FIG. 82, the barrier structure 431-1 is made of a stainless plate of thickness of 2 mm and provided with through holes having an average opening diameter d3 of 60 μm on the front side and that of 30 μm on the rear side. The hydrotalcite adsorbent particle layer 431-2 having the maximum frequency of particle diameter distribution in the range of particle diameter 5 μm to 100 μm was caused to deposit on the surface of the barrier structure to form the adsorbent particle layer 431-2 to a thickness of 6 mm on the front side. As a result of using a recycling treatment of the waste liquid using the strainer 431, a waste liquid recycling treatment that is effective in removing both toner solid content and ionic compounds and utilizing the maximum possible adsorption capability of the adsorbent in a short time could be achieved.

For the liquid developer in the present embodiment, the conductivity of an Isopar L dispersion liquid in which the adsorbent has sufficiently adsorbed toner solid content, liberated metallic particles, and metallic soap content was measured.

FIG. 89 is a graph showing a criterion for replacing the adsorbent.

As a result, as shown in FIG. 89, the initial conductivity was 3 pS/cm and the conductivity in a state of near saturation of the adsorbent dropped to 1.0 pS/cm. Therefore, we managed the adsorbent by defining the criterion for replacing the adsorbent at 1.5 pS/cm, which is a state of 80% adsorption.

By using a wiring substrate manufacturing apparatus according to the present invention, circuit boards of fine wiring patterns having high reliability based on data created in advance by CAD can be manufactured in a short time with reproducibility.

A cleaning apparatus in the present invention has the above configuration and operation and therefore, cleaning of charged particles held by an image support can satisfactorily be done.

A pattern formation apparatus in the present invention can recycle a carrier liquid by removing ionic compounds and toner solid content from a liquid developer waste liquid concurrently and has a waste liquid treatment unit in which the treatment capability per unit time and adsorption efficiency per unit amount of adsorbent used are satisfactory.

What is claimed is:

1. A cleaning apparatus which cleans an intaglio after making a transcription to a transferred medium by aggregating developer particles in a pattern-like recess, comprising:
a supply device which supplies a cleaning liquid to the recess; and
a removal device which removes the developer particles remaining in the recess together with the cleaning liquid supplied by the supply device.

2. The cleaning apparatus according to claim 1, wherein the supply device has a two-fluid nozzle or a one-fluid nozzle which blows the cleaning liquid against the recess.

3. The cleaning apparatus according to claim 2, wherein the supply device has an adjustment mechanism which adjusts a blowing angle of the cleaning liquid by the two-fluid nozzle or the one-fluid nozzle.

4. The cleaning apparatus according to claim 1, wherein the removal device has a porous member in contact with an opening of the recess and a pressure device which causes a negative pressure on a surface of the porous member.

5. The cleaning apparatus according to claim 4, wherein the removal device has a removal roller having the porous member on a circumferential surface thereof and rotates the removal roller to slidingly bring the removal roller into contact with the recess to cause a negative pressure on the circumferential surface of the removal roller by the pressure device via a rotation axis thereof.

6. A cleaning apparatus which cleans a recess after a transcription incorporated in a pattern formation apparatus that supplies a liquid developer in which charged developer particles are dispersed in an insulating liquid to an intaglio having the pattern-like recess, aggregates the developer particles in the liquid developer into the recess by action of an electric field near the recess, and makes a transcription to a transferred medium by the action of an electric field on the developer particles aggregated in the recess, comprising:
a supply device which supplies a cleaning liquid to the recess; and
a removal device which removes the developer particles remaining in the recess together with the cleaning liquid supplied by the supply device.

7. The cleaning apparatus according to claim 6, wherein the supply device has a two-fluid nozzle or a one-fluid nozzle which blows the cleaning liquid against the recess.

8. The cleaning apparatus according to claim 7, wherein the supply device further has an adjustment mechanism which adjusts a blowing angle of the cleaning liquid blown by the two-fluid nozzle or the one-fluid nozzle.

9. The cleaning apparatus according to claim 7, wherein the supply device further has a fluctuation mechanism which fluctuates a blowing angle of the cleaning liquid blown by the two-fluid nozzle or the one-fluid nozzle.

10. The cleaning apparatus according to claim 7, wherein the cleaning liquid is an insulating liquid constituting the liquid developer.

11. The cleaning apparatus according to claim 6, wherein the removal device has a porous member in contact with an opening of the recess and a pressure device which causes a negative pressure on a surface of the porous member.

12. The cleaning apparatus according to claim 11, wherein the removal device has a removal roller having the porous member on a circumferential surface thereof and rotates the removal roller to slidingly bring the removal roller into contact with the recess to cause a negative pressure on the circumferential surface of the removal roller by the pressure device via a rotation axis thereof.

13. The cleaning apparatus according to claim 12, wherein the porous member of the removal roller is formed from a material having conductivity so that the charged developer particles are made to be adsorbed by the action of an electric field between the porous member and the recess.

14. The cleaning apparatus according to claim 12, wherein the removal device further has a blade for scraping off the developer particles adhering to the removal roller.

15. The cleaning apparatus according to claim 14, wherein the blade is formed from a material having conductivity so that the developer particles adhering to the removal roller are made to be adsorbed by forming an electric field between the blade and the removal roller.

16. The cleaning apparatus according to claim 13, wherein the removal device further has a cleaning roller in rotational contact with the removal roller to cause the developer particles adhering to the removal roller to adhere to a circumferential surface of the cleaning roller by forming the electric field between the removal roller and the cleaning roller.

17. The cleaning apparatus according to claim 16, wherein the removal device further has a blade for scraping off the developer particles adhering to the circumferential surface of the cleaning roller.

18. The cleaning apparatus according to claim 17, wherein the blade is formed from a material having conductivity so that the developer particles adhering to the circumferential surface of the cleaning roller are made to be adsorbed by forming an electric field between the blade and the cleaning roller.

19. A cleaning method for cleaning an intaglio after making a transcription to a transferred medium by aggregating developer particles in a pattern-like recess, comprising:
a supply step of supplying a cleaning liquid to the recess; and
a removal step of removing the developer particles remaining in the recess together with the cleaning liquid supplied by the supply step.

20. The cleaning method according to claim 19, wherein the cleaning liquid is blown against the recess via a two-fluid nozzle or a one-fluid nozzle in the supply step.

21. A cleaning apparatus which cleans an image support holding a pattern image by charged particles to transfer the pattern image to a transferred medium, comprising:
an electrode arranged near and opposite to the image support to cause the charged particles held by the image support to be adsorbed by forming an electric field between the electrode and image support; and
a liquid flow device which fills a space between the electrode and the image support with a cleaning liquid and causing the cleaning liquid to circulate the charged particles adsorbed by the electrode after causing the electric field to disappear.

22. The cleaning apparatus according to claim 21, wherein the image support has a pattern-like recess for housing and holding the charged particles and a conductive material arranged at a bottom of the recess, and
the electric field is formed between the conductive material and the electrode after filling the space between the image support and the electrode with the cleaning liquid when cleaning of the charged particles held by the recess is done.

23. The cleaning apparatus according to claim 21, further comprising a pre-wet device for pre-wetting the image support with the cleaning liquid.

24. The cleaning apparatus according to claim 21, further comprising a removal device which removes the cleaning liquid from the image support after flowing the charged particles.

25. The cleaning apparatus according to claim 21, further comprising another cleaner which does the cleaning of the charged particles held by the image support.

26. A pattern formation apparatus, comprising:
a holding mechanism which holds a flat-plate transferred medium;
a drum-like image support;
a rolling mechanism which rolls the image support along the transferred medium held by the holding mechanism;
an image formation apparatus which forms a pattern image by charged particles on a circumferential surface of the image support;
a transfer device which transfers the pattern image on the circumferential surface to the transferred medium by forming an electric field between the rolling image support and the transferred medium; and
a cleaning apparatus which cleans the circumferential surface of the image support, wherein
the cleaning apparatus comprises:
an electrode arranged near and opposite to the image support to cause the charged particles held on the circumferential surface to be adsorbed by forming the electric filed between the electrode and image support; and
a liquid flow device which fills a space between the electrode and the circumferential surface of the image support with a cleaning liquid and causing the cleaning liquid to circulate the charged particles adsorbed by the electrode after causing the electric field to disappear.

27. The pattern formation apparatus according to claim 26, wherein pattern-like recesses which houses and holds the charged particles are formed on the circumferential surface of the image support.

28. The pattern formation apparatus according to claim 27, wherein the image support has a conductive member arranged at a bottom of the recesses, and
the cleaning apparatus forms the electric field between the conductive member and the electrode after filling the space between the circumferential surface of the image support and the electrode with the cleaning liquid.

29. The pattern formation apparatus according to claim 26, further comprising a pre-wet device which pre-wets the circumferential surface with the cleaning liquid before cleaning the circumferential surface of the image support by the cleaning apparatus.

30. The pattern formation apparatus according to claim 26, further comprising a removal device which removes the cleaning liquid from the circumferential surface after cleaning the circumferential surface of the image support by the cleaning apparatus.

31. The pattern formation apparatus according to claim 26, further comprising another cleaner which cleans the circumferential surface of the image support.

32. A cleaning method for cleaning an image support holding a pattern image by charged particles to transfer the pattern image to a transferred medium, comprising steps of:
arranging an electrode near and opposite to the image support;
filling a space between the electrode and the image support with a cleaning liquid;
causing the electrode to adsorb the charged particles held by the image support by forming an electric field between the electrode and the image support; and
causing the cleaning liquid filling the space between the electrode and the image support to circulate to flow the charged particles adsorbed by the electrode after causing the electric field to disappear.

33. The cleaning method according to claim 32, further comprising a pre-wet step of pre-wetting the image support with the cleaning liquid.

34. The cleaning method according to claim 32 or 33, further comprising a removal step of removing the cleaning liquid from the image support after the step of causing the cleaning liquid to circulate.

35. The cleaning method according to claim 32, further comprising a step of determining whether or not emergency cleaning is needed by determining an amount of the charged particles held by the image support.

36. A cleaning apparatus, comprising:
a liquid flow device which fills a surface of an image support with a cleaning liquid and flowing the cleaning liquid; and
an ultrasonic device which causes the cleaning liquid to penetrate into remaining developer particles by application of ultrasonic waves on the developer particles remaining on the image support while the surface of the image support is filled with the cleaning liquid.

37. The cleaning apparatus according to claim 36, further comprising a pre-wet device which pre-wets the surface of the image support with the cleaning liquid.

38. The cleaning apparatus according to claim 36, further comprising a removal device which removes the cleaning liquid from the surface of the image support after flowing the developer particles.

39. The cleaning apparatus according to claim 36, further comprising another cleaner which does cleaning of the developer particles held by the image support.

40. The cleaning apparatus according to claim 36, further comprising a detection device which detects an amount of the developer particles remaining on the image support; and
a control device which controls at least one of a frequency of ultrasonic waves generated by the ultrasonic device, an applied voltage, and an application time based on detection results of the detection device.

41. The cleaning apparatus according to claim 36, further comprising a blowing device causing the developer particles remaining on the image support to be peeled off by blowing the cleaning liquid against the developer particles.

42. A cleaning apparatus which cleans an image support holding a pattern image by charged particles to transfer the pattern image to a transferred medium, comprising:
a liquid flow device which fills a surface of an image support with a cleaning liquid and flows the cleaning liquid;
an ultrasonic device which causes the cleaning liquid to penetrate into the remaining developer particles by application of ultrasonic waves on the developer particles remaining on the image support while the surface of the image support is filled with the cleaning liquid; and
a conductive member arranged near and opposite to the surface of the image support to cause the charged particles held by the image support to be adsorbed by forming an electric field between the image support and the conductive member.

43. The cleaning apparatus according to claim 42, further comprising a pre-wet device which pre-wets the surface of the image support with the cleaning liquid.

44. The cleaning apparatus according to claim 42, further comprising a removal device which removes the cleaning liquid from the surface of the image support after flowing the developer.

45. The cleaning apparatus according to claim 42, further comprising another cleaner for doing cleaning of the developer held by the image support.

46. The cleaning apparatus according to claim 42, further comprising a detection device which detects an amount of the developer remaining on the image support; and
a control device which controls at least one of a frequency of ultrasonic waves generated by the ultrasonic device, an applied voltage, an application time, and the electric field formed between the image support and the conductive member based on detection results of the detection device.

47. The cleaning apparatus according to claim 42, further comprising a blowing device causing the charged particles remaining on the image support to be peeled off by blowing the cleaning liquid against the charged particles.

48. A cleaning method for cleaning an image support holding a pattern image by developer particles to transfer the pattern image to a transferred medium, comprising:
a step of filling a surface of the image support with a cleaning liquid;
an ultrasonic wave generation step of causing the cleaning liquid to penetrate into the remaining developer particles by application of ultrasonic waves on the developer particles remaining on the image support; and
a liquid flow step of flowing the cleaning liquid filling the surface of the image support.

49. The cleaning method according to claim 48, further comprising a pre-wet step of pre-wetting the image support with the cleaning liquid.

50. The cleaning method according to claim 48, further comprising a removal step of removing the cleaning liquid from the image support after the liquid flow step.

51. The cleaning method according to claim 48, further comprising a blowing step of causing the developer particles remaining on the image support to be peeled off by blowing the cleaning liquid against the developer particles.

52. The cleaning method according to claim 48, further comprising:
a detection step of detecting an amount of the developer particles remaining on the image support; and
a control step of controlling at least one of a frequency of ultrasonic waves generated by the ultrasonic wave generation step, an applied voltage, and an application time, based on detection results from the detection step.

53. A cleaning method for cleaning an image support holding a pattern image by charged particles to transfer the pattern image to a transferred medium, comprising:
a step of filling a surface of the image support with a cleaning liquid;
an ultrasonic wave generation step of causing the cleaning liquid to penetrate into the remaining charged particles by application of ultrasonic waves on the charged particles remaining on the image support;
a step of causing a conductive member to adsorb the charged particles held by the image support by forming an electric field between the conductive member arranged near and opposite to the surface of the image support and the image support; and
a liquid flow step of flowing the charged particles adsorbed by the conductive member by flowing the cleaning liquid filling the surface of the image support after causing the electric field to disappear.

54. The cleaning method according to claim 53, further comprising a pre-wet step of pre-wetting the image support with the cleaning liquid.

55. The cleaning method according to claim 53, further comprising a removal step of removing the cleaning liquid from the image support after the liquid flow step.

56. The cleaning method according to claim 53, further comprising a blowing step of causing the charged particles remaining on the image support to be peeled off by blowing the cleaning liquid against the charged particles.

57. The cleaning method according to claim 53, further comprising:
a detection step of detecting an amount of the charged particles remaining on the image support; and
a control step of controlling at least one of a frequency of ultrasonic waves generated by the ultrasonic wave generation step, an applied voltage, an application time, and the electric field formed between the image support and the conductive member in the step of causing the conductive member to adsorb based on detection results from the detection step.

58. A pattern formation apparatus, comprising:
an image support;
a pattern formation unit provided opposite to the image support and having a development part for forming a toner image by developing an electrostatic latent image formed on the image support using a liquid developer including toner containing an ionic compound and a carrier liquid, and a transfer part for transferring the toner image to a transfer medium;
a waste liquid collection line connected to the pattern formation unit to collect a waste liquid containing toner solid content, ionic compounds, and the carrier liquid;
a waste liquid treatment unit that is connected to the collection line, has a conductive barrier structure having perforations of 30 to 100 μm in diameter, and includes a strainer which removes the toner solid content and the ionic compounds in the waste liquid, and an input part provided upstream of the strainer to introduce adsorbent particles; and
a recycled liquid supply line which returns the treated waste liquid discharged from the waste liquid treatment unit to the pattern formation unit, wherein
the strainer serves waste liquid treatment by causing to form an adsorbent particle layer of 0.5 mm to 10 mm in thickness by allowing to pass the waste liquid or the carrier liquid to which adsorbent particles having a maximum frequency of particle diameter distribution in a range of 5 μm to 100 μm have been added.

59. The pattern formation apparatus according to claim 58, wherein the waste liquid treatment unit further comprises: a treatment cistern provided upstream of the strainer and having an input part which introduces the adsorbent particles; and an output part which takes out the adsorbent particles from the treatment cistern.

60. The pattern formation apparatus according to claim 59, wherein the waste liquid treatment unit further comprises: a preliminary treatment cistern that is provided upstream of the strainer to store the waste liquid and causes a portion of the toner to deposit to remove the toner from the waste liquid.

61. The pattern formation apparatus according to claim 60, wherein the toner whose particle diameter is 1 μm or more is removed in the preliminary treatment cistern and the toner whose particle diameter is less than 1 μm is removed in the treatment cistern and the strainer.

62. The pattern formation apparatus according to any one of claims 58 to 61, further comprising: a first conductivity measuring part between the input part and the treatment cistern; and a second conductivity measuring part between the treatment cistern and the output part, wherein the first conductivity measuring part measures initial conductivity by dispersing the introduced adsorbent particles in the carrier liquid, the second conductivity measuring part measures conductivity after waste liquid treatment and, if the conductivity after the waste liquid treatment is equal to or falls below a reference conductivity based on the initial conductivity, the adsorbent particles are removed through the output part and unused adsorbent particles are introduced through the input part.

63. The pattern formation apparatus according to any one of claims 58 to 61, further comprising: a circulation line for returning the treated waste liquid discharged from the waste liquid treatment part upstream of the strainer inside the waste liquid treatment part in a subsequent stage of the strainer.

64. A pattern formation method using a pattern formation apparatus having a waste liquid treatment unit and a pattern formation unit, comprising:
a pattern formation step of forming a toner image in the pattern formation unit by developing an electrostatic latent image formed on an image support using a liquid developer including toner containing an ionic compound and a carrier liquid and a transfer part for transferring the toner image to a transfer medium;
a waste liquid collection step of collecting a waste liquid of toner solid content, the ionic compound, and the carrier liquid from the pattern formation unit into the waste liquid treatment unit through a waste liquid collection line;
an adsorbent particle layer formation step of forming an adsorbent particle layer of 0.5 mm to 10 mm in thickness on a barrier structure in the waste liquid treatment unit by applying adsorbent particles having a maximum frequency of particle diameter distribution in a range of 5 μm to 100 μm to the waste liquid or the carrier liquid from an input port provided upstream of the strainer and passing the waste liquid or the carrier liquid containing the adsorbent particles through the strainer having a conductive barrier structure with perforations of 30 to 100 μm in diameter;
subsequently, a waste liquid treatment step of removing the toner solid content and the ionic compounds by passing the waste liquid through the strainer in which the adsorbent particle layer is formed; and
a recycled liquid supply step of returning the waste liquid treated waste liquid from the waste liquid treatment unit to the pattern formation unit through a recycled liquid supply line.

65. The pattern formation method according to claim 64, wherein the collected waste liquid is introduced into a treatment cistern provided upstream of the strainer and having the input part and an output part for taking out the adsorbent particles before being sent from the treatment cistern to the strainer.

66. The pattern formation method according to claim 65, wherein the collected waste liquid is introduced into a preliminary treatment cistern provided upstream of the treatment cistern to be stored there, and after the toner solid content is caused to deposit for removal, is set to the treatment cistern.

67. The pattern formation method according to claim 66, wherein the toner whose particle diameter is 1 μm or more is removed in the preliminary treatment cistern and the toner whose particle diameter is less than 1 μm is removed in the treatment cistern and the strainer.

68. The pattern formation method according to any one of claims 64 to 67, further comprising: a first conductivity measuring part between the input part and the treatment cistern; and a second conductivity measuring part between the treatment cistern and the output part, wherein the first conductivity measuring part measures initial conductivity by dispersing the introduced adsorbent particles in the carrier liquid, the second conductivity measuring part measures conductivity after waste liquid treatment and, if the conductivity after the waste liquid treatment is equal to or falls below reference conductivity based on the initial conductivity, the adsorbent particles are removed through the output part and unused adsorbent particles are introduced through the input part.

69. The pattern formation method according to any one of claims 64 to 67, wherein the waste liquid treated waste liquid is returned upstream of the strainer inside the waste liquid treatment part through a circulation line provided in a subsequent stage of the strainer.
